(19) United States
(12) Patent Application Publication
(10) Pub. No.: US 2025/0208379 A1
(43) Pub. Date: Jun. 26, 2025

(54) LARGE APERTURE RATIO ULTRA WIDE ANGLE LENS

(71) Applicant: SIGMA CORPORATION, Kanagawa (JP)

(72) Inventor: Yasumoto OGINOME, Tokyo (JP)

(73) Assignee: SIGMA CORPORATION, Kanagawa (JP)

(21) Appl. No.: 18/983,677

(22) Filed: Dec. 17, 2024

(30) Foreign Application Priority Data
Dec. 22, 2023 (JP) 2023-216807

(51) Int. Cl. G02B 9/64; G02B 13/06; G02B 13/18

(52) U.S. Cl. CPC G02B 9/64; G02B 13/06; G02B 13/18

(57) ABSTRACT

A large aperture ratio ultra wide angle lens is compact and lightweight, has a half angle of view of 80 degrees or more, is bright with an F-number of approximately 1.8 or less, and has good optical performance from center of a screen to periphery while ensuring a sufficient image circle is provided. A large aperture ratio ultra wide angle lens includes, in order from an object side, first lens group G1, aperture diaphragm S, and second lens group G2, first lens group G1 has a meniscus negative lens component N1 having its convex surface facing the object side and being disposed on a side closest to the object side, and a meniscus negative lens component N2 with its convex surface facing the object side on a side closer to an image side than the meniscus negative lens component N1, and a predetermined conditional expression is satisfied.

### BACKGROUND OF THE INVENTION

### Field of the Invention

The present invention relates to a large aperture ratio ultra wide angle lens that is suitable for imaging optical systems used in imaging devices such as digital cameras and video cameras.

### Background Art

In recent years, as digital cameras and video cameras have become more mirrorless, and as smartphones and mobile data terminals have been equipped with high-performance cameras, digital cameras equipped with large sensors of a 35 mm full-size format or larger have become mainstream in order to differentiate themselves from these mobile devices. Similarly, there is an increasing demand for bright large aperture ratio ultra wide angle lenses with an F-number in the optical systems used in imaging devices in order to differentiate them from smartphones or the like.

Furthermore, in recent years, digital cameras and video cameras have been increasingly high pixel imaging elements, and the demand for high performance imaging optical systems has been increasing.

Japanese Patent No. 4633379 and Japanese Patent Application Publication No. 2013-238684 disclose examples of large aperture ratio ultra wide angle lenses with a maximum angle of view of approximately 160 degrees or more and an F-number of approximately 1.8 or less.

### SUMMARY OF THE INVENTION

Ultra-wide angle lenses with a maximum angle of view of approximately 160 degrees or more often have a retrofocus type lens configuration, and are often configured to include a meniscus negative lens disposed on a side closest to an object side, the meniscus negative lens with its convex surface facing the object side. In such optical systems, the meniscus negative lens disposed on a side closest to the object side often has a concave surface that has a large thickness deviation ratio and is close to a hemisphere, and may account for 50% or more of the total lens weight of the entire optical system. When an F-number is decreased, a lens diameter increases, and the weight of the optical system increases rapidly. When achieving a large aperture ratio, it is important to achieve high performance while preventing enlargement of the lens.

Japanese Patent No. 4633379 includes an example of a bright large aperture ratio ultra wide angle lens with a maximum angle of view of 160 degrees or more and an F-number of 1.6 or less. The large aperture ratio ultra wide angle lens disclosed in Japanese Patent No. 4633379 has high optical performance, but has a small image circle, and is an extremely large optical system from the perspective of the size of an optical system with respect to the image circle, which poses a problem in terms of downsizing.

Japanese Patent Application Publication No. 2013-238684 includes an example of a bright large aperture ratio ultra wide angle lens with an F-number of approximately 1.8, but lateral chromatic aberration is large due to a low image height, which is insufficient in terms of high performance. In addition, a back focus is long, and thus the optical system does not take an advantage of a short flange back of the recent trend toward mirrorless cameras, and there is room for an improvement in terms of downsizing of the optical system.

The present invention has been made in view of the above-described problems, and an object thereof is to provide a large aperture ratio ultra wide angle lens that is compact and lightweight, has a half angle of view of 80 degrees or more, is bright with an F-number of approximately 1.8 or less, and has good optical performance from the center to the periphery of a screen while ensuring a sufficient image circle.

A large aperture ratio ultra wide angle lens according to the present invention includes, in order from an object side, a first lens group G1, an aperture diaphragm S, and a second lens group G2, in which the first lens group G1 has a meniscus negative lens component N1 having its convex surface facing the object side and being disposed on a side closest to the object side, and a meniscus negative lens component N2 with its convex surface facing the object side on a side closer to an image side than the meniscus negative lens component N1, and the following Conditional Expressions (1) to (4) are satisfied.

$$2 ω \geq 160. ° \qquad ( 1 )$$

$$Fno < 1.9 \qquad ( 2 )$$

$$- 6. < N 1 OAh / iOAh < - 1.1 \qquad ( 3 )$$

$$0.5 < SagN 1 / SagN 2 < 1.8 \qquad ( 4 )$$

ω: A half angle of view when focusing on infinity
Fno: An F-number when focusing on infinity
N1OAh: An off-axis chief ray height when a ray with an object-side angle of incidence of 90° is incident on the meniscus negative lens component N1 when focusing on infinity (however, when 2ω<180°, it is a height of an off-axis chief ray that is incident at an object-side angle of incidence ω)
iOAh: An imaging height of an off-axis chief ray when a ray with an object-side angle of incidence of 90° forms an image on an image surface when focusing on infinity (however, when 2ω<180°, it is an imaging height of an off-axis chief ray that is incident at an object-side angle of incidence ω)
SagN1: A sag from a surface vertex of an image-side surface of the meniscus negative lens component N1 (as a ray height when calculating a sag, an off-axis chief ray height when a ray with an object-side angle of incidence of 90° emerges from the surface when focusing on infinity is used. When 2ω<180°, an off-axis chief ray height that is incident at an object-side angle of incidence ω is used for calculation.)
SagN2: A sag from a surface vertex of an image-side surface of the meniscus negative lens component N2 (as a ray height when calculating a sag, an off-axis chief ray height when a ray with an object-side angle of incidence of 90° emerges from the surface when focusing on infinity is used. When 2ω<180°, an off-axis chief ray height that is incident at an object-side angle of incidence ω is used for calculation.)

According to the present invention, it is possible to provide a large aperture ratio ultra wide angle lens that is compact and lightweight, has a half angle of view of 80 degrees or more, is bright with an F-number of approximately 1.8 or less, and has good optical performance from the center to the periphery of a screen while ensuring a sufficient image circle.

### BRIEF DESCRIPTION OF THE DRAWINGS

The amount of distortion is shown in a longitudinal aberration diagram of each example when focusing on infinity, but in all of Examples 1 to 14, an ideal image height is defined on the basis of a definition equation of equisolid angle projection, and a distortion is calculated. In addition, a lateral aberration diagram shows an aberration diagram when light rays at angles of view of 0%, 30%, 50%, 70%, 90%, and 100% of the maximum angle of view are incident. An object distance mentioned below refers to a distance between a subject and a first surface of a lens that is closest to an object side.

FIG. 1 is a diagram showing a lens configuration of a large aperture ratio ultra wide angle lens according to Example 1 of the present invention when focusing on infinity;

FIG. 2 is a longitudinal aberration diagram of the large aperture ratio ultra wide angle lens according to Example 1 of the present invention when focusing on infinity;

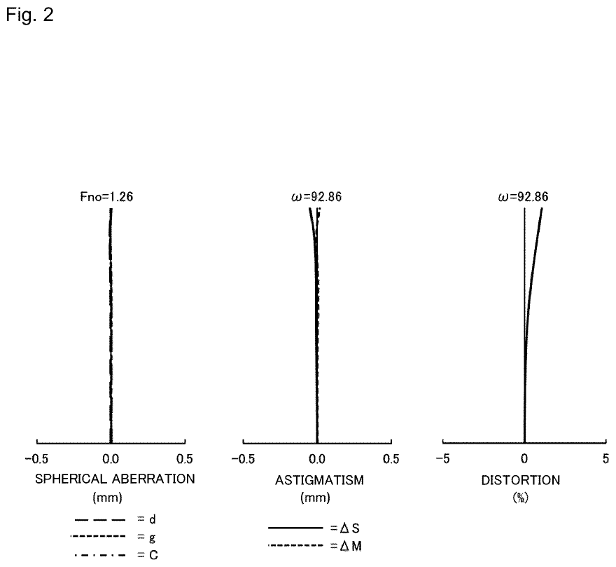

FIG. 3 is a lateral aberration diagram of the large aperture ratio ultra wide angle lens according to Example 1 of the present invention when focusing on infinity;

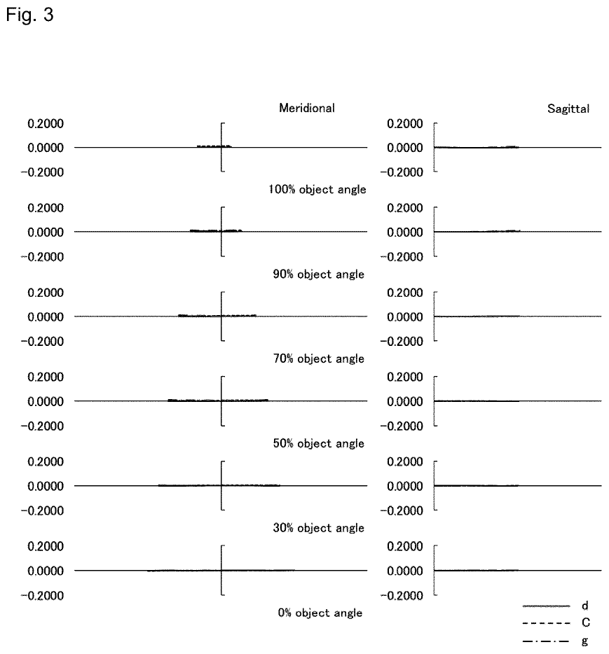

FIG. 4 is a longitudinal aberration diagram of the large aperture ratio ultra wide angle lens according to Example 1 of the present invention at the time of focusing at an object distance of 222.34 mm;

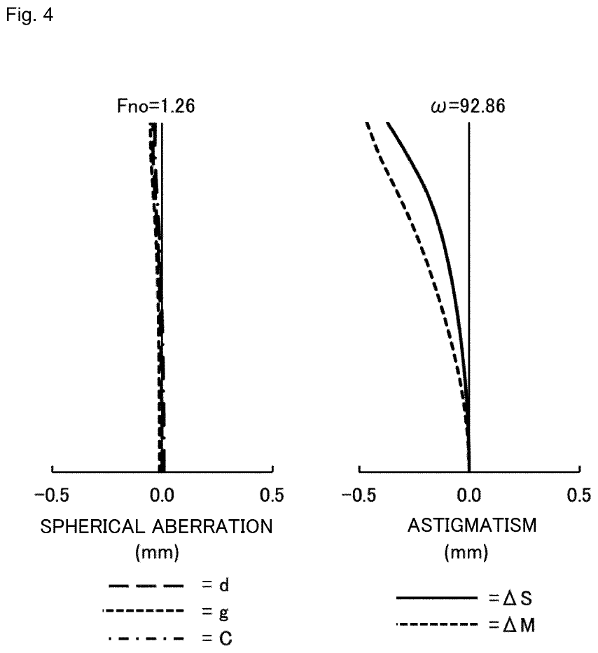

FIG. 5 is a lateral aberration diagram of the large aperture ratio ultra wide angle lens according to Example 1 of the present invention at the time of focusing at an object distance of 222.34 mm;

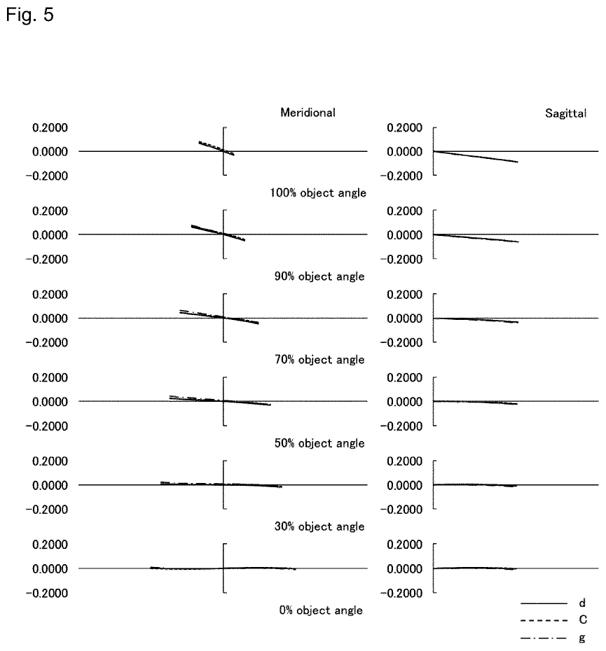

FIG. 6 is a diagram showing a lens configuration of a large aperture ratio ultra wide angle lens according to Example 2 of the present invention when focusing on infinity;

FIG. 7 is a longitudinal aberration diagram of the large aperture ratio ultra wide angle lens according to Example 2 of the present invention when focusing on infinity;

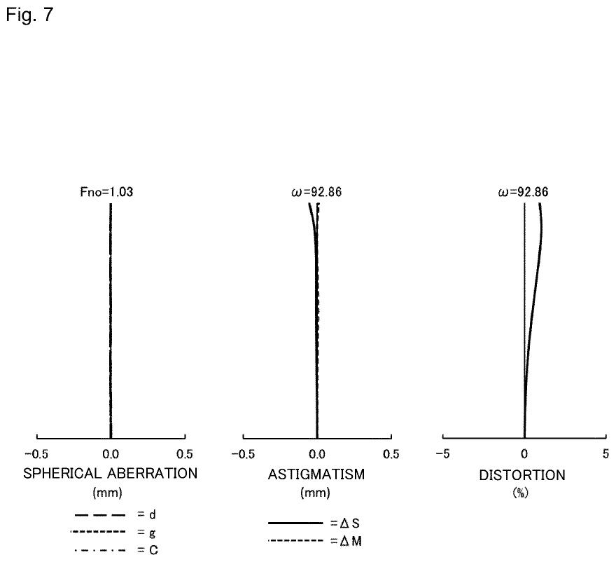

FIG. 8 is a lateral aberration diagram of the large aperture ratio ultra wide angle lens according to Example 2 of the present invention when focusing on infinity;

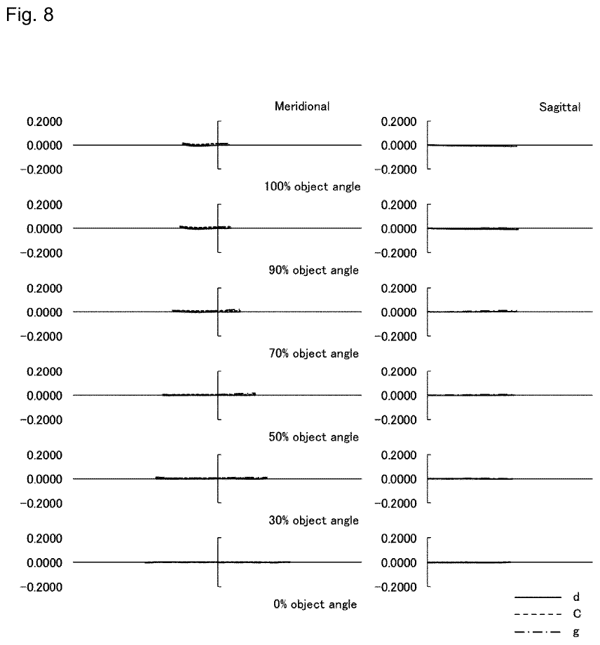

FIG. 9 is a longitudinal aberration diagram of the large aperture ratio ultra wide angle lens according to Example 2 of the present invention at the time of focusing at an object distance of 220.20 mm;

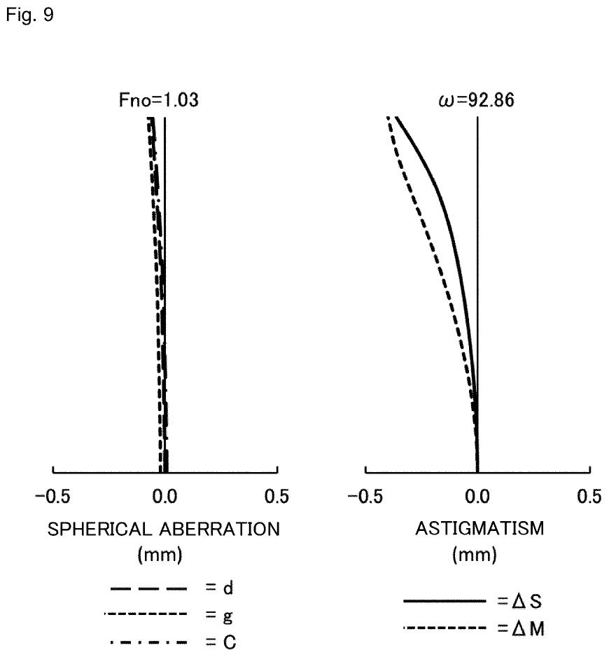

FIG. 10 is a lateral aberration diagram of the large aperture ratio ultra wide angle lens according to Example 2 of the present invention at the time of focusing at an object distance of 220.20 mm;

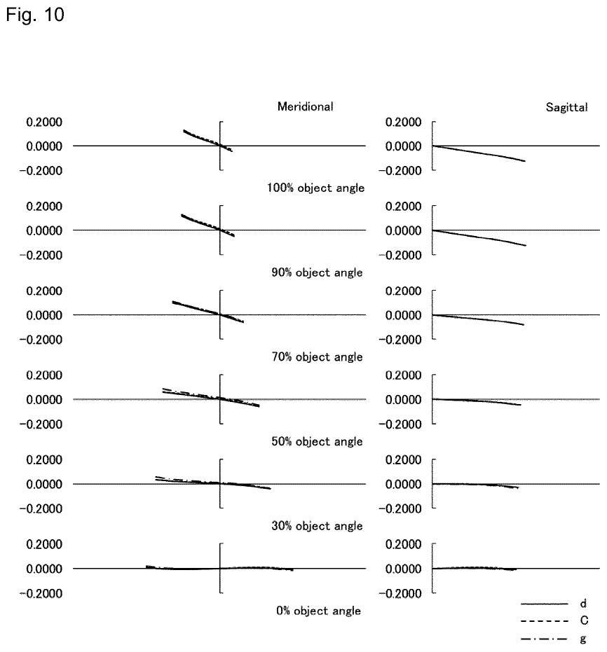

FIG. 11 is a diagram showing a lens configuration of a large aperture ratio ultra wide angle lens according to Example 3 of the present invention when focusing on infinity;

FIG. 12 is a longitudinal aberration diagram of the large aperture ratio ultra wide angle lens according to Example 3 of the present invention when focusing on infinity;

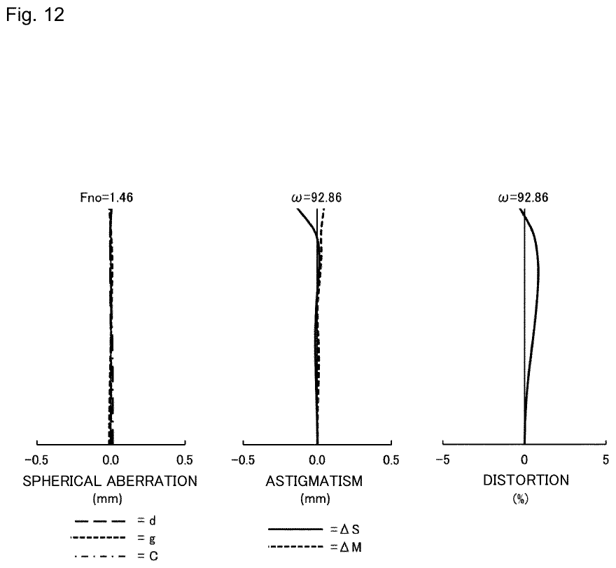

FIG. 13 is a lateral aberration diagram of the large aperture ratio ultra wide angle lens according to Example 3 of the present invention when focusing on infinity;

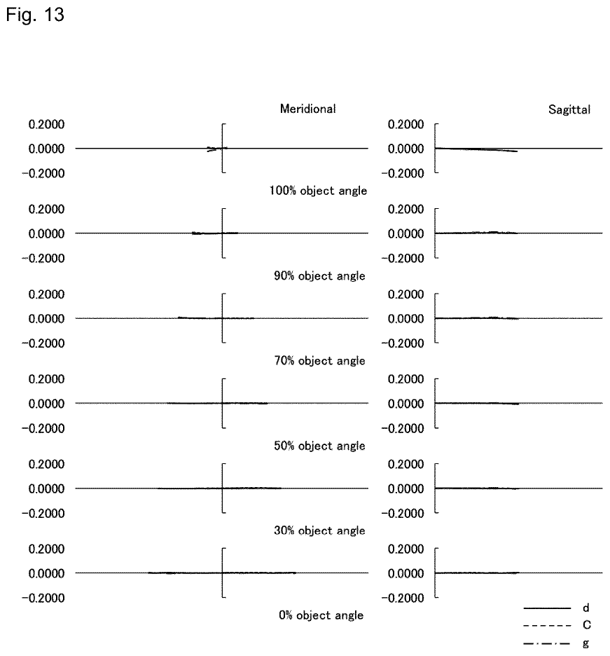

FIG. 14 is a longitudinal aberration diagram of the large aperture ratio ultra wide angle lens according to Example 3 of the present invention at the time of focusing at an object distance of 435.25 mm;

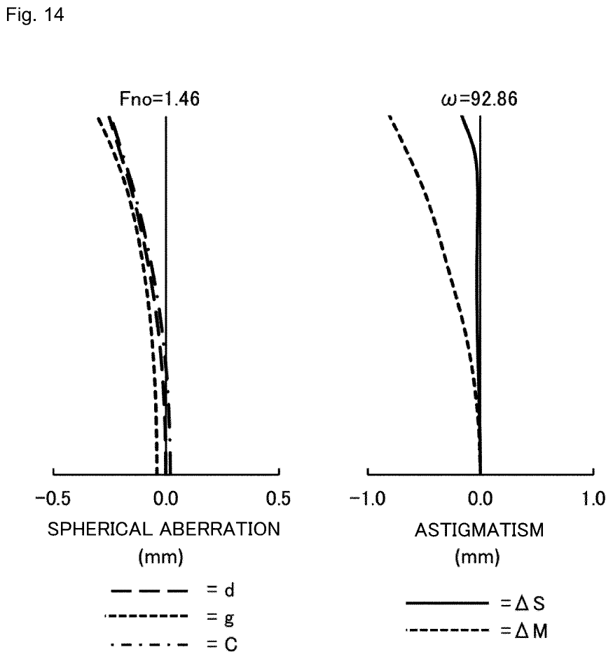

FIG. 15 is a lateral aberration diagram of the large aperture ratio ultra wide angle lens according to Example 3 of the present invention at the time of focusing at an object distance of 435.25 mm;

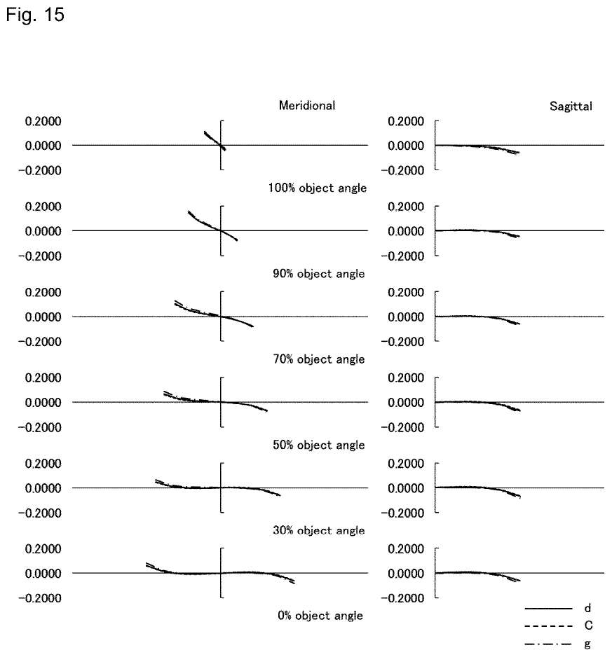

FIG. 16 is a diagram showing a lens configuration of a large aperture ratio ultra wide angle lens according to Example 4 of the present invention when focusing on infinity;

FIG. 17 is a longitudinal aberration diagram of the large aperture ratio ultra wide angle lens according to Example 4 of the present invention when focusing on infinity;

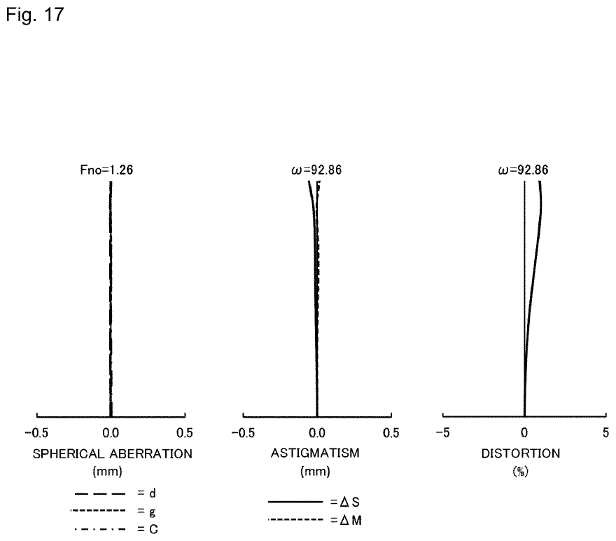

FIG. 18 is a lateral aberration diagram of the large aperture ratio ultra wide angle lens according to Example 4 of the present invention when focusing on infinity;

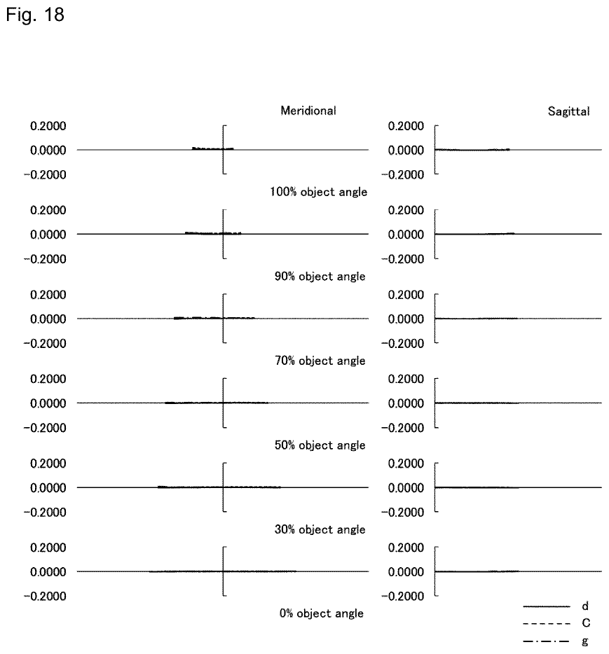

FIG. 19 is a longitudinal aberration diagram of the large aperture ratio ultra wide angle lens according to Example 4 of the present invention at the time of focusing at an object distance of 220.00 mm;

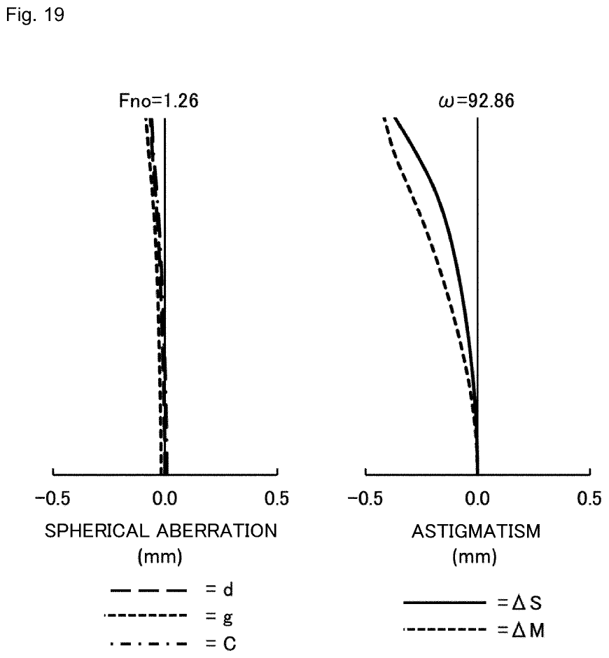

FIG. 20 is a lateral aberration diagram of the large aperture ratio ultra wide angle lens according to Example 4 of the present invention at the time of focusing at an object distance of 220.00 mm;

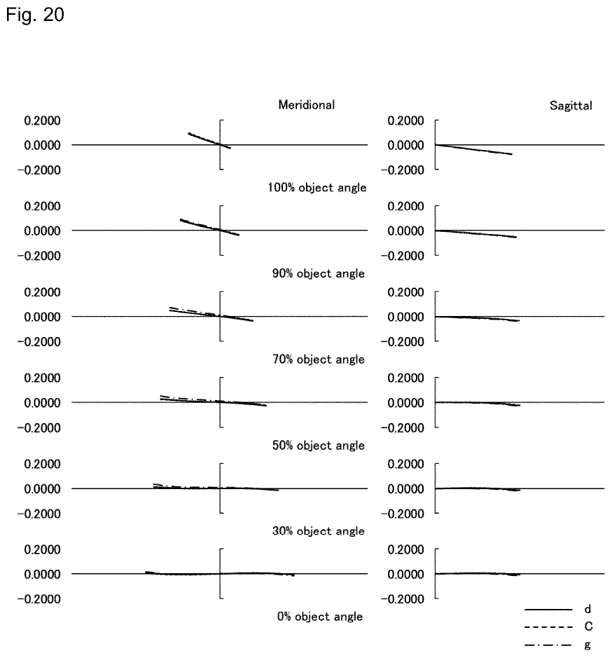

FIG. 21 is a diagram showing a lens configuration of a large aperture ratio ultra wide angle lens according to Example 5 of the present invention when focusing on infinity;

FIG. 22 is a longitudinal aberration diagram of the large aperture ratio ultra wide angle lens according to Example 5 of the present invention when focusing on infinity;

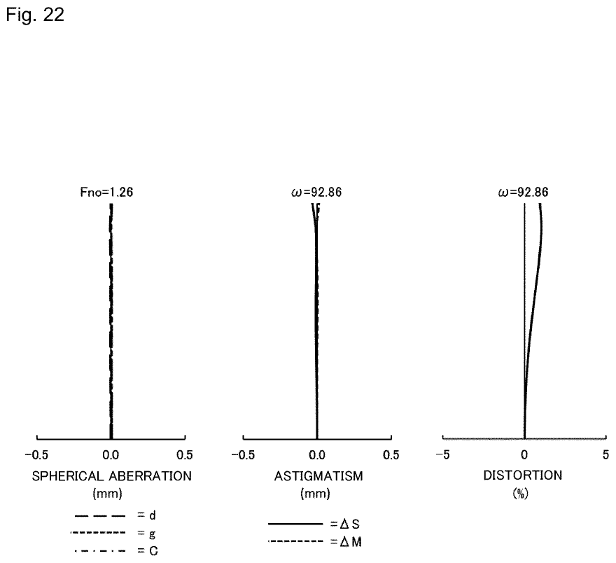

FIG. 23 is a lateral aberration diagram of the large aperture ratio ultra wide angle lens according to Example 5 of the present invention when focusing on infinity;

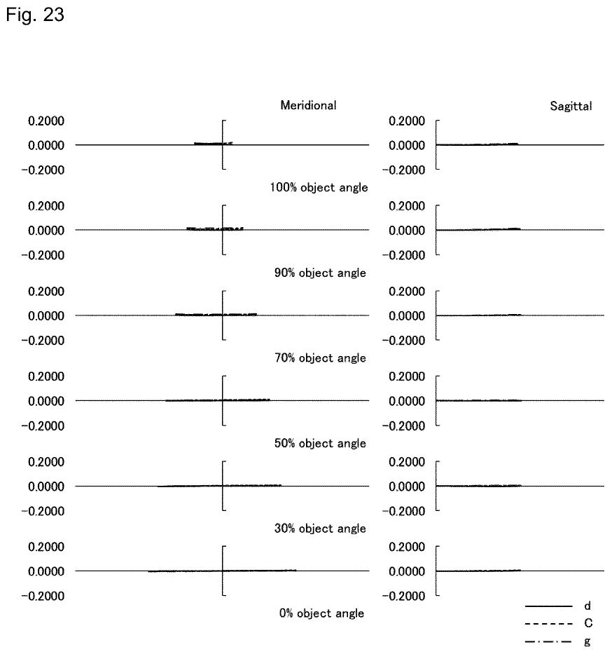

FIG. 24 is a longitudinal aberration diagram of the large aperture ratio ultra wide angle lens according to Example 5 of the present invention at the time of focusing at an object distance of 219.02 mm;

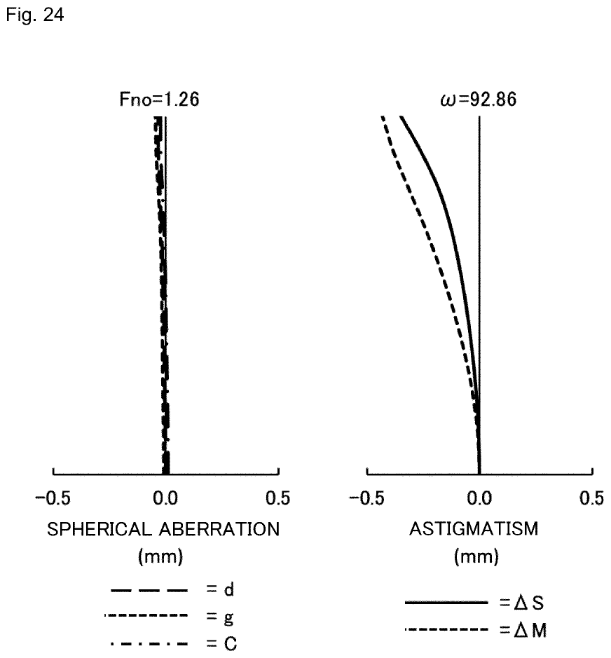

FIG. 25 is a lateral aberration diagram of the large aperture ratio ultra wide angle lens according to Example 5 of the present invention at the time of focusing at an object distance of 219.02 mm;

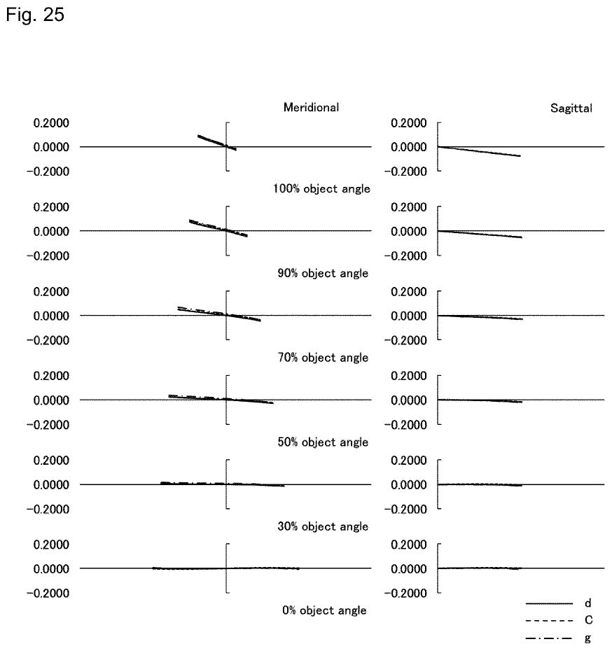

FIG. 26 is a diagram showing a lens configuration of a large aperture ratio ultra wide angle lens according to Example 6 of the present invention when focusing on infinity;

FIG. 27 is a longitudinal aberration diagram of the large aperture ratio ultra wide angle lens according to Example 6 of the present invention when focusing on infinity;

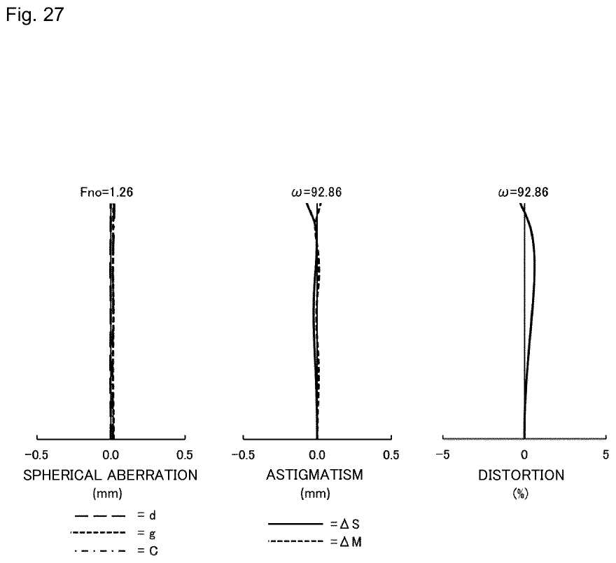

FIG. 28 is a lateral aberration diagram of the large aperture ratio ultra wide angle lens according to Example 6 of the present invention when focusing on infinity;

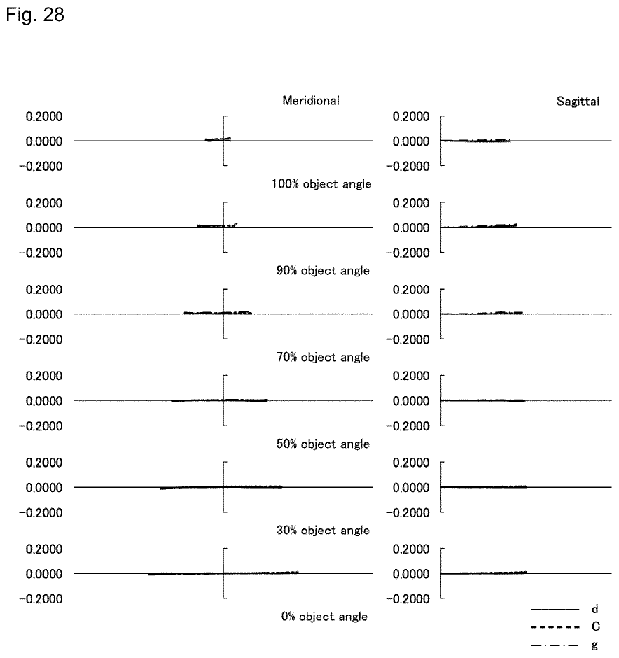

FIG. 29 is a longitudinal aberration diagram of the large aperture ratio ultra wide angle lens according to Example 6 of the present invention at the time of focusing at an object distance of 424.41 mm;

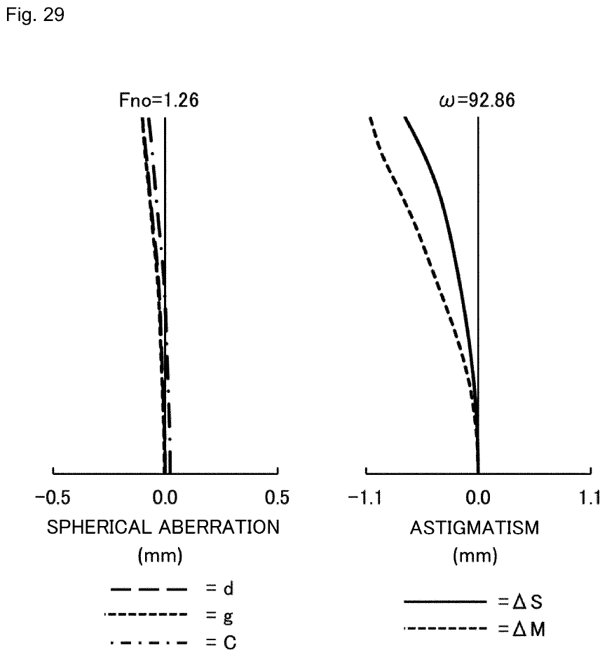

FIG. 30 is a lateral aberration diagram of the large aperture ratio ultra wide angle lens according to Example 6 of the present invention at the time of focusing at an object distance of 424.41 mm;

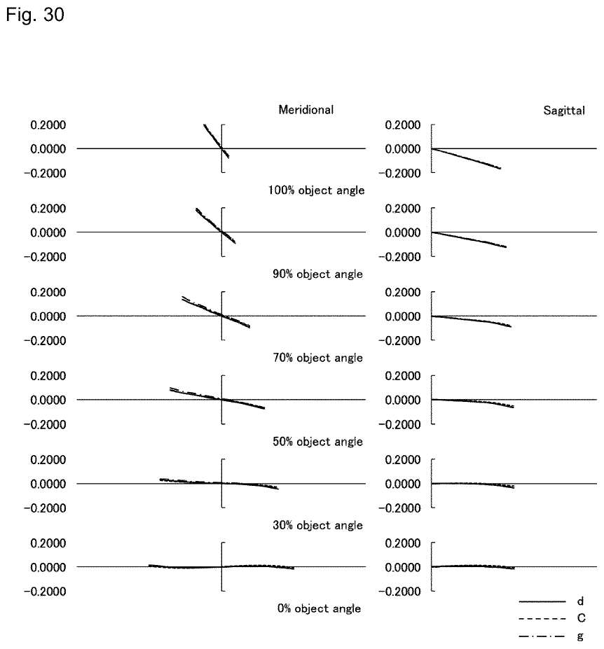

FIG. 31 is a diagram showing a lens configuration of a large aperture ratio ultra wide angle lens according to Example 7 of the present invention when focusing on infinity;

FIG. 32 is a longitudinal aberration diagram of the large aperture ratio ultra wide angle lens according to Example 7 of the present invention when focusing on infinity;

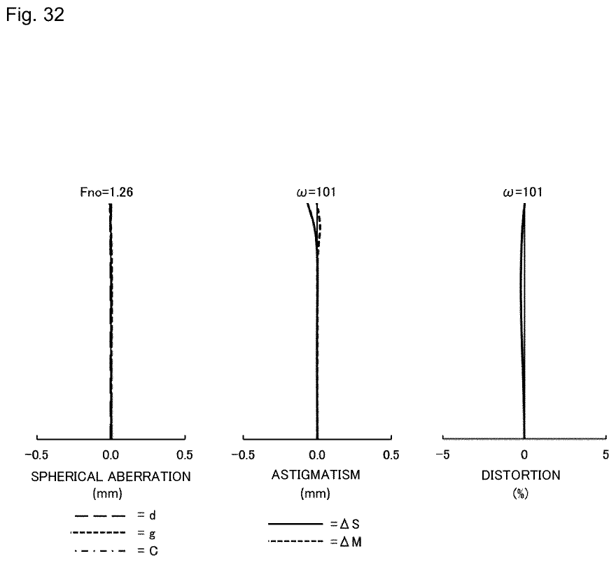

FIG. 33 is a lateral aberration diagram of the large aperture ratio ultra wide angle lens according to Example 7 of the present invention when focusing on infinity;

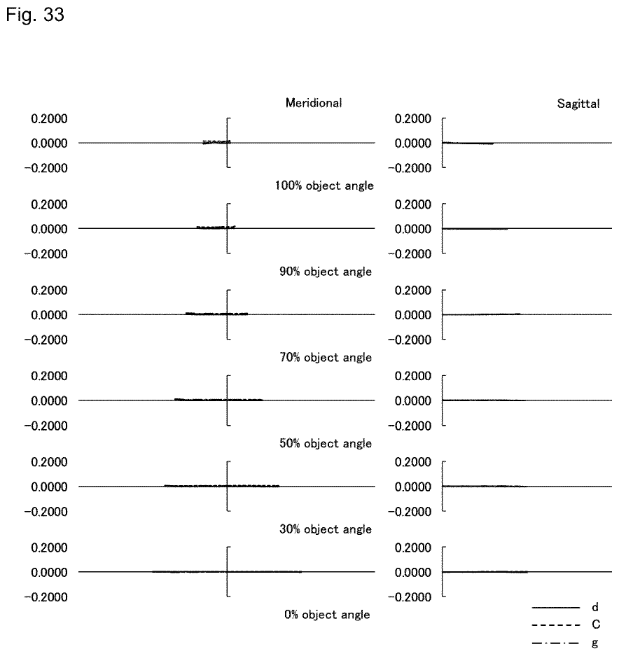

FIG. 34 is a longitudinal aberration diagram of the large aperture ratio ultra wide angle lens according to Example 7 of the present invention at the time of focusing at an object distance of 207.23 mm;

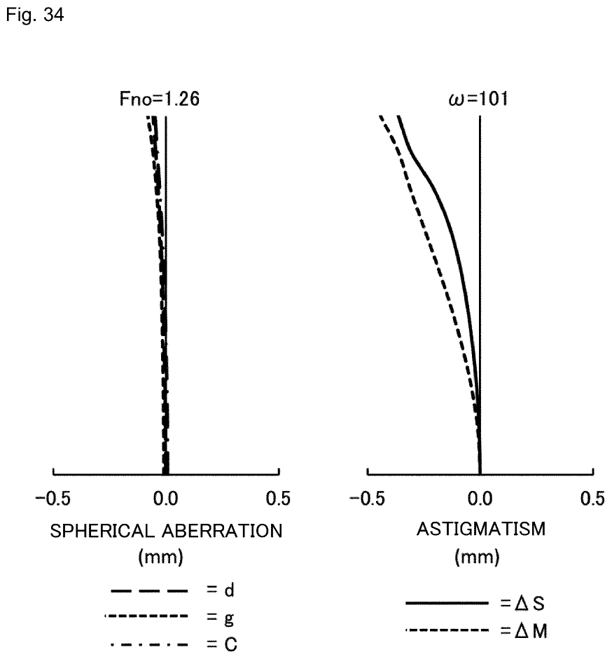

FIG. 35 is a lateral aberration diagram of the large aperture ratio ultra wide angle lens according to Example 7 of the present invention at the time of focusing at an object distance of 207.23 mm;

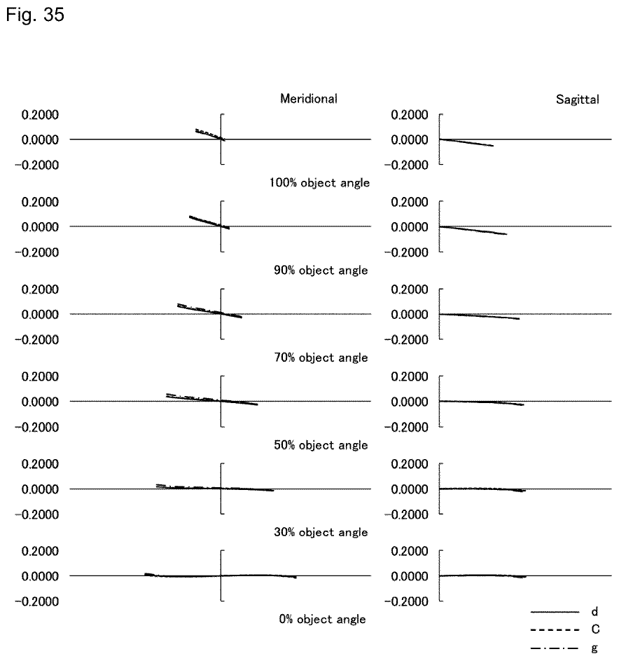

FIG. 36 is a diagram showing a lens configuration of a large aperture ratio ultra wide angle lens according to Example 8 of the present invention when focusing on infinity;

FIG. 37 is a longitudinal aberration diagram of the large aperture ratio ultra wide angle lens according to Example 8 of the present invention when focusing on infinity;

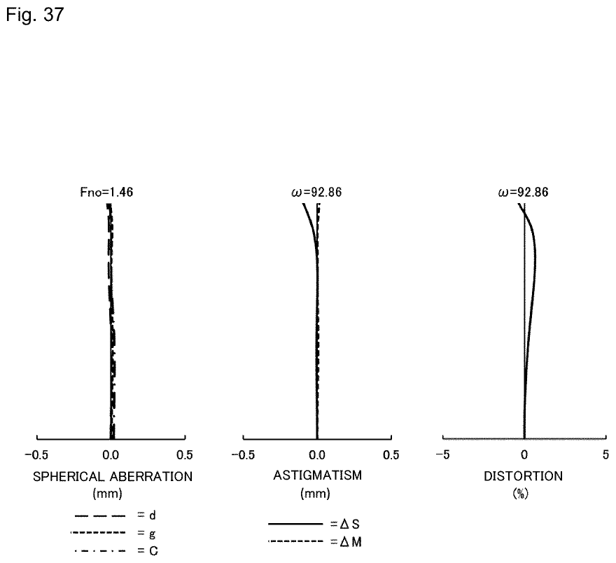

FIG. 38 is a lateral aberration diagram of the large aperture ratio ultra wide angle lens according to Example 8 of the present invention when focusing on infinity;

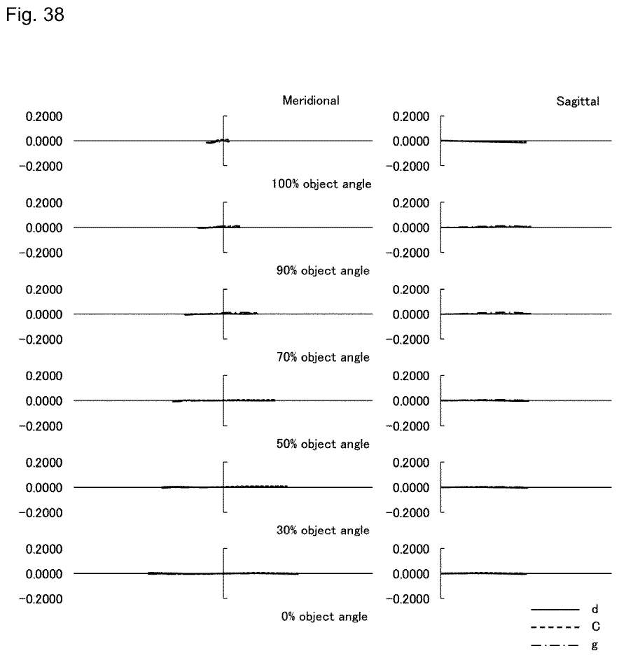

FIG. 39 is a longitudinal aberration diagram of the large aperture ratio ultra wide angle lens according to Example 8 of the present invention at the time of focusing at an object distance of 435.59 mm;

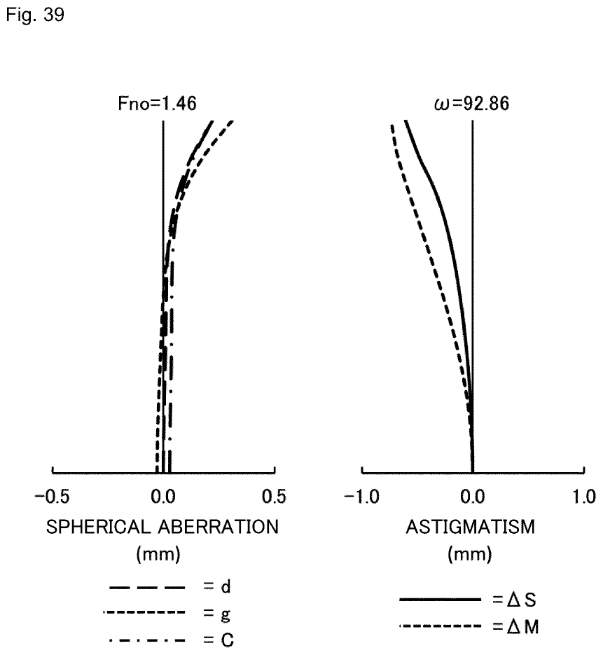

FIG. 40 is a lateral aberration diagram of the large aperture ratio ultra wide angle lens according to Example 8 of the present invention at the time of focusing at an object distance of 435.59 mm;

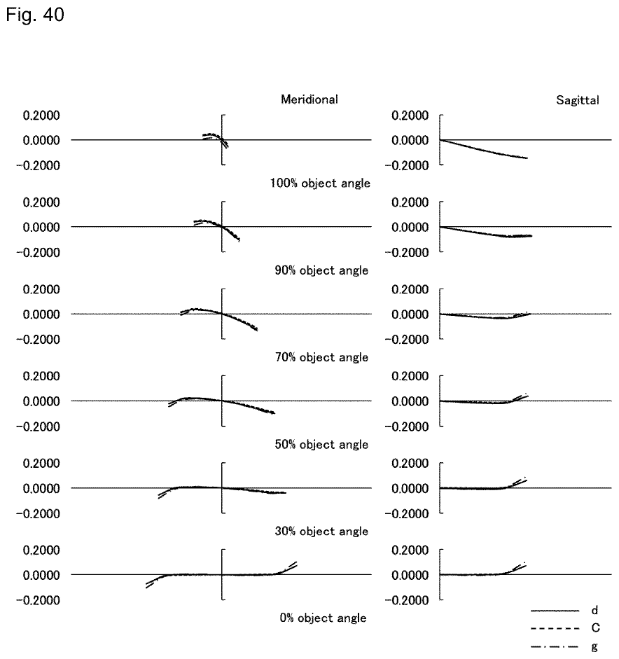

FIG. 41 is a diagram showing a lens configuration of a large aperture ratio ultra wide angle lens according to Example 9 of the present invention when focusing on infinity;

FIG. 42 is a longitudinal aberration diagram of the large aperture ratio ultra wide angle lens according to Example 9 of the present invention when focusing on infinity;

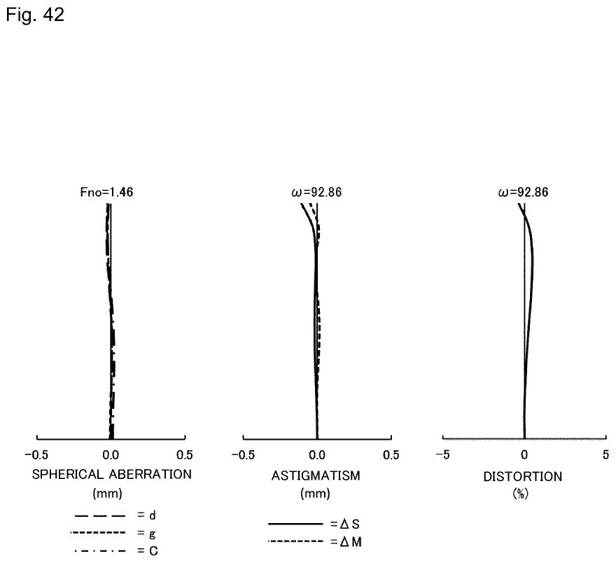

FIG. 43 is a lateral aberration diagram of the large aperture ratio ultra wide angle lens according to Example 9 of the present invention when focusing on infinity;

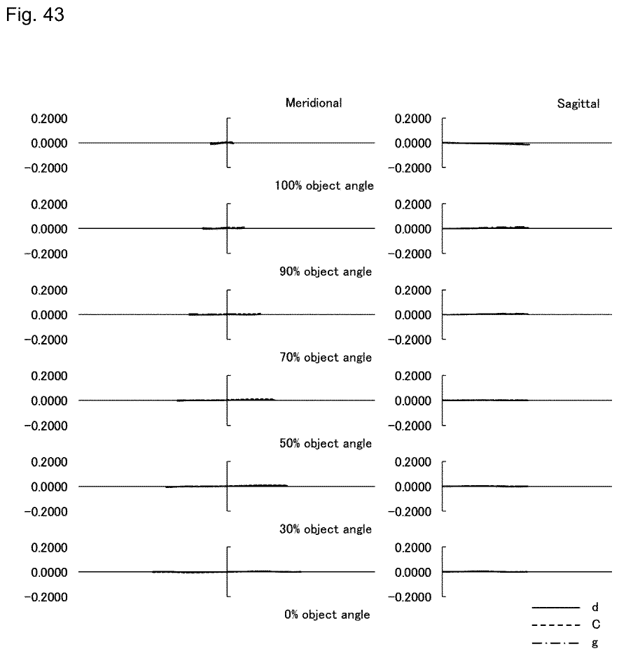

FIG. 44 is a longitudinal aberration diagram of the large aperture ratio ultra wide angle lens according to Example 9 of the present invention at the time of focusing at an object distance of 432.91 mm;

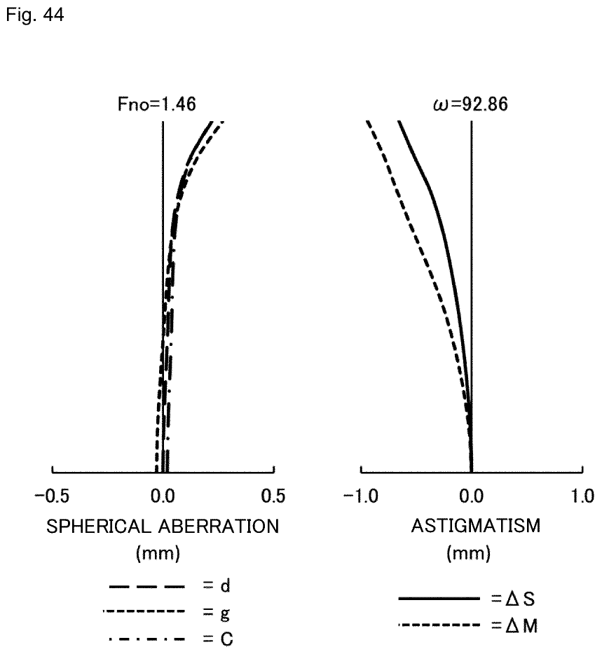

FIG. 45 is a lateral aberration diagram of the large aperture ratio ultra wide angle lens according to Example 9 of the present invention at the time of focusing at an object distance of 432.91 mm;

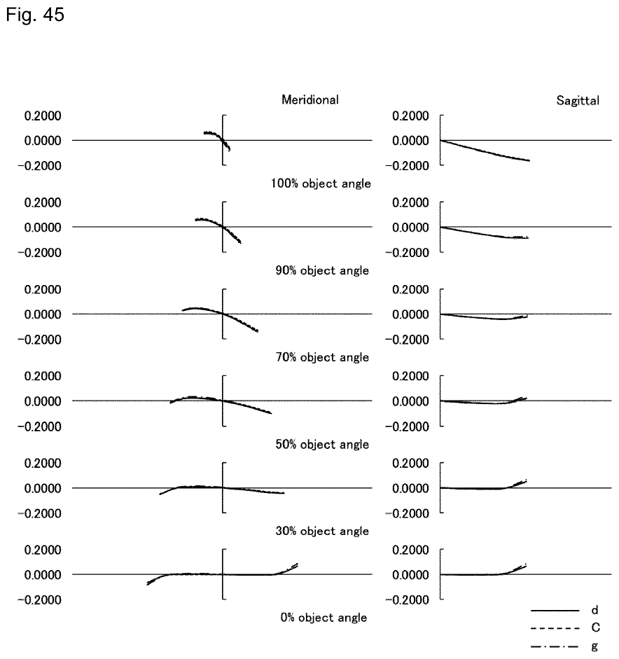

FIG. 46 is a diagram showing a lens configuration of a large aperture ratio ultra wide angle lens according to Example 10 of the present invention when focusing on infinity;

FIG. 47 is a longitudinal aberration diagram of the large aperture ratio ultra wide angle lens according to Example 10 of the present invention when focusing on infinity;

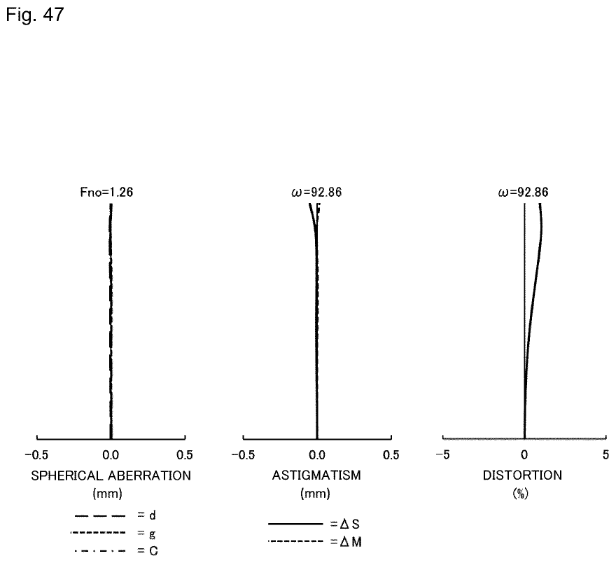

FIG. 48 is a lateral aberration diagram of the large aperture ratio ultra wide angle lens according to Example 10 of the present invention when focusing on infinity;

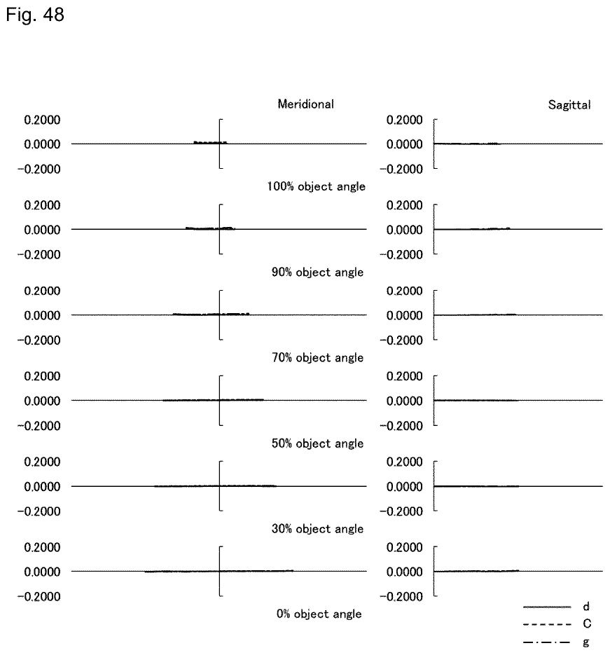

FIG. 49 is a longitudinal aberration diagram of the large aperture ratio ultra wide angle lens according to Example 10 of the present invention at the time of focusing at an object distance of 224.26 mm;

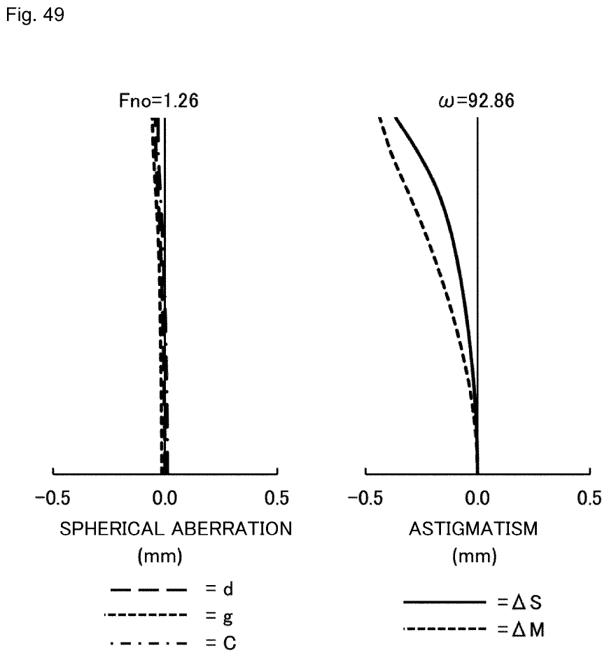

FIG. 50 is a lateral aberration diagram of the large aperture ratio ultra wide angle lens according to Example 10 of the present invention at the time of focusing at an object distance of 224.26 mm;

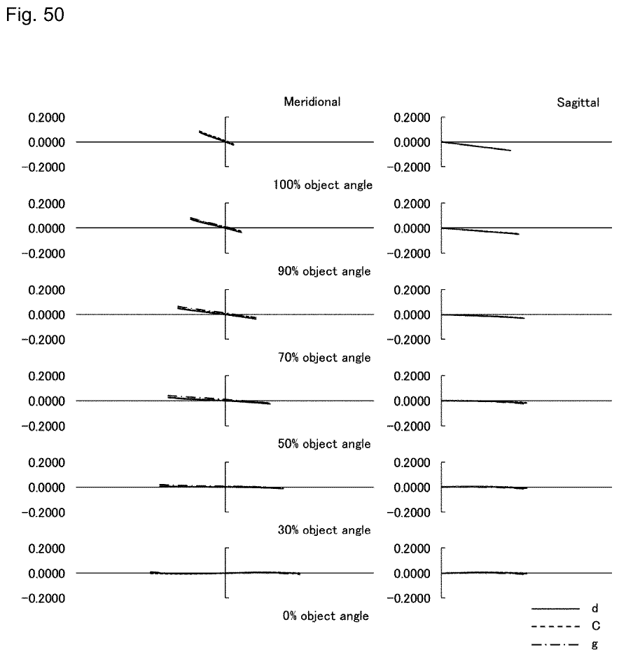

FIG. 51 is a diagram showing a lens configuration of a large aperture ratio ultra wide angle lens according to Example 11 of the present invention when focusing on infinity;

FIG. 52 is a longitudinal aberration diagram of the large aperture ratio ultra wide angle lens according to Example 11 of the present invention when focusing on infinity;

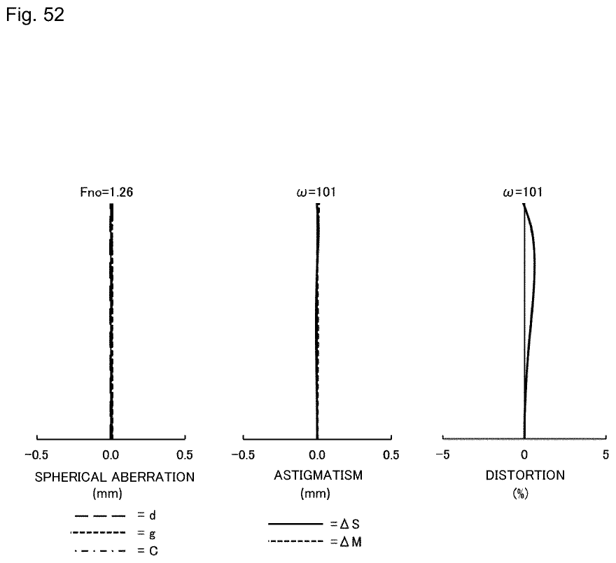

FIG. 53 is a lateral aberration diagram of the large aperture ratio ultra wide angle lens according to Example 11 of the present invention when focusing on infinity;

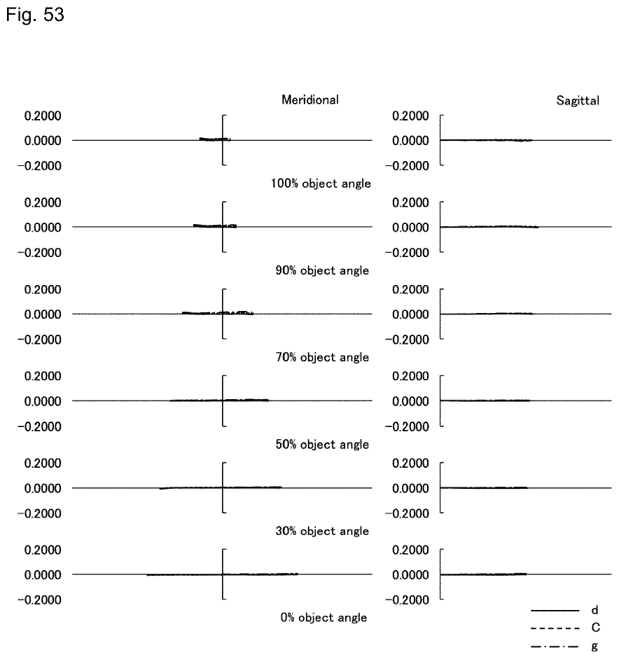

FIG. 54 is a longitudinal aberration diagram of the large aperture ratio ultra wide angle lens according to Example 11 of the present invention at the time of focusing at an object distance of 205.25 mm;

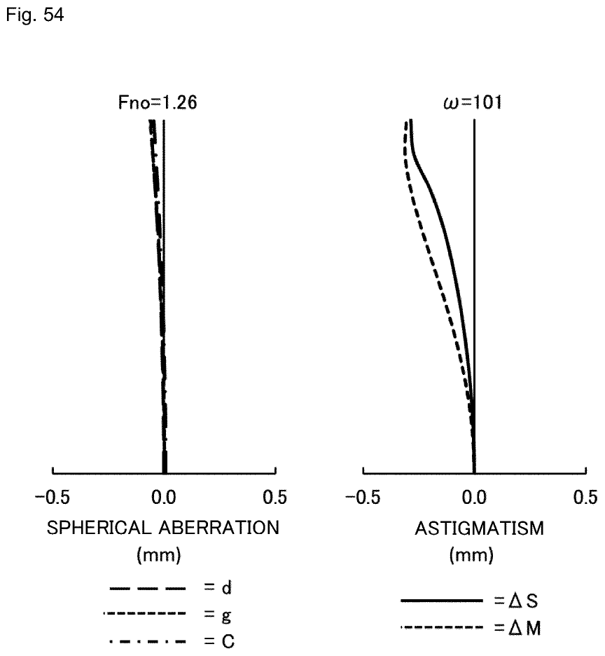

FIG. 55 is a lateral aberration diagram of the large aperture ratio ultra wide angle lens according to Example 11 of the present invention at the time of focusing at an object distance of 205.25 mm;

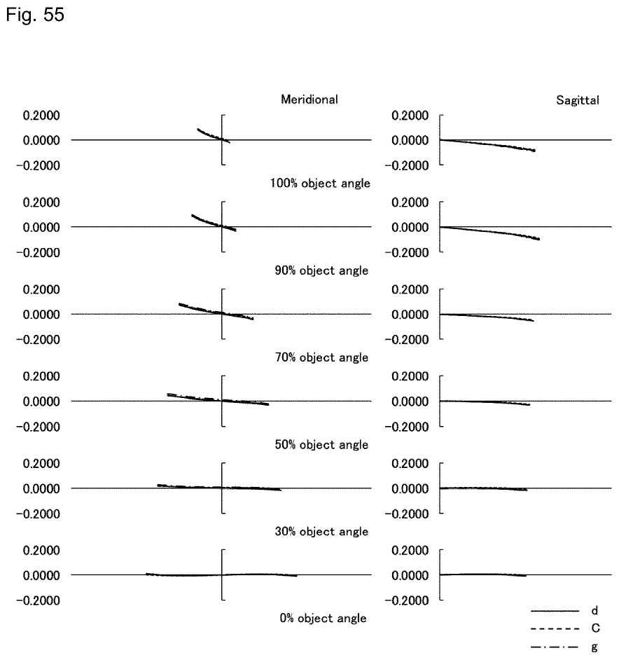

FIG. 56 is a diagram showing a lens configuration of a large aperture ratio ultra wide angle lens according to Example 12 of the present invention when focusing on infinity;

FIG. 57 is a longitudinal aberration diagram of the large aperture ratio ultra wide angle lens according to Example 12 of the present invention when focusing on infinity;

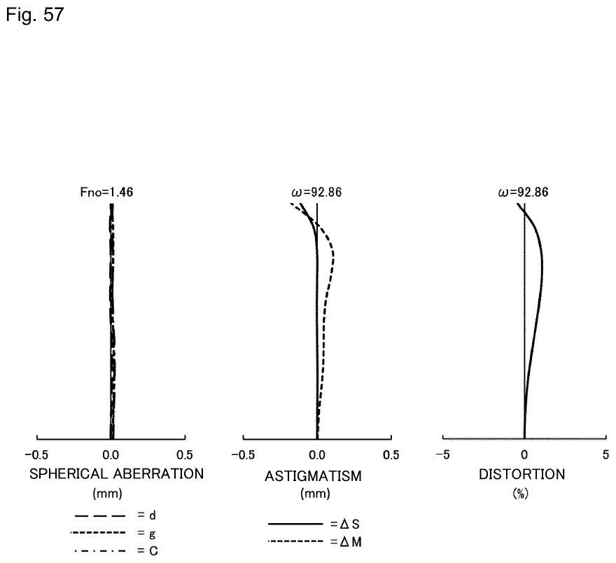

FIG. 58 is a lateral aberration diagram of a large aperture ratio ultra wide angle lens according to Example 12 of the present invention when focusing on infinity;

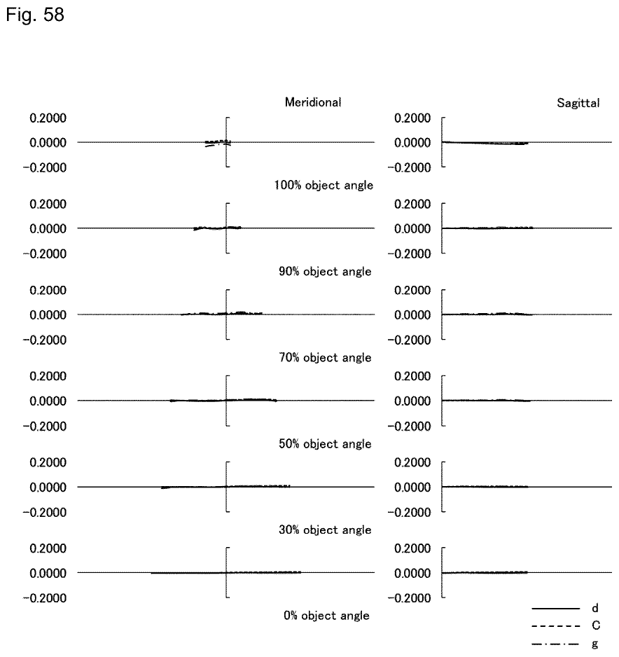

FIG. 59 is a longitudinal aberration diagram of the large aperture ratio ultra wide angle lens according to Example 12 of the present invention when focusing at an object distance of 437.67 mm;

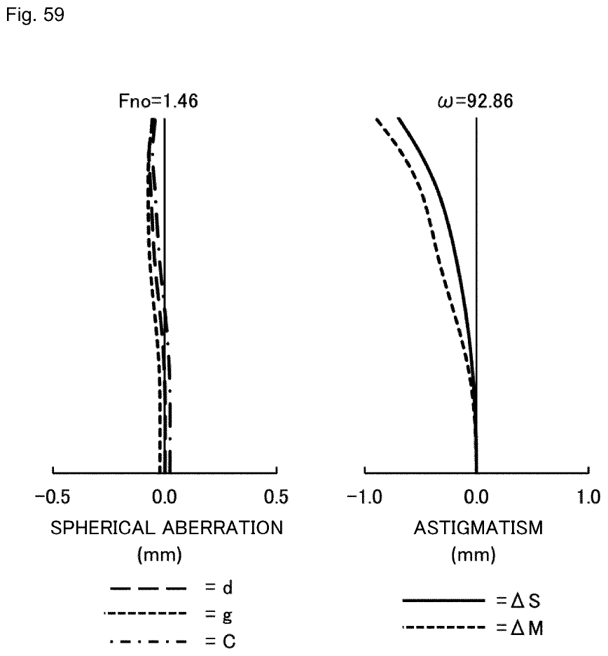

FIG. 60 is a lateral aberration diagram of the large aperture ratio ultra wide angle lens according to Example 12 of the present invention at the time of focusing at an object distance of 437.67 mm;

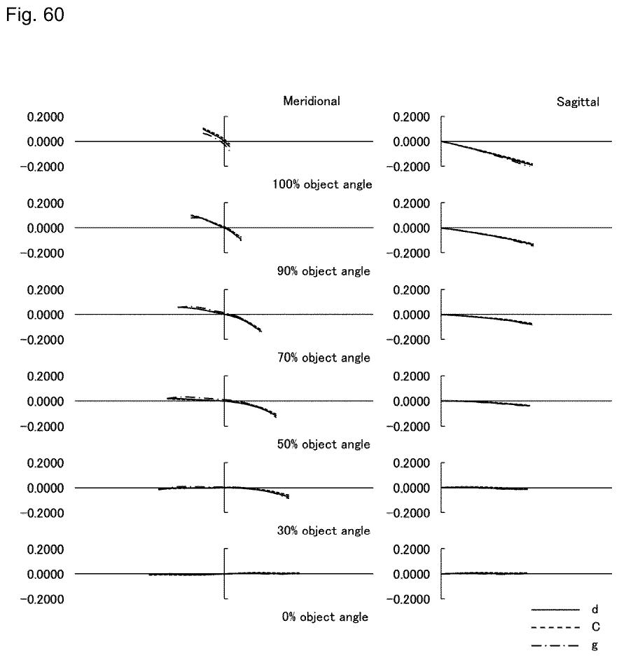

FIG. 61 is a diagram showing a lens configuration of a large aperture ratio ultra wide angle lens according to Example 13 of the present invention when focusing on infinity;

FIG. 62 is a longitudinal aberration diagram of the large aperture ratio ultra wide angle lens according to Example 13 of the present invention when focusing on infinity;

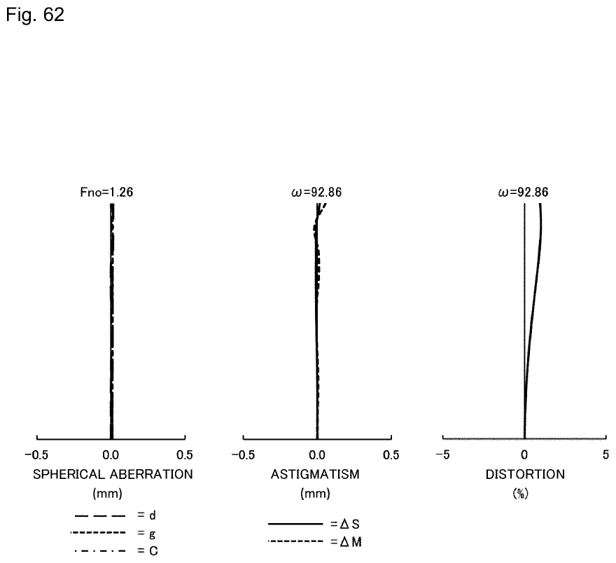

FIG. 63 is a lateral aberration diagram of the large aperture ratio ultra wide angle lens according to Example 13 of the present invention when focusing on infinity;

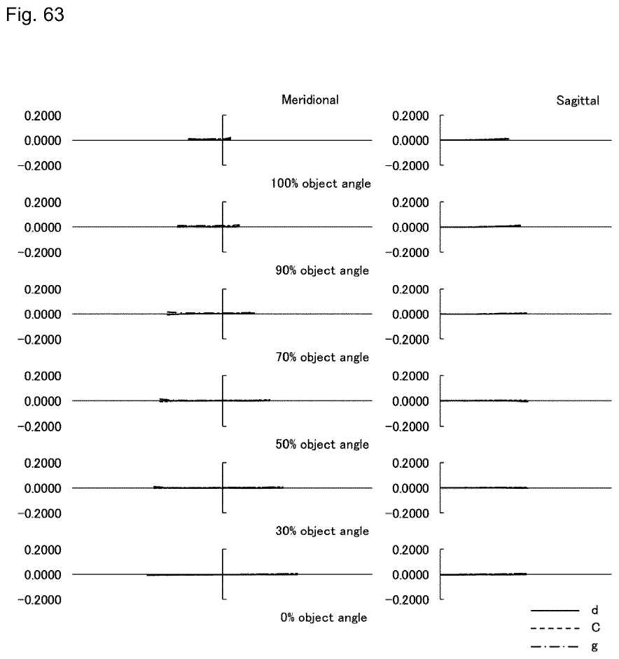

FIG. 64 is a longitudinal aberration diagram of the large aperture ratio ultra wide angle lens according to Example 13 of the present invention at the time of focusing at an object distance of 225.06 mm;

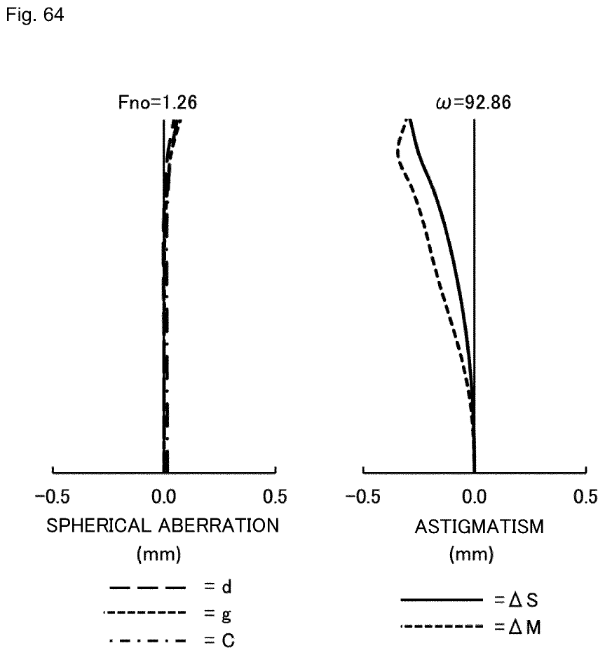

FIG. 65 is a lateral aberration diagram of the large aperture ratio ultra wide angle lens according to Example 13 of the present invention at the time of focusing at an object distance of 225.06 mm;

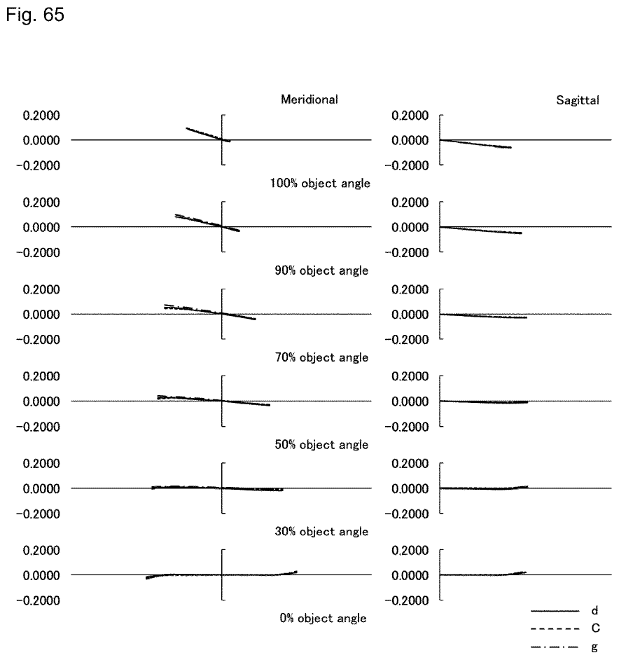

FIG. 66 is a diagram showing a lens configuration of a large aperture ratio ultra wide angle lens according to Example 14 of the present invention when focusing on infinity;

FIG. 67 is a longitudinal aberration diagram of the large aperture ratio ultra wide angle lens according to Example 14 of the present invention when focusing on infinity;

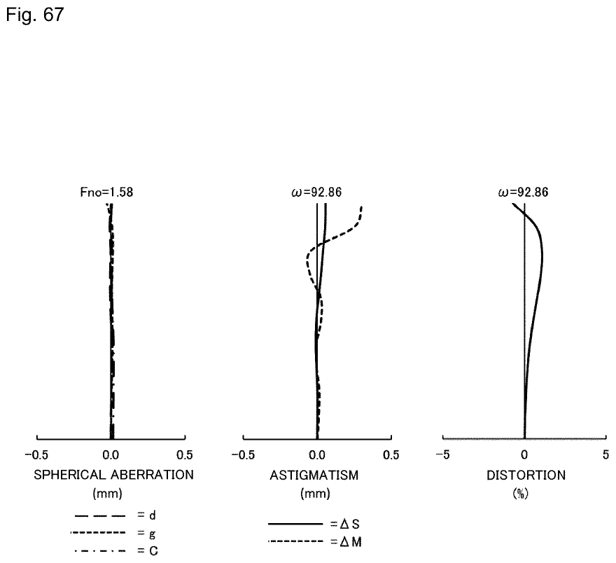

FIG. 68 is a lateral aberration diagram of the large aperture ratio ultra wide angle lens according to Example 14 of the present invention when focusing on infinity;

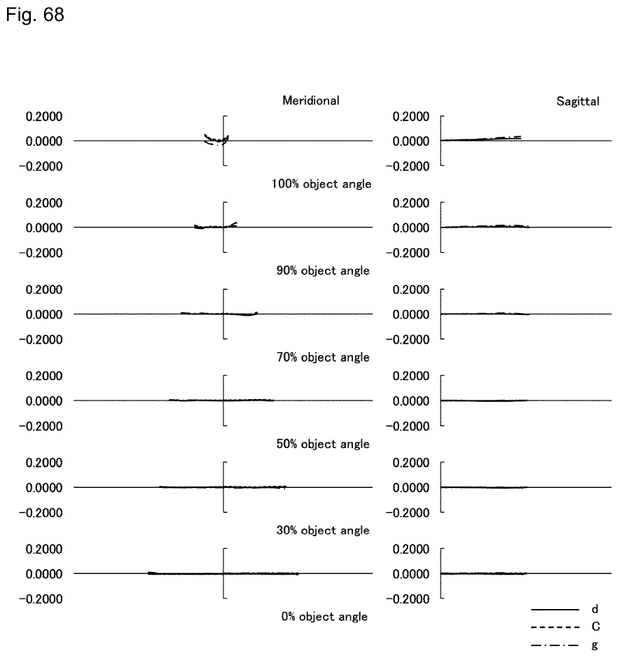

FIG. 69 is a longitudinal aberration diagram of the large aperture ratio ultra wide angle lens according to Example 14 of the present invention at the time of focusing at an object distance of 443.32 mm; and

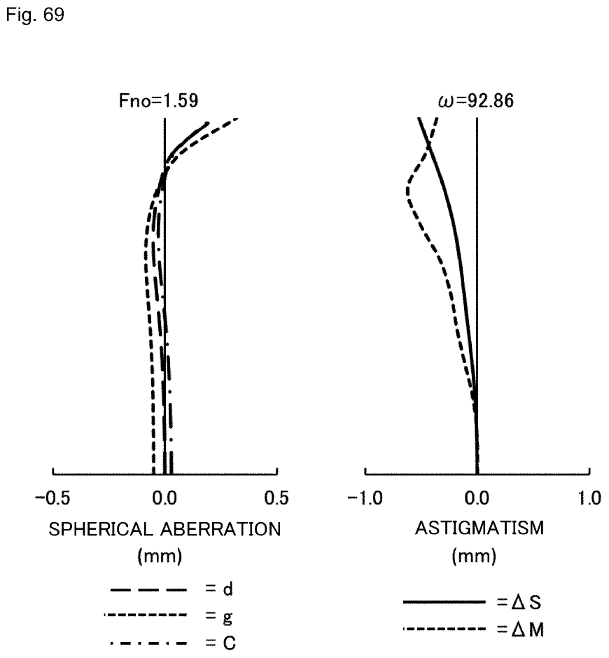

FIG. 70 is a lateral aberration diagram of the large aperture ratio ultra wide angle lens according to Example 14 of the present invention at the time of focusing at an object distance of 443.32 mm.

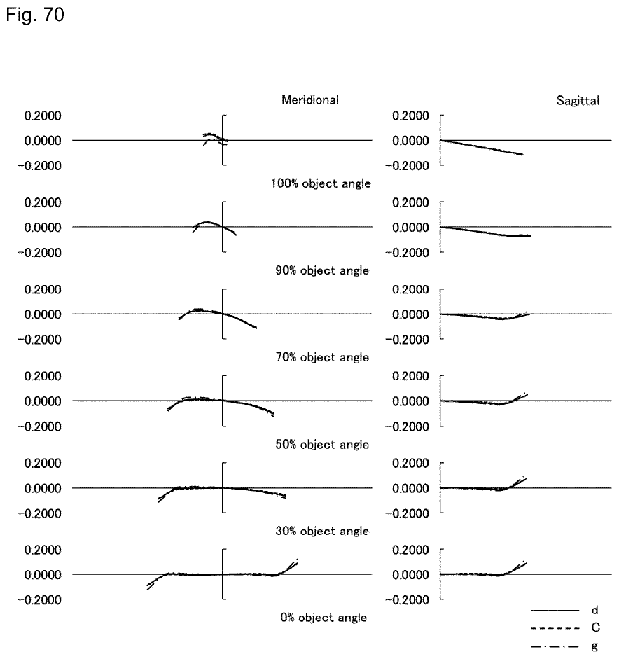

### DESCRIPTION OF THE EMBODIMENTS

A lens component specified in the present invention refers to a single lens or a cemented lens constituted by a plurality of single lenses bonded together. Thus, a meniscus negative lens component refers to a meniscus negative lens constituted by a single lens, or a cemented lens constituted by a plurality of single lenses bonded together to have a concave meniscus shape with a negative refractive power as a whole.

A meniscus specified in the present invention as a lens shape refers to object-side and image-side surfaces including curved surfaces having a curvature radius of the same sign. For example, a meniscus negative lens with its convex surface facing an object side refers to a lens in which the curvature radiuses of object-side and image-side surfaces are both positive, and the image-side surface has a smaller curvature radius. In the case of an aspheric lens, a lens shape is determined by a paraxial curvature radius.

Furthermore, when the number of lenses is counted in the present invention, unless otherwise specified, a single lens is counted as one, and in the case of a cemented lens, each single lens that configures it is counted as one. For example, a cemented lens including a convex lens and a concave lens is counted as two.

When the number of lens components is counted in the present invention, both the number of lens components including a single lens and the number of lens components including a cemented lens are each counted as one. For example, a lens component including a single lens is counted as one lens component, and a cemented lens including one convex lens and one concave lens is counted as one lens component.

As can be seen from each numerical example and a lens configuration diagram of each example, a large aperture ratio ultra wide angle lens of the present invention includes, in order from an object side, a first lens group G1, an aperture diaphragm S, and a second lens group G2, and is configured such that a meniscus negative lens component N1 with a convex surface facing the object side is disposed on a side of the first lens group G1 which is closest to the object, and a meniscus negative lens component N2, which has a higher negative refractive power than that of the meniscus negative lens component N1 and has a convex surface facing the object side, is disposed on a side closer to the image side than the meniscus negative lens component N1.

The large aperture ratio ultra wide angle lens of the present invention is an ultra wide angle lens with a total angle of view 2ω of 160° or more. In general, ultra wide angle lenses with a total angle of view 2ω of 160° or more often have a retrofocus type lens configuration, and a meniscus negative lens having a concave surface facing an object side, having a curvature radius on an image side that is significantly smaller than the curvature radius of the object-side surface, and having a concave surface that is close to a hemisphere with a large thickness deviation ratio is often disposed on a side closest to the object side. The meniscus negative lens as described above has an effect of greatly bending off-axis rays incident from the object side and lowering the ray height of the off-axis rays. In addition, lenses with a total angle of view 2ω of 160° or more are often fisheye lenses, and fisheye lenses tend to have a larger thickness deviation ratio of a meniscus negative lens on a side closest to an object side than general wide-angle lenses. This is because, in the case of a fisheye lens, it is not necessary to correct negative distortion (here, distortion refers to a case where an ideal image height is defined by central projection), and thus there are few adverse effects even when the curvature radius of an image-side surface is significantly smaller than that of an object-side surface to strengthen a negative refractive power, thereby making it possible to downsize an optical system.

The large aperture ratio ultra wide angle lens of the present invention is an extremely bright optical system as an ultra wide angle lens with an F-number of less than 1.9 and a total angle of view 2ω of 1600 or more. In such an optical system, the meniscus negative lens disposed on a side closest to the object side may account for 50% or more of the total lens weight of the entire optical system, and it is important to achieve high performance while preventing enlargement of the lens.

It is preferable for the large aperture ratio ultra wide angle lens of the present invention to satisfy the following Conditional Expressions (1) to (4) in order to achieve high performance while curbing enlargement of the optical system.

$$2 ω \geq 160 ° \qquad ( 1 )$$

$$Fno < 1.9 \qquad ( 2 )$$

$$- 6. < N 1 OAh / iOAh < - 1.1 \qquad ( 3 )$$

$$0.5 < SagN 1 / SagN 2 < 1.8 \qquad ( 4 )$$

ω: A half angle of view when focusing on infinity
Fno: An F-number when focusing on infinity
N1OAh: An off-axis chief ray height when a ray with an object-side angle of incidence of 90° is incident on the meniscus negative lens component N1 when focusing on infinity (however, when 2ω<180°, it is an off-axis chief ray height that is incident at an object-side angle of incidence ω)
iOAh: An imaging height of an off-axis chief ray when a ray with an object-side angle of incidence of 90° forms an image on an image surface when focusing on infinity (however, when 2ω<180°, it is an imaging height of an off-axis chief ray that is incident at an object-side angle of incidence ω)
SagN1: A sag from a surface vertex of an image-side surface of the meniscus negative lens component N1 (as a ray height when calculating a sag, an off-axis chief ray height when a ray with an object-side angle of incidence of 90° emerges from the surface when focusing on infinity is used. When 2ω<180°, an off-axis chief ray height that is incident at an object-side angle of incidence ω is used for calculation.)
SagN2: A sag from a surface vertex of an image-side surface of the meniscus negative lens component N2 (as a ray height when calculating a sag, an off-axis chief ray height when a ray with an object-side angle of incidence of 90° emerges from the surface when focusing on infinity is used. When 2ω<180°, an off-axis chief ray height that is incident at an object-side angle of incidence ω is used for calculation.)

Conditional Expressions (1) and (2) respectively specify a total angle of view and an F-number at the time of focusing on infinity of the large aperture ratio ultra wide angle lens of the present invention. By satisfying Conditional Expression (1), a sufficient angle of view can be obtained at the time of focusing on infinity of the large aperture ratio ultra wide angle lens. Furthermore, by satisfying Conditional Expression (2), a sufficient F-number can be obtained at the time of focusing on infinity of the large aperture ratio ultra wide angle lens.

It is preferable that a lower limit of Conditional Expression (1) be set to 180°, and an upper limit of Conditional Expression (2) be set to 1.6.

Conditional Expression (3) specifies a preferable range of a ratio of an off-axis chief ray height when a ray with an object-side angle of incidence of 90° is incident on the meniscus negative lens component N1 during focusing on infinity (however, when 2ω<180°, it is an off-axis chief ray height that is incident at an object-side angle of incidence ω) to an imaging height of an off-axis chief ray when a ray with an object-side angle of incidence of 90° forms an image on an image surface (however, when 2ω<180°, it is an imaging height of an off-axis chief ray that is incident at an object-side angle of incidence ω). The values of N1OAh and iOAh have a positive-negative relationship because the ray height of the off-axis chief ray is dealt with. Specifically, since the sign of the off-axis chief ray height is inverted before and after a diaphragm, N1OAh and iOAh have opposite signs at all times.

When the ratio of the off-axis chief ray height when the ray with an object-side angle of incidence of 90° is incident on the meniscus negative lens component N1 during focusing on infinity to the imaging height of the off-axis chief ray when the ray with an object-side angle of incidence of 90° forms an image on the image surface becomes closer to 0 and increases beyond the upper limit of Conditional Expression (3), the diameter of the meniscus negative lens component N1 relative to the imaging height becomes excessively small, thereby making it necessary to further strengthen the negative refractive power of the meniscus negative lens component N1, which undesirably leads to astigmatism and deterioration of field curvature.

When N1OAh becomes small relative to iOAh, and the ratio of the off-axis chief ray height when the ray with an object-side angle of incidence of 90° is incident on the meniscus negative lens component N1 during focusing on infinity to the imaging height of the off-axis chief ray when the ray with an object-side angle of incidence of 90° forms an image on the image surface decreases away from 0 beyond the lower limit of Conditional Expression (3), the diameter of the meniscus negative lens component N1 relative to the imaging height becomes excessively large, which undesirably leads to enlargement of the optical system.

Regarding Conditional Expression (3), it is preferable to set the upper limit to −1.2 and the lower limit to −4.1, and more preferable to set the lower limit to −3.5, thereby making it possible to ensure the above-mentioned effect further.

Conditional Expression (4) specifies a ratio between sags of image-side surfaces of the meniscus negative lens component N1 and the meniscus negative lens component N2 (as a ray height when calculating a sag, an off-axis chief ray height when a ray with an object-side angle of incidence of 90° emerges from the surface when focusing on infinity is used. When 2ω<180°, an off-axis chief ray height that is incident at an object-side angle of incidence ω is used for calculation). As mentioned above, in ultra wide angle lenses with a total angle of view 2ω of 160° or more, a meniscus negative lens with its convex surface facing the object side, having a curvature radius of the image-side surface that is significantly smaller than the curvature radius of the object-side surface, and having a large sag of the image-side surface is generally disposed. In particular, in fisheye lenses, there are many examples in which an image-side surface having a shape close to a hemisphere is adopted. However, it is difficult to improve the processing accuracy of such a concave surface with a large curvature and sag. In addition, when a general interferometer is used as a means for measuring the surface accuracy of a lens, the larger the curvature, the smaller the measurable diameter becomes, and in the case of a concave surface having a shape close to a hemisphere, it is often difficult to measure a peripheral area with an interferometer. In the case of a bright optical system such as in the present invention with an F-number of less than 1.9, the depth of focus is shallow, and thus it is necessary to process optical elements with higher accuracy, and the curvature radiuses and sags of the image-side surfaces of the meniscus negative lens component N1 and the meniscus negative lens component N2 need to be taken into consideration for workability and measurement accuracy.

When the ratio of the sag of the image-side surface of the meniscus negative lens component N1 to the sag of the image-side surface of the meniscus negative lens component N2 becomes large beyond the upper limit of Conditional Expression (4), the sag of the image-side surface of the meniscus negative lens component N1, which has a larger effective diameter, increases, and workability and measurement accuracy deteriorate. In addition, the negative refractive power of the meniscus negative lens component N1 becomes excessively large, thereby making it difficult to correct astigmatism and field curvature, which is not preferable.

When the ratio of the sag of the image-side surface of the meniscus negative lens component N1 to the sag of the image-side surface of the meniscus negative lens component N2 becomes small beyond the lower limit of Conditional Expression (4), the sag of the image-side surface of the meniscus negative lens component N2 increases, and workability and measurement accuracy deteriorate. Furthermore, the negative refractive power of the meniscus negative lens component N2 becomes excessively large, thereby making it difficult to correct astigmatism and field curvature, which is not preferable.

Furthermore, regarding Conditional Expression (4), it is preferable to set the upper limit to 1.72 and set the lower limit to 0.60, and more preferable to set the upper limit to 1.40 and set the lower limit to 0.70, thereby making it possible to ensure the above-mentioned effect further.

In the large aperture ratio ultra wide angle lens of the present invention, it is preferable that the meniscus negative lens component N1 and the meniscus negative lens component N2 satisfy the following Conditional Expression (5).

$$0.4 < fN 1 / fN 2 < 5. \qquad ( 5 )$$

fN1: A focal length of the meniscus negative lens component N1
fN2: A focal length of THE meniscus negative lens component N2

Conditional Expression (5) specifies a ratio of the focal length of the meniscus negative lens component N1 to the focal length of the meniscus negative lens component N2. The lens on the object side of the large aperture ratio ultra wide angle lens of the present invention is apt to be enlarged when an F-number is reduced or an angle of view is widened while maintaining high optical performance. By appropriately setting the focal lengths of the meniscus negative lens component N1 and the meniscus negative lens component N2 and configuring them to appropriately share the negative refractive power, it is possible to curb the enlargement of the optical system while maintaining high optical performance.

When the ratio between the focal lengths of the meniscus negative lens component N1 and the meniscus negative lens component N2 becomes large beyond the upper limit of Conditional Expression (5), the negative refractive power of the meniscus negative lens component N2 becomes excessively large, thereby making it difficult to correct astigmatism and field curvature, which is not preferable.

When the ratio between the focal lengths of the meniscus negative lens component N1 and the meniscus negative lens component N2 becomes small below the lower limit of Conditional Expression (5), the negative refractive power of the meniscus negative lens component N1 becomes excessively large, thereby making it difficult to correct astigmatism and field curvature. In addition, the curvature radius of the image side of the meniscus negative lens component N1 becomes small, a sag increases, workability and measurement accuracy deteriorate, and a thickness deviation ratio of the lens increases. Since the meniscus negative lens component N1 is located closer to the object side than the meniscus negative lens component N2 and has a larger lens diameter, an increase in the weight of the lens tends to be larger in the meniscus negative lens component N1 when the thickness deviation ratio increases. Thus, this tends to lead to an increase in the weight of the entire optical system, which is not preferable.

Regarding Conditional Expression (5), it is preferable to set the upper limit to 4.3 and set the lower limit to 0.7, thereby making it possible to ensure the above-mentioned effect further.

In the large aperture ratio ultra wide angle lens of the present invention, it is preferable that the meniscus negative lens component N1 satisfy the following Conditional Expression (6).

$$1.5 < N 1 SF < 6. \qquad ( 6 )$$

$$N 1 SF = ( N 1 R 1 + N 1 R 2 ) / ( N 1 R 1 - N 1 R 2 )$$

N1R1: A curvature radius of the object-side surface of the meniscus negative lens component N1
N1R2: A curvature radius of the image-side surface of the meniscus negative lens component N1

Conditional Expression (6) specifies a lens shape of the meniscus negative lens component N1, that is, a so-called shape factor. Since the meniscus negative lens component N1 has a concave meniscus shape with a convex surface facing the object side, both N1R1 and N1R2 are larger than 0, N1R1 is larger than N1R2, and N1SF becomes larger as a difference between N1R1 and N1R2 becomes smaller and N1SF becomes closer to 1 as the difference between N1R1 and N1R2 becomes larger. Thus, when the refractive index of the meniscus negative lens component N1 does not change, the closer N1SF is to 1, the higher the negative refractive power of the meniscus negative lens component N1 will be, and the greater the sag of the image-side surface of the meniscus negative lens component N1 will be.

When N1SF of the meniscus negative lens component N1 becomes large beyond the upper limit of Conditional Expression (6), a difference between N1R1 and N1R2 becomes small, the negative refractive power of the meniscus negative lens component N1 decreases, the insufficient refractive power is compensated for by the meniscus negative lens component N2, and the negative refractive power of the meniscus negative lens component N2 becomes excessively large, thereby making it difficult to correct astigmatism and field curvature, which is not preferable.

When N1SF of the meniscus negative lens component N1 decreases and becomes closer to 1 below the lower limit of Conditional Expression (6), the difference between N1R1 and N1R2 becomes large, and the negative refractive power of the meniscus negative lens component N1 becomes excessively large, which leads to astigmatism and deterioration of field curvature. In particular, the curvature radius N1R2 of the image-side surface becomes small, resulting in an increase in sag and deterioration of workability and measurement accuracy. Furthermore, the thickness deviation ratio of the meniscus negative lens component N1, which has the largest lens diameter, increases, which undesirably leads to an increase in the weight of the optical system.

Regarding Conditional Expression (6), it is preferable to set the upper limit to 4.5 and set the lower limit to 1.7, and more preferable to set the upper limit to 4.3 and set the lower limit to 2.2, thereby making it possible to ensure the above-mentioned effect further.

In the large aperture ratio ultra wide angle lens of the present invention, it is preferable that the meniscus negative lens component N2 satisfy the following Conditional Expression (7).

$$1.2 < N 2 SF < 5. \qquad ( 7 )$$

$$N 2 SF = ( N 2 R 1 + N 2 R 2 ) / ( N 2 R 1 - N 2 R 2 )$$

N2R1: A curvature radius of the object-side surface of the meniscus negative lens component N2
N2R2: A curvature radius of the image-side surface of the meniscus negative lens component N2

Conditional Expression (7) specifies a lens shape of the meniscus negative lens component N2, that is, a so-called shape factor. Since the meniscus negative lens component N2 has a concave meniscus shape with a convex surface facing the object side, both N2R1 and N2R2 are larger than 0, N2R1 is larger than N2R2, and N2SF becomes larger as a difference between N2R1 and N2R2 becomes smaller, and N2SF becomes closer to 1 as the difference between N2R1 and N2R2 becomes larger. Thus, when the refractive index of the meniscus negative lens component N2 does not change, the closer N2SF is to 1, the higher the negative refractive power of the meniscus negative lens component N2 will be, and the greater the sag of the image-side surface of the meniscus negative lens component N2 will be.

When N2SF of the meniscus negative lens component N2 becomes large beyond the upper limit of Conditional Expression (7), a difference between N2R1 and N2R2 becomes small, the negative refractive power of the meniscus negative lens component N2 decreases, the insufficient refractive power is compensated for by the meniscus negative lens component N1, and the negative refractive power of the meniscus negative lens component N1 becomes excessively large, thereby making it difficult to correct astigmatism and field curvature. At the same time, the difference in curvature radius between the object-side surface and the image-side surface of the meniscus negative lens component N1 becomes large, and in particular, the curvature radius N1R2 of the image-side surface becomes small, so that sag increases and workability and measurement accuracy deteriorate. In addition, the thickness deviation ratio of the meniscus negative lens component N1, which has the largest lens diameter, increases, which undesirably leads to an increase in the weight of the optical system.

When N2SF of the meniscus negative lens component N2 decreases and becomes closer to 1 below the lower limit of Conditional Expression (7), the negative refractive power of the meniscus negative lens component N2 becomes excessively large, thereby making it difficult to correct astigmatism and field curvature. At the same time, a difference in curvature radius between the object-side surface and the image-side surface of the meniscus negative lens component N2 becomes large, and in particular, the curvature radius N1R2 of the image-side surface becomes small, which undesirably leads to an increase in a sag and deterioration of workability and measurement accuracy.

Regarding Conditional Expression (7), it is preferable to set the upper limit to 4.0 and set the lower limit to 1.6, thereby making it possible to ensure the above-mentioned effect further.

In the large aperture ratio ultra wide angle lens of the present invention, it is preferable that the meniscus negative lens component N1 and the meniscus negative lens component N2 satisfy the following Conditional Expression (8).

$$0.4 < N 1 SF / N 2 SF < 3. \qquad ( 8 )$$

$$N 1 SF = ( N 1 R 1 + N 1 R 2 ) / ( N 1 R 1 - N 1 R 2 )$$

N1R1: A curvature radius of the object-side surface of the meniscus negative lens component N1
N1R2: A curvature radius of the image-side surface of the meniscus negative lens component N1

$$N 2 SF = ( N 2 R 1 + N 2 R 2 ) / ( N 2 R 1 - N 2 R 2 )$$

N2R1: A curvature radius of the object-side surface of the meniscus negative lens component N2
N2R2: A curvature radius of the image-side surface of the meniscus negative lens component N2

Conditional Expression (8) specifies a ratio of the shape factor of the meniscus negative lens component N1 to the shape factor of the meniscus negative lens component N2. The lens on the object side of the large aperture ratio ultra wide angle lens is apt to be enlarged when an F-number is reduced or an angle of view is widened while maintaining high optical performance. By appropriately setting the shape factors of the meniscus negative lens component N1 and the meniscus negative lens component N2, it becomes possible to configure them so that they appropriately share the negative refractive power. As mentioned above, the meniscus negative lens component N1 and the meniscus negative lens component N2 need to be machined with high accuracy, and they need to be set to have a shape that makes this easy to achieve.

When the ratio of the shape factor of the meniscus negative lens component N1 to the shape factor of the meniscus negative lens component N2 becomes large beyond the upper limit of Conditional Expression (8), this means that the value of N2SF becomes small relative to N1SF. When N2SF becomes closer to 1 and decreases, a difference in curvature radius between the object-side surface and the image-side surface of the meniscus negative lens component N2 becomes large, and in particular, the curvature radius of the image-side surface becomes small, resulting in an increase in sag and deterioration of workability and measurement accuracy. Furthermore, the negative refractive power of the meniscus negative lens component N2 becomes excessively large, thereby making it difficult to correct astigmatism and field curvature, which is not preferable.

When the ratio of the shape factor of the meniscus negative lens component N1 to the shape factor of the meniscus negative lens component N2 becomes small below the lower limit of Conditional Expression (8), this means that the value of N1SF becomes small relative to N2SF. When N1SF becomes closer to 1 and decreases, a difference in curvature radius between the object-side surface and the image-side surface of the meniscus negative lens component N1 becomes large, and in particular, the curvature radius of the image-side surface becomes small, resulting in an increase in sag and deterioration of workability and measurement accuracy. In addition, the thickness deviation ratio of the meniscus negative lens component N1, which has the largest lens diameter, increases, which undesirably leads to an increase in the weight of the optical system. Furthermore, the negative refractive power of the meniscus negative lens component N1 becomes excessively large, thereby making it difficult to correct astigmatism and field curvature, which is not preferable.

Regarding Conditional Expression (8), it is preferable to set the upper limit to 2.4 and set the lower limit to 0.5, thereby making it possible to ensure the above-mentioned effect further.

In the large aperture ratio ultra wide angle lens of the present invention, it is preferable that the meniscus negative lens component N1 satisfy the following Conditional Expression (9).

$$1.8 < PLOAN 1 / PLAN 1 < 5. \qquad ( 9 )$$

PLOAN1: A distance at which an off-axis chief ray passes through the meniscus negative lens component N1 when a ray incident at an object-side angle of incidence of 90° when focusing on infinity is an off-axis ray (however, when 2ω<180°, a ray incident at an object-side angle of incidence ω is an off-axis ray)
PLAN1: The thickness of the meniscus negative lens component N1 on the optical axis

Conditional Expression (9) specifies a ratio of a passing distance of an axial ray that passes through the meniscus negative lens component N1 to a passing distance of an off-axis chief ray. The off-axis ray is defined as a ray with an object-side angle of incidence of 90° when focusing on infinity (however, when 2ω<180°, a ray incident at an object-side angle of incidence ω is an off-axis ray). Since the lens closest to the object side of the large aperture ratio ultra wide angle lens according to the present invention has a concave meniscus shape with a convex surface facing the object side, it is characterized by a large passing distance in the lens of the off-axis ray relative to the axial ray. In the case of a lens shape in which the curvature radius of the image-side surface is further smaller than that of the object-side surface (a lens shape in which a sag of the image-side surface is large and the thickness deviation ratio is also large), a difference in the passing distance of the off-axis ray within the lens with respect to that of the axial ray becomes further larger. In order to downsize the ultra wide angle lens, it is effective to use a high refractive index glass material for the lens closest to the object side, but generally, the higher the refractive index of a glass material, the lower the internal transmittance of the glass material tends to be, and particularly, transmittance on a short wavelength side deteriorates, which makes the lens look yellowish. When such a glass material with low internal transmittance is used for the meniscus negative lens component N1, unless the difference in the passing distance between the axial ray and the off-axial ray is kept within an appropriate range, a phenomenon occurs in which the color varies depending on the angle of view (the image becomes yellowish toward the periphery of a screen), which is not preferable. A similar phenomenon also occurs with the meniscus negative lens component N2 which has a similar optical path to the meniscus negative lens component N1, but the effect is greater with the meniscus negative lens component N1 which has a larger lens diameter and a longer light passing distance within the lens.

When the ratio of the passing distance of the axial ray that passes through the meniscus negative lens component N1 to the passing distance of the off-axis chief ray becomes large beyond the upper limit of Conditional Expression (9), the passing distance of the off-axis ray become large relative to the axial ray passing through the meniscus negative lens component N1, and thus the transmittance of the off-axis ray significantly decreases relative to the transmittance of the axial ray, thereby leading to an increase in a difference in color due to the angle of view, which is not preferable.

When the ratio of the passing distance of the axial ray that passes through the meniscus negative lens component N1 to the passing distance of the off-axis chief ray becomes small below the lower limit of Conditional Expression (9), the negative refractive power of the meniscus negative lens component N1 becomes insufficient, and in order to compensate for this, the refractive power of the meniscus negative lens component N2 becomes excessively large, thereby leading to astigmatism and deterioration of field curvature, which is not preferable.

Regarding Conditional Expression (9), it is preferable to set the upper limit to 4.2 and set the lower limit to 2.0, thereby making it possible to ensure the above-mentioned effect further.

In the large aperture ratio ultra wide angle lens of the present invention, it is preferable that the meniscus negative lens component N1 and the meniscus negative lens component N2 satisfy the following Conditional Expression (10).

$$0.3 < PLOAN 1 / PLOAN 2 < 3.5 \qquad ( 10 )$$

PLOAN1: A distance at which an off-axis chief ray passes through the meniscus negative lens component N1 when a ray incident at an object-side angle of incidence of 90° when focusing on infinity is an off-axis ray (however, when 2ω<180°, a ray incident at an object-side angle of incidence ω is an off-axis ray)
PLOAN2: A distance at which an off-axis chief ray passes through the meniscus negative lens component N2 when a ray incident at an object-side angle of incidence of 90° when focusing on infinity is an off-axis ray (however, when 2ω<180°, a ray incident at an object-side angle of incidence ω is an off-axis ray)

Conditional Expression (10) specifies a ratio of a passing distance of an off-axis chief ray that passes through the meniscus negative lens component N1 to a passing distance of an off-axis chief ray that passes through the meniscus negative lens component N2. The off-axis ray is defined as a ray with an object-side angle of incidence of 90° when focusing on infinity (however, when 2ω<180°, a ray incident at an object-side angle of incidence ω is an off-axis ray). In the description of Conditional Expression (9), it is clearly stated that the difference in passing distance between the axial ray and the off-axis ray of the meniscus negative lens component N1 may affect a change in color due to an angle of view, but the same phenomenon also occurs in the meniscus negative lens component N2 which has a similar lens shape and a similar manner of passing of rays. Thus, passing distances of the off-axis ray passing through the meniscus negative lens component N1 and the meniscus negative lens component N2 are set within an appropriate range, and thus it is possible to obtain a satisfactory image with little change in color due to an angle of view.

When the ratio of the passing distance of the off-axis chief ray that passes through the meniscus negative lens component N1 to the passing distance of the off-axis chief ray that passes through the meniscus negative lens component N2 becomes large beyond the upper limit of Conditional Expression (10), the distance of the off-axis ray passing through the meniscus negative lens component N1 becomes large, thereby making it easier for color to change due to an angle of view. In addition, the thickness deviation ratio of the meniscus negative lens component N1, which has the largest lens diameter, changes in an increasing direction, which undesirably leads to an increase in the weight of the optical system. Furthermore, the negative refractive power of the meniscus negative lens component N1 becomes excessively large, thereby making it difficult to correct astigmatism and field curvature, which is not preferable.

When the ratio of the passing distance of the off-axis chief ray that passes through the meniscus negative lens component N1 to the passing distance of the off-axis chief ray that passes through the meniscus negative lens component N2 becomes small below the lower limit of the Conditional Expression (10), the distance of the off-axis ray passing through the meniscus negative lens component N2 becomes large, thereby making it easier for color to change due to an angle of view. In addition, the thickness deviation ratio of the meniscus negative lens component N2 changes in an increasing direction, the negative refractive power of the meniscus negative lens component N2 becomes excessively large, thereby leading to astigmatism and deterioration of field curvature, which is not preferable.

Regarding Conditional Expression (10), it is possible to set the upper limit to 2.8 and set the lower limit to 0.6, thereby making it possible to ensure the above-mentioned effect further.

In the large aperture ratio ultra wide angle lens of the present invention, it is preferable that the second lens group G2 have a convex lens LP1 that satisfies the following Conditional Expressions (11) to (13).

$$1.6 < ndLP 1 \qquad ( 11 )$$

$$vdLP 1 < 35. \qquad ( 12 )$$

$$0.018 < Δ PgFLP 1 \qquad ( 13 )$$

ndLP1: A refractive index of the convex lens LP1
vdLP1: An Abbe number of the convex lens LP1
ΔPgFLP1: Anomalous dispersion of the convex lens LP1

Conditional Expressions (11) to (13) specify desirable ranges of a refractive index, an Abbe number, and anomalous dispersion of the convex lens LP1 of the second lens group G2. In retrofocus type ultra wide angle lenses, it is common to dispose a glass material with positive anomalous dispersion on a convex lens on an image side of a diaphragm. This is related to the tendency of lateral chromatic aberration and axial chromatic aberration to occur in retrofocus type ultra wide angle lenses. In lateral chromatic aberration, a C-line tends to remain in an over-axis direction, and when the design is made to correct the C-line and a g-line, a secondary spectrum will remain in the over-axis direction. In axial chromatic aberration, a C-line tends to remain in an over-axis direction in general single-focus lenses (synonymous with the focal length of the C-line becoming longer), and when the design is made to correct the C-line and a g-line, a secondary spectrum will remain in the over-axis direction. When a glass material with positive anomalous dispersion is used for a convex lens disposed on an image side of a diaphragm, the correct direction of the lateral chromatic aberration and the correct direction of the axial chromatic aberration will match, thereby making it possible to correct the chromatic aberration more effectively. Generally, fluorite or similar special low dispersion glass is used as a glass material with positive anomalous dispersion. Since many of these special low dispersion glasses are glass materials with a low refractive index, using them frequently for a convex lens on an image side of a diaphragm acts against the correction of the Petzval sum, thereby making it difficult to correct field curvature. Since the large aperture ratio ultra wide angle lens of the present invention is bright with an F-number of less than 1.9, correction of axial chromatic aberration is essential to improving performance, and there is no choice but to use many special low dispersion glass with positive anomalous dispersion in a convex lens on an image side of a diaphragm. However, in order to correct the deteriorating Petzval sum, a glass material with a refractive index of 1.6 or more and positive anomalous dispersion (a representative glass material is E-FDS1-W or the like made by HOYA Corporation) is disposed in the second lens group G2 on the image side of the diaphragm, thereby configuring it to effectively correct lateral chromatic aberration and axial chromatic aberration while also appropriately correcting field curvature.

When the refractive index of the convex lens LP1 falls below the lower limit of Conditional Expression (11), the Petzval sum deteriorates and it becomes difficult to correct field curvature, which is not preferable.

Regarding Conditional Expression (11), it is preferable to set the lower limit to 1.65, and more preferable to set the lower limit to 1.85, thereby making it possible to ensure the above-mentioned effect further.

In general, for glass materials within the range of Conditional Expression (11), the smaller the Abbe number, the larger the positive anomalous dispersion, and the larger the Abbe number, the smaller the positive anomalous dispersion, and some glass materials may have negative anomalous dispersion. Thus, when the Abbe number of the convex lens LP1 becomes large beyond the upper limit of the Conditional Expression (12), the anomalous dispersion becomes small, which makes it difficult to correct the lateral chromatic aberration and the axial chromatic aberration, which is not preferable.

Regarding Conditional Expression (12), it is preferable to set the upper limit to 32.0, and more preferable to set the upper limit to 28.0, thereby making it possible to ensure the above-mentioned effect further.

When the anomalous dispersion of the convex lens LP1 becomes small below the lower limit of Conditional Expression (13), it becomes difficult to correct the lateral chromatic aberration and the axial chromatic aberration, which is not preferable.

Regarding Conditional Expression (13), it is preferable to set the lower limit to 0.020, and more preferable to set the lower limit to 0.025, thereby making it possible to ensure the above-mentioned effect further.

In the large aperture ratio ultra wide angle lens of the present invention, it is preferable that the first lens group G1 have a negative refractive power and satisfy the following Conditional Expression (14).

$$- 0.4 < f / f 1 < 0.7 \qquad ( 14 )$$

f: A focal length of the entire system when focusing on infinity
f1: A focal length of first lens group G1 when focusing on infinity

Conditional Expression (14) specifies a ratio of a focal length of the entire system when focusing on infinity to a focal length of the first lens group G1 when focusing on infinity. By satisfying Conditional Expression (14), the optical system is prevented from being enlarged while achieving a wide angle of view.

When the ratio of the focal length of the entire system when focusing on infinity to the focal length of the first lens group G1 when focusing on infinity becomes large beyond the upper limit of Conditional Expression (14), f1 takes a positive value and becomes closer to 0, and the positive refractive power of the first lens group G1 increases, thereby making it difficult to achieve a wide angle of view, which is not preferable.

When the ratio of the focal length of the entire system when focusing on infinity to the focal length of the first lens group G1 when focusing on infinity becomes small below the lower limit of Conditional Expression (14), f1 takes a negative value and becomes closer to 0, and the negative refractive power of the first lens group G1 excessively increases, thereby leading to astigmatism and deterioration of field curvature, which is not preferable.

Regarding Conditional Expression (14), it is preferable to set the upper limit to 0.60 and set the lower limit to −0.25, thereby making it possible to ensure the above-mentioned effect further.

In the large aperture ratio ultra wide angle lens of the present invention, it is preferable that the first lens group G1 and the second lens group G2 having a positive refractive power satisfy the following Conditional Expression (15).

$$- 0.8 < f 2 / f 1 < 2.7 \qquad ( 15 )$$

f1: A focal length of the first lens group G1 when focusing on infinity
f2: A focal length of the second lens group G2 when focusing on infinity

Conditional Expression (15) specifies a ratio of the focal length of the second lens group G2 when focusing on infinity to the focal length of the first lens group G1 when focusing on infinity. By satisfying Conditional Expression (15), the optical system is prevented from being enlarged while achieving a wide angle of view.

When the ratio of the focal length of the second lens group G2 when focusing on infinity to the focal length of the first lens group G1 when focusing on infinity becomes large beyond the upper limit of Conditional Expression (15), f1 takes a positive value and becomes closer to 0, and the positive refractive power of the first lens group G1 increases, thereby making it difficult to achieve a wide angle of view, which is not preferable.

When the ratio of the focal length of the second lens group G2 when focusing on infinity to the focal length of the first lens group G1 when focusing on infinity becomes small below the lower limit of Conditional Expression (15), f1 takes a negative value and becomes closer to 0, and the negative refractive power of the first lens group G1 excessively increases, thereby leading to astigmatism and deterioration of field curvature, which is not preferable.

Regarding Conditional Expression (15), it is preferable to set the upper limit to 2.6 and set the lower limit to −0.7, thereby making it possible to ensure the above-mentioned effect further.

In the large aperture ratio ultra wide angle lens of the present invention, it is preferable that the second lens group G2 have at least one convex lens satisfying the following Conditional Expression (16), and it is preferable that the following Conditional Expression (17) be satisfied.

$$0.3 < G 2 LPAXh / G 2 LPOAh < 2.7 \qquad ( 16 )$$

$$0.004 < G 2 LPAve \qquad ( 17 )$$

G2LPAXh: An axial marginal ray height incident on a convex lens when focusing on infinity in a diaphragm open state
G2LPOAh: An off-axis chief ray height when a ray with an object-side angle of incidence of 90° is incident on a convex lens when focusing on infinity (however, when 2ω<180°, it is an off-axis chief ray height that is incident at an object-side angle of incidence ω)
G2LPAve: An average value of anomalous dispersion of a convex lens that satisfies Conditional Expression (16)

Lateral chromatic aberration of an optical system generally including thin lenses is given by the sum of lenses as shown in the following (Reference Formula 1), and axial chromatic aberration is given by the following (Reference Formula 2).

$$\sum ( h \cdot hb \cdot φ / v ) \qquad ( Reference formula 1 )$$

$$\sum ( h \cdot h \cdot φ / v ) \qquad ( Reference formula 2 )$$

h: Axial marginal ray height
hb: Off-axis chief ray height
φ: Refractive power
v: Abbe number

From (Reference Formula 1) and (Reference Formula 2), it can be understood that the higher the position of the off-axis chief ray height of the lens that passes through, the greater the influence of the lateral chromatic aberration, and the higher the position of the axial marginal ray height of the lens that passes through, the greater the influence of the axial chromatic aberration. Thus, it is possible to highly correct the lateral chromatic aberration and the axial chromatic aberration by appropriately setting a difference between the heights of the axial marginal ray height and the off-axis chief ray height and dispersion characteristics of a glass material.

Conditional Expression (16) specifies a ratio of the axial marginal ray height to the off-axis chief ray height that are incident on the convex lens of the second lens group G2. Both the axial marginal ray height and the off-axis chief ray height that are incident on the convex lens of the second lens group G2 specify ray heights at the time of incidence, and thus correspond to the ray heights on the object side of the respective convex lenses. As mentioned above, when a glass material with large positive anomalous dispersion is used for the convex lens of the second lens group G2 disposed on the image side of the diaphragm, it is effective in correcting both the lateral chromatic aberration and the axial chromatic aberration. It is possible to further enhance the effect by disposing a convex lens using a glass material with positive anomalous dispersion in the range that satisfies Conditional Expression (16). G2LPAXh defines an axial marginal ray height that is incident on the convex lens of the second lens group G2, and positive/negative reversal of the ray height does not occur in the axial marginal ray before and after the diaphragm, and thus it is calculated as a positive value at all times in the calculation of this conditional expression. In addition, G2LPOAh defines an off-axis chief ray height when a ray with an object-side angle of incidence of 90° is incident on the convex lens when focusing on infinity, and can take both positive and negative values. In the calculation of this conditional expression, the calculation is performed for the off-axis chief ray that takes a positive value on the image side of the diaphragm.

When the ratio of the axial marginal ray height and the off-axis chief ray height incident on the convex lens of the second lens group G2 becomes large beyond the upper limit of Conditional Expression (16), the axial marginal ray height will be lower than the off-axis chief ray height, which undesirably leads to a reduction in the effect of correcting the axial chromatic aberration.

When the ratio between the axial marginal ray height and the off-axis chief ray height that are incident on the convex lens of the second lens group G2 becomes small below the lower limit of Conditional Expression (16), the off-axis chief ray height will be lower than the axial marginal ray height, which undesirably leads to a reduction in the effect of correcting the lateral chromatic aberration.

Conditional Expression (17) specifies an average value of anomalous dispersion of the convex lens included in the second lens group G2 and satisfying Conditional Expression (16). The more positive anomalous dispersion a glass material is used, the greater the effect of correcting lateral chromatic aberration and axial chromatic aberration.

When the average value of anomalous dispersion of the convex lenses included in the second lens group G2 and satisfying Conditional Expression (16) becomes small below the lower limit of Conditional Expression (17), the effect of correcting the lateral chromatic aberration and the axial chromatic aberration decreases, which is not preferable.

Regarding Conditional Expression (17), it is preferable to set the lower limit to 0.009, thereby making it possible to ensure the above-mentioned effect further.

In the large aperture ratio ultra wide angle lens of the present invention, it is preferable that the meniscus negative lens component N1 include a concave lens that satisfies the following Conditional Expression (18).

$$1.7 < ndN 1 n \qquad ( 18 )$$

ndN1n: A refractive index of the concave lens included in the meniscus negative lens component N1

Conditional Expression (18) specifies a refractive index of the concave lens included in the meniscus negative lens component N1 having a convex surface facing the object side. The concave lens makes it possible to downsize the optical system by using a high refractive index material.

When the refractive index of the concave lens included in the meniscus negative lens component N1 with its convex surface facing the object side is lowered below the lower limit of Conditional Expression (18), the curvature radius (N1R2) of the image-side surface of the meniscus negative lens component N1 becomes small in order to maintain the refractive power, which undesirably leads to astigmatism and deterioration of field curvature. In addition, the thickness deviation ratio of the meniscus negative lens component N1 acts in an increasing direction, and the weight of the meniscus negative lens component N1 increases, which is not preferable.

Regarding Conditional Expression (18), it is preferable to set the lower limit to 1.8, thereby making it possible to ensure the above-mentioned effect further.

It is preferable that the large aperture ratio ultra wide angle lens of the present invention desirably satisfy the following Conditional Expression (19).

$$5. < LT / BF < 12. \qquad ( 19 )$$

LT: A distance on the optical axis from the lens surface closest to the object side to the lens surface closest to the image side when focusing on infinity
BF: A distance on the optical axis from the lens surface closest to the image side to the image surface when focusing on infinity

Conditional Expression (19) specifies a ratio of the distance on the optical axis from the lens surface closest to the object side to the lens surface closest to the image side when focusing on infinity to the distance on the optical axis from the lens surface closest to the image side to the image surface when focusing on infinity. Parallel plates adjacent to the image surface or adjacent to each other with an air distance are not counted as lenses. When the distance on the optical axis from the lens surface closest to the image side to the image surface is calculated, the calculation is performed with an air equivalent length by replacing the parallel plates with air. It is possible to achieve the downsizing of the optical system by satisfying Conditional Expression (19).

When the ratio of the distance on the optical axis from the lens surface closest to the object side to the lens surface closest to the image side when focusing on infinity to the distance on the optical axis from the lens surface closest to the image side to the image surface when focusing on infinity becomes large beyond the upper limit of Conditional Expression (19), the optical system is enlarged, which is not preferable.

When the ratio of the distance on the optical axis from the lens surface closest to the object side to the lens surface closest to the image side when focusing on infinity to the distance on the optical axis from the lens surface closest to the image side to the image surface when focusing on infinity becomes small below the lower limit of Conditional Expression (19), it becomes necessary to reduce LT, thereby making it difficult to correct spherical aberration, astigmatism, and field curvature while maintaining a large aperture ratio of less than F1.9, which is not preferable.

Regarding Conditional Expression (19), it is preferable to set the upper limit to 11.00 and set the lower limit to 5.35, and more preferable to set the upper limit to 10.00 and set the lower limit to 6.20, thereby making it possible to ensure the above-mentioned effect further.

It is preferable that the large aperture ratio ultra wide angle lens of the present invention satisfy the following Conditional Expression (20).

$$2.5 < \vert LT / iOAh \vert < 18. \qquad ( 20 )$$

LT: A distance on the optical axis from the lens surface closest to the object side to the lens surface closest to the image side when focusing on infinity
iOAh: An imaging height of an off-axis chief ray when a ray with an object-side angle of incidence of 90° forms an image on an image surface when focusing on infinity (however, when 2ω<180°, it is an imaging height of an off-axis chief ray that is incident at an object-side angle of incidence ω)

Conditional Expression (20) specifies an absolute value of a ratio of the distance on the optical axis from the lens surface closest to the object side to the lens surface closest to the image side when focusing on infinity to an imaging height of an off-axis chief ray when a ray with an object-side angle of incidence of 90° is imaged on the image surface when focusing on infinity (however, when 2ω<180°, it is an imaging height of an off-axis chief ray that is incident at an object-side angle of incidence ω). It is possible to achieve the downsizing of the optical system by satisfying Conditional Expression (19).

When the ratio of the distance on the optical axis from the lens surface closest to the object side to the lens surface closest to the image side when focusing on infinity to the imaging height of the off-axis chief ray when a ray with an object-side angle of incidence of 90° is imaged on the image surface when focusing on infinity becomes large beyond the upper limit of Conditional Expression (20), the optical system is enlarged relative to the maximum imaging height of the optical system, which is not preferable.

When the ratio of the distance on the optical axis from the lens surface closest to the object side to the lens surface closest to the image side when focusing on infinity to the imaging height of the off-axis chief ray when a ray with an object-side angle of incidence of 90° is imaged on the image surface when focusing on infinity becomes small below the lower limit of Conditional Expression (20), it becomes necessary to reduce LT, thereby making it difficult to correct spherical aberration, astigmatism, and field curvature while maintaining a large aperture ratio of less than F1.9, which is not preferable.

Regarding Conditional Expression (20), it is preferable to set the upper limit to 16.0 and set the lower limit to 3.1, and more preferable to set the upper limit to 14.0 and set the lower limit to 4.1, thereby making it possible to ensure the above-mentioned effect further.

In the large aperture ratio ultra wide angle lens of the present invention, it is preferable that the meniscus negative lens component N2 be a meniscus negative lens component having its convex surface facing the object side and being disposed second from the object side among meniscus negative lens components with their convex surfaces facing the object side. The meniscus negative lens component N2 plays a role in introducing an off-axis ray incident from the object side at an angle close to the optical axis, and thus the meniscus negative lens component N2 is disposed on a side closest to the object side, making it possible to introduce the off-axis ray while preventing enlargement of the optical system.

In the large aperture ratio ultra wide angle lens of the present invention, it is preferable that the meniscus negative lens component N1 and the meniscus negative lens component N2 be disposed consecutively from a side closest to the object side. Both the meniscus negative lens component N1 and the meniscus negative lens component N2 play a role of gently guiding off-axial rays incident from the object side at an angle close to the optical axis, and thus they are disposed consecutively from a side closest to the object side, thereby making it possible to curb enlargement of the optical system.

In the large aperture ratio ultra wide angle lens of the present invention, it is preferable that the meniscus negative lens component N1 and the meniscus negative lens component N2 include spherical surface lenses. By using spherical surface lenses for the meniscus negative lens component N1 and the meniscus negative lens component N2, the optical elements can be easily processed, the degree of freedom in selecting glass materials increases, and lateral chromatic aberration can be easily corrected.

The large aperture ratio ultra wide angle lens of the present invention has a function of focusing from infinity to a close distance object, and in this case, it is preferable to perform focusing by moving a part or the entirety of the optical system in the optical axis direction.

Next, lens configurations and numerical examples of examples of the large aperture ratio ultra wide angle lens of the present invention will be described. In the following description, the lens configurations will be described in the order from an object side to an image side.

All of Examples 1 to 14 of the present invention show fisheye lenses that use an equisolid angle projection method. When each aberration diagram is output, an object surface is evaluated as a plane (curvature radius is ∞). Thus, particularly when performing evaluation at a finite distance where an object distance is small, significant field curvature appears in the aberration diagram because the object surface is a plane.

In [Surface Data], a surface number is the number of a lens surface or an aperture diaphragm S counted from the object side, r is the curvature radius of each lens surface, d is a distance between the lens surfaces, nd is a refractive index for a d-line (wavelength 587.56 nm), vd is an Abbe number for the d-line, and ΔPgF is a value calculated using the formula of PgF−0.64833±0.00180×vd. Additionally, the names of glass materials manufactured by HOYA Corporation, OHARA Corporation, and Hikari Glass Co., Ltd. are listed as examples of glass that meet the refractive index, Abbe number, and ΔPgF listed in the [Surface Data].

* (asterisk) attached to the surface number indicates that a lens surface has an aspherical surface shape. Additionally, BF stands for back focus, and a distance of an object surface indicates a distance from a subject to a first surface of a lens.

(Diaphragm) attached to the surface number indicates that the aperture diaphragm S is located at that position. ∞ (infinity) is written in the curvature radius for the plane or the aperture diaphragm S.

[Aspherical Surface Data] shows the value of each coefficient that gives the aspherical surface shape of the lens surface marked with * in the [Surface Data]. The shape of the aspherical surface is expressed by the following formula. In the following formula, a displacement from the optical axis in a direction perpendicular to the optical axis is represented by y, a displacement (sag) from an intersection between the optical axis and the aspherical surface in the optical axis direction is represented by z, a curvature radius of a reference spherical surface is represented by r, and a Conic coefficient is represented by K. In addition, 4th, 6th, 8th, 10th, 12th, 14th, and 16th aspherical surface coefficients are represented by A4, A6, A8, A10, A12, A14, and A16, respectively.

$$Z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8} + A 10 {y}^{10} + A 12 {y}^{12} + A 14 {y}^{14} + A 16 {y}^{16}$$

[Various Data] shows a value such as a focal length in each imaging distance focusing state.

[Variable Distance Data] shows a variable distance and the value of BF in each imaging distance focusing state.

[Lens Group Data] shows a surface number on a side closest to the object side that configures each lens group and a composite focal length of the entire group.

[Convex Lens in Second Lens Group G2 Satisfying Conditional Expression (16)] shows an object-side surface number of the convex lens in the second lens group G2 that satisfies Conditional Expression (16), the corresponding glass material, an axial marginal ray height (G2LPAXh) that is incident on the convex lens when focusing on infinity in a diaphragm open state, an off-axis chief ray height when a ray with an object-side angle of incidence of 90° is incident on the convex lens when focusing on infinity (however, when 2ω<180°, it is an off-axis chief ray height that is incident at an object-side angle of incidence ω: G2LPOAh), a ratio of G2LPAXh to G2LPOAh, and the value of ΔPgF.

In the aberration diagram corresponding to each example, d, g, and C represent a d-line, a g-line, and a C-line, respectively, and ΔS and ΔM represent a sagittal image surface and a meridional image surface, respectively.

In the values of all of the following specifications, the focal length f, the curvature radius r, the lens surface distance d, and other length units are in millimeters (mm) unless otherwise specified, but this is not limiting because the optical system provides similar optical performance in proportional enlargement and proportional reduction.

In addition, the lens disposed on a side closest to the object side will be referred to as L1, the second lens disposed toward the image side will be referred to as L2, and the third lens disposed toward the image side will be referred to as L3, in that order.

In the lens configuration diagram in each example, I is an image surface, F is a filter, and an alternating dotted-dashed line that passes through the center is an optical axis.

### Example 1

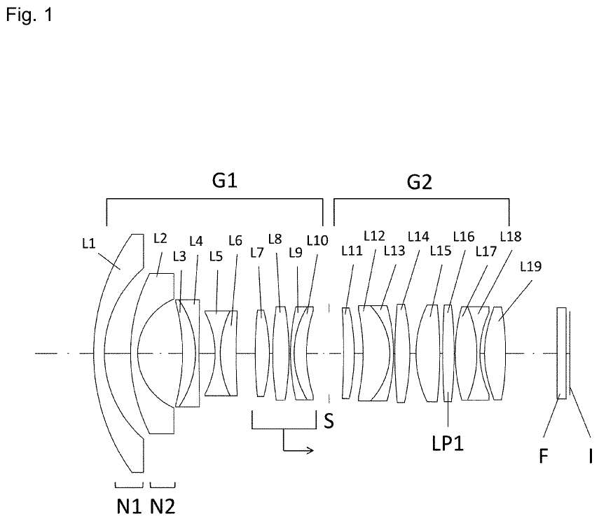

FIG. 1 is a diagram showing a lens configuration of a large aperture ratio ultra wide angle lens according to Example 1 when focusing on infinity.

The large aperture ratio ultra wide angle lens in FIG. 1 includes, in order from the object side, with a first lens group G1 having a negative refractive power, an aperture diaphragm S, and a second lens group G2 having a positive refractive power.

The first lens group G1 includes, in order from the object side, a meniscus negative lens component N1 including a meniscus negative lens L1 with its convex surface facing the object side, a meniscus negative lens component N2 including a meniscus negative lens L2 with its convex surface facing the object side, a cemented lens of a meniscus positive lens L3 with its convex surface facing the image side and a biconcave lenses L4, a cemented lens of a biconcave lenses L5 and a meniscus positive lens L6 with its convex surface facing the object side, a biconvex lens L7, a biconvex aspheric lens L8, and a cemented lens of a meniscus negative lens L9 with its convex surface facing the object side and a meniscus positive lens L10 with its convex surface facing the object side.

The second lens group G2 includes, in order from the object side, a meniscus positive lens L11 with its convex surface facing the image side, a cemented lens including a meniscus positive lens L12 with its convex surface facing the image side and a meniscus negative lens L13 with its convex surface facing the image side, a biconvex lens L14, a biconvex lens L15, a biconvex lens L16, a cemented lens including a biconvex lens L17 and a biconcave lenses L18, and a biconvex aspheric lens L19.

As an example of focusing, the lenses L7 to L10 among the lenses that configure the first lens group G1 are integrally moved to the image side along the optical axis, thereby making it possible to perform focusing from an infinite distance object to a close distance object. Regardless of this, it is possible to perform focusing by moving a part or the entirety of the optical system in the optical axis direction.

Specifications of the large aperture ratio ultra wide angle lens according to Example 1 are shown below.

### Numerical Example 1

Unit: mm
[Surface Data]

| Surface | | | | | | Corresponding |
|---|---|---|---|---|---|---|
| Number | r | d | nd | vd | ΔPgF | Glass Material |
| 0 | | (d0) | | | | |
| 1 | 59.3307 | 3.0000 | 1.85033 | 42.69 | −0.0072 | TAFD34 |
| 2 | 32.6012 | 7.3330 | | | | |
| 3 | 51.6525 | 2.0000 | 2.00069 | 25.46 | 0.0110 | TAFD40-W |
| 4 | 16.9776 | 12.5575 | | | | |
| 5 | −57.0174 | 3.6235 | 1.85451 | 25.15 | 0.0071 | NBFD25 |
| 6 | −27.5516 | 1.0000 | 1.43700 | 95.10 | 0.0564 | FCD100 |
| 7 | 760.8918 | 4.4992 | | | | |
| 8 | −25.4905 | 1.4563 | 1.80100 | 34.97 | 0.0009 | S-LAM66 |
| 9 | 28.4681 | 4.4072 | 1.86966 | 20.02 | 0.0310 | FDS20-W |
| 10 | 204.3417 | (d10) | | | | |
| 11 | 118.3888 | 3.9558 | 1.49700 | 81.61 | 0.0373 | FCD1 |
| 12 | −49.6092 | 0.9510 | | | | |
| *13 | 88.3904 | 4.5768 | 1.85135 | 40.10 | −0.0067 | M-TAFD305 |
| *14 | −76.6548 | 0.4190 | | | | |
| 15 | 59.7344 | 0.9958 | 1.80611 | 40.73 | −0.0080 | NBFD13 |
| 16 | 25.9394 | 3.4660 | 2.05090 | 26.94 | 0.0052 | TAFD65 |
| 17 | 40.2507 | (d17) | | | | |
| 18(diaphragm) | ∞ | 4.0123 | | | | |
| 19 | −216.5603 | 2.9894 | 1.49700 | 81.61 | 0.0373 | FCD1 |
| 20 | −61.2064 | 2.4673 | | | | |
| 21 | −61.5955 | 7.5045 | 1.43700 | 95.10 | 0.0564 | FCD100 |
| 22 | −19.7410 | 1.0214 | 1.85451 | 25.15 | 0.0071 | NBFD25 |
| 23 | −51.7120 | 0.3919 | | | | |
| 24 | 147.9068 | 4.1953 | 1.55032 | 75.50 | 0.0274 | FCD705 |
| 25 | −65.3241 | 1.7129 | | | | |
| 26 | 32.2779 | 6.6442 | 1.43700 | 95.10 | 0.0564 | FCD100 |
| 27 | −142.0192 | 0.8259 | | | | |
| 28 | 214.5952 | 3.2005 | 1.94595 | 17.98 | 0.0385 | FDS18-W |
| 29 | −127.3539 | 0.3026 | | | | |
| 30 | 48.9128 | 6.1022 | 1.43700 | 95.10 | 0.0564 | FCD100 |
| 31 | −35.2153 | 0.8500 | 1.85451 | 25.15 | 0.0071 | NBFD25 |
| 32 | 28.3382 | 1.2521 | | | | |
| *33 | 29.8464 | 5.8960 | 1.80610 | 40.73 | −0.0058 | M-NBFD130 |
| *34 | −87.4854 | 14.4500 | | | | |
| 35 | ∞ | 2.5000 | 1.51680 | 64.20 | 0.0014 | BSC7 |
| 36 | ∞ | (BF) | | | | |

[Aspherical Surface Data]

| | 13th Surface | 14th Surface | 33rd Surface | 34th Surface |
|---|---|---|---|---|
| K | 0.00000E+00 | 0.00000E+00 | 0.00000E+00 | 0.00000E+00 |
| A4 | −4.77407E−08 | 2.55930E−06 | −9.17184E−06 | 1.08522E−07 |
| A6 | −1.39344E−09 | −1.20340E−09 | −2.11056E−08 | −2.25595E−08 |
| A8 | −1.29188E−12 | −2.76024E−11 | 5.62697E−11 | 7.12380E−11 |
| A10 | −1.16182E−13 | 3.94546E−14 | −6.92083E−13 | −6.26716E−13 |
| A12 | −9.32650E−17 | −4.40567E−16 | −4.35790E−16 | −1.58415E−15 |
| A14 | 5.68935E−19 | 4.92346E−19 | 0.00000E+00 | 4.13406E−18 |
| A16 | −1.15739E−21 | −5.23936E−22 | 0.00000E+00 | 0.00000E+00 |

[Various Data]

| | Wide Angle (INF) |
|---|---|
| Focal Length | 8.15 |
| F-number | 1.26 |
| Total Angle of View 2ω | 185.73 |
| Image Height Y | 11.94 |
| Overall Lens Length | 133.27 |

[Variable Distance Data]

| | INF | Close Distance |
|---|---|---|
| (d0) | ∞ | 222.3414 |
| (d10) | 5.3549 | 5.6265 |
| (d17) | 6.3575 | 6.0858 |
| (BF) | 1.0000 | 1.0000 |

[Lens Group Data]

| Group | Starting Surface | Focal Length |
|---|---|---|
| G1 | 1 | −111.1800 |
| G2 | 19 | 28.2728 |

[Convex Lens in Second Lens Group G2 Satisfying Conditional Expression (16)]

| Surface | Corresponding | | | G2LPAXh/ | |
|---|---|---|---|---|---|
| Number | Glass Material | G2LPAXh | G2LPOAh | G2LPOAh | ΔPgF |
| 24 | FCD705 | 12.832 | 6.437 | 2.0 | 0.0274 |
| 26 | FCD100 | 12.719 | 8.574 | 1.5 | 0.0564 |
| 28 | FDS18-W | 11.729 | 9.549 | 1.2 | 0.0385 |
| 30 | FCD100 | 10.492 | 9.824 | 1.1 | 0.0564 |
| 33 | M-NBFD130 | 8.302 | 10.554 | 0.8 | −0.0058 |

### Example 2

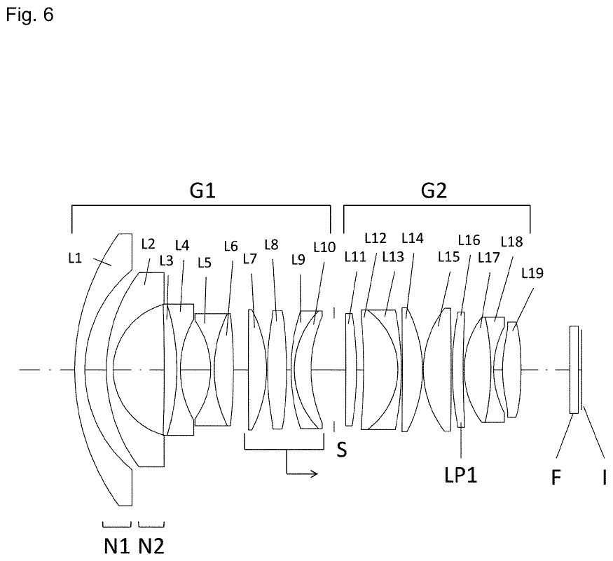

FIG. 6 is a diagram showing a lens configuration of a large aperture ratio ultra wide angle lens according to Example 2 when focusing on infinity.

The large aperture ratio ultra wide angle lens in FIG. 6 includes, in order from the object side, with a first lens group G1 having a negative refractive power, an aperture diaphragm S, and a second lens group G2 having a positive refractive power.

The first lens group G1 includes, in order from the object side, a meniscus negative lens component N1 including a meniscus negative lens L1 with its convex surface facing the object side, a meniscus negative lens component N2 including a meniscus negative lens L2 with its convex surface facing the object side, a cemented lens of a meniscus positive lens L3 with its convex surface facing the image side and a biconcave lenses L4, a cemented lens of a biconcave lens L5 and a biconvex lens L6, a biconvex lens L7, a biconvex aspheric lens L8, and a cemented lens of a meniscus negative lens L9 with its convex surface facing the object side and a meniscus positive lens L10 with its convex surface facing the object side.

The second lens group G2 includes, in order from the object side, a meniscus positive lens L11 with its convex surface facing the image side, a cemented lens of a meniscus positive lens L12 with its convex surface facing the image side and a meniscus negative lens L13 with its convex surface facing the image side, a meniscus positive lens L14 with its convex surface facing the image side, a biconvex lens L15, a meniscus positive lens L16 with its convex surface facing the object side, a cemented lens of a biconvex lens L17 and a biconcave lens L18, and a biconvex aspheric lens L19.

As an example of focusing, the lenses L7 to L10 among the lenses that configure the first lens group G1 are integrally moved to the image side along the optical axis, thereby making it possible to perform focusing from an infinite distance object to a close distance object. Regardless of this, it is possible to perform focusing by moving a part or the entirety of the optical system in the optical axis direction.

Specifications of the large aperture ratio ultra wide angle lens according to Example 2 are shown below.

### Numerical Example 2

Unit: mm
[Surface Data]

| Surface | | | | | | Corresponding |
|---|---|---|---|---|---|---|
| Number | r | d | nd | vd | ΔPgF | Glass Material |
| 0 | | (d0) | | | | |
| 1 | 70.9430 | 3.0000 | 1.95375 | 32.32 | −0.0002 | TAFD45 |
| 2 | 39.6332 | 6.3946 | | | | |
| 3 | 49.5611 | 2.0000 | 2.00069 | 25.46 | 0.0110 | TAFD40-W |
| 4 | 20.4420 | 15.0704 | | | | |
| 5 | −615.5293 | 3.7743 | 1.91082 | 35.25 | −0.0028 | TAFD35 |
| 6 | −68.3304 | 1.0000 | 1.43700 | 95.10 | 0.0564 | FCD100 |
| 7 | 31.0972 | 9.0087 | | | | |
| 8 | −25.8197 | 1.0000 | 1.91082 | 35.25 | −0.0028 | TAFD35 |
| 9 | 38.3086 | 5.7129 | 1.86966 | 20.02 | 0.0310 | FDS20-W |
| 10 | −155.2260 | (d10) | | | | |
| 11 | 3423.5606 | 5.3753 | 1.49700 | 81.61 | 0.0373 | FCD1 |
| 12 | −40.1836 | 0.3004 | | | | |
| *13 | 88.0834 | 5.6688 | 1.85135 | 40.10 | −0.0067 | M-TAFD305 |
| *14 | −124.6795 | 1.2998 | | | | |
| 15 | 57.3790 | 0.9997 | 1.77250 | 49.62 | −0.0088 | TAF1 |
| 16 | 25.5128 | 4.9391 | 2.05090 | 26.94 | 0.0052 | TAFD65 |
| 17 | 40.6599 | (d17) | | | | |
| 18 (diaphragm) | ∞ | 3.5448 | | | | |
| 19 | −2749.0125 | 3.1260 | 1.43700 | 95.10 | 0.0564 | FCD100 |
| 20 | −107.9561 | 2.1000 | | | | |
| 21 | −181.7676 | 10.1370 | 1.43700 | 95.10 | 0.0564 | FCD100 |
| 22 | −22.4977 | 1.0000 | 1.85451 | 25.15 | 0.0071 | NBFD25 |
| 23 | −90.9572 | 0.3000 | | | | |
| 24 | −1318.8089 | 5.9392 | 1.49700 | 81.61 | 0.0373 | FCD1 |
| 25 | −40.5459 | 0.3000 | | | | |
| 26 | 30.6100 | 8.2176 | 1.43700 | 95.10 | 0.0564 | FCD100 |
| 27 | −1160.6200 | 0.3213 | | | | |
| 28 | 89.2221 | 3.2047 | 1.94595 | 17.98 | 0.0385 | FDS18-W |
| 29 | 335.8016 | 0.3000 | | | | |
| 30 | 26.7314 | 7.8895 | 1.43700 | 95.10 | 0.0564 | FCD100 |
| 31 | −77.2159 | 0.8500 | 1.85451 | 25.15 | 0.0071 | NBFD25 |
| 32 | 28.0958 | 2.6306 | | | | |
| *33 | 40.2346 | 5.4564 | 1.80610 | 40.73 | −0.0058 | M-NBFD130 |
| *34 | −107.6407 | 14.4500 | | | | |
| 35 | ∞ | 2.5000 | 1.51680 | 64.20 | 0.0014 | BSC7 |
| 36 | ∞ | (BF) | | | | |

[Aspherical Surface Data]

| | 13th Surface | 14th Surface | 33rd Surface | 34th Surface |
|---|---|---|---|---|
| K | 0.00000E+00 | 0.00000E+00 | 0.00000E+00 | 0.00000E+00 |
| A4 | 6.67394E−07 | 1.73143E−06 | −1.26529E−05 | −2.58659E−06 |
| A6 | −1.61981E−09 | −2.26287E−10 | −4.95945E−08 | −4.98148E−08 |
| A8 | 1.28312E−12 | −2.33718E−11 | 9.44730E−11 | 9.96431E−11 |
| A10 | −7.63542E−14 | 5.79288E−14 | −8.71214E−13 | −5.70081E−13 |
| A12 | 4.57302E−17 | −2.56856E−16 | −4.35790E−16 | −1.58415E−15 |
| A14 | 5.68935E−19 | 4.92346E−19 | 0.00000E+00 | 4.13406E−18 |
| A16 | −2.04827E−21 | −1.12558E−21 | 0.00000E+00 | 0.00000E+00 |

[Various Data]

| | Wide Angle (INF) |
|---|---|
| Focal Length | 8.15 |
| F-number | 1.03 |
| Total Angle of View 2ω | 185.73 |
| Image Height Y | 11.93 |
| Overall Lens Length | 149.99 |

[Variable Distance Data]

| | INF | Close Distance |
|---|---|---|
| (d0) | ∞ | 220.2021 |
| (d10) | 4.3946 | 4.6802 |
| (d17) | 6.7828 | 6.4972 |
| (BF) | 1.0000 | 1.0000 |

[Lens Group Data]

| Group | Starting Surface | Focal Length |
|---|---|---|
| G1 | 1 | −76.3147 |
| G2 | 19 | 29.7796 |

[Convex Lens in Second Lens Group G2 Satisfying Conditional Expression (16)]

| Surface | Corresponding | | | G2LPAXh/ | |
|---|---|---|---|---|---|
| Number | Glass Material | G2LPAXh | G2LPOAh | G2LPOAh | ΔPgF |
| 24 | FCD1 | 17.148 | 6.373 | 2.7 | 0.0373 |
| 26 | FCD100 | 17.312 | 8.740 | 2.0 | 0.0564 |
| 28 | FDS18-W | 16.139 | 9.814 | 1.6 | 0.0385 |
| 30 | FCD100 | 13.829 | 10.153 | 1.4 | 0.0564 |
| 33 | M-NBFD130 | 10.555 | 10.514 | 1.0 | −0.0058 |

### Example 3

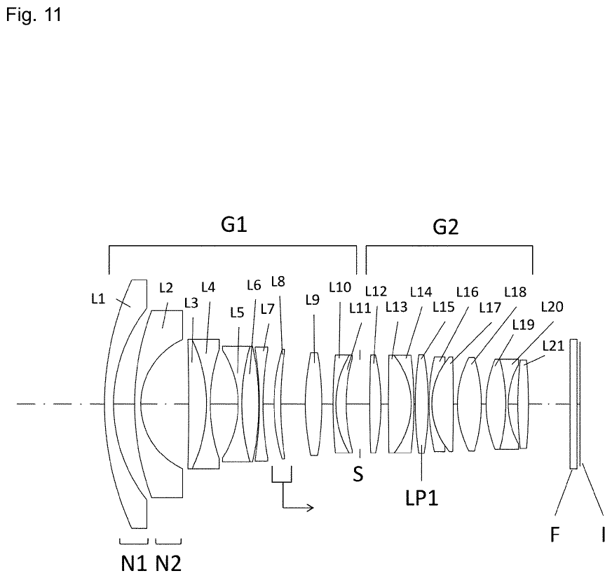

FIG. 11 is a diagram showing a lens configuration of a large aperture ratio ultra wide angle lens according to Example 3 when focusing on infinity.

The large aperture ratio ultra wide angle lens in FIG. 11 includes, in order from the object side, with a first lens group G1 having a negative refractive power, an aperture diaphragm S, and a second lens group G2 having a positive refractive power.

The first lens group G1 includes, in order from the object side, a meniscus negative lens component N1 including a meniscus negative lens L1 with its convex surface facing the object side, a meniscus negative lens component N2 including a meniscus negative lens L2 with its convex surface facing the object side, a cemented lens of a meniscus positive lens L3 with its convex surface facing the image side and a biconcave lenses L4, a cemented lens of a biconcave lens L5 and a biconvex lens L6, a biconcave lens L7, a meniscus positive lens L8 with its convex surface facing the object side, a biconvex aspheric lens L9, and a cemented lens of a meniscus negative lens L10 with its convex surface facing the object side and a meniscus positive lens L11 with its convex surface facing the object side.

The second lens group G2 includes, in order from the object side, a biconvex lens L12, and a cemented lens of a biconvex lens L13 and a meniscus negative lens L14 with its convex surface facing the image side, a biconvex lens L15, a cemented lens of a meniscus negative lens L16 with its convex surface facing the object side and a biconvex lens L17, a biconvex lens L18, a cemented lens of a biconvex lens L19 and a biconcave lens L20, and a biconvex aspheric lens L21.

As an example of focusing, L8 among the lenses that configure the first lens group G1 is moved to the image side along the optical axis, thereby making it possible to perform focusing from an infinite distance object to a close distance object. Regardless of this, it is possible to perform focusing by moving a part or the entirety of the optical system in the optical axis direction.

Specifications of the large aperture ratio ultra wide angle lens according to Example 3 are shown below.

### Numerical Example 3

Unit: mm
[Surface Data]

| Surface | | | | | | Corresponding |
|---|---|---|---|---|---|---|
| Number | r | d | nd | vd | ΔPgF | Glass Material |
| 0 | | (d0) | | | | |
| 1 | 109.2625 | 3.2000 | 1.88300 | 40.80 | −0.0094 | TAFD30 |
| 2 | 56.8200 | 7.4594 | | | | |
| 3 | 97.5361 | 2.2000 | 2.00100 | 29.13 | 0.0035 | TAFD55-W |
| 4 | 25.8504 | 16.9680 | | | | |
| 5 | −919.4422 | 6.3047 | 1.88300 | 40.80 | −0.0094 | TAFD30 |
| 6 | −56.4257 | 1.3369 | 1.43700 | 95.10 | 0.0564 | FCD100 |
| 7 | 63.8170 | 9.8914 | | | | |
| 8 | −37.0971 | 1.2936 | 1.48749 | 70.44 | 0.0090 | FC5 |
| 9 | 76.4236 | 6.0467 | 2.00100 | 29.13 | 0.0035 | TAFD55-W |
| 10 | −97.1124 | 0.1875 | | | | |
| 11 | −129.7405 | 1.2480 | 1.60311 | 60.64 | 0.0022 | S-BSM14 |
| 12 | 111.4369 | (d12) | | | | |
| 13 | 70.5891 | 2.3511 | 1.68893 | 31.07 | 0.0079 | S-TIM28 |
| 14 | 133.3264 | (d14) | | | | |
| *15 | 79.7484 | 5.8668 | 1.77377 | 47.17 | −0.0078 | MC-TAF401 |
| *16 | −115.3962 | 3.9562 | | | | |
| 17 | 192.5212 | 0.9990 | 1.86966 | 20.02 | 0.0310 | FDS20-W |
| 18 | 35.2125 | 3.6459 | 2.00100 | 29.13 | 0.0035 | TAFD55-W |
| 19 | 64.9829 | 4.8785 | | | | |
| 20 (diaphragm) | ∞ | 3.5080 | | | | |
| 21 | 539.5023 | 3.9395 | 1.59282 | 68.62 | 0.0192 | FCD515 |
| 22 | −83.4488 | 2.6689 | | | | |
| 23 | 1065.0975 | 8.0417 | 1.48071 | 85.29 | 0.0413 | FCD915 |
| 24 | −28.6941 | 0.9990 | 1.85451 | 25.15 | 0.0071 | NBFD25 |
| 25 | −150.6573 | 0.4573 | | | | |
| 26 | 129.2499 | 4.6033 | 1.98613 | 16.48 | 0.0468 | FDS16-W |
| 27 | −106.5875 | 0.3000 | | | | |
| 28 | 78.2500 | 0.9950 | 1.76634 | 35.82 | −0.0047 | S-NBH59 |
| 29 | 26.5216 | 7.5754 | 1.43700 | 95.10 | 0.0564 | FCD100 |
| 30 | −641.5498 | 1.5000 | | | | |
| 31 | 37.1997 | 8.4302 | 1.43700 | 95.10 | 0.0564 | FCD100 |
| 32 | −59.4924 | 1.7256 | | | | |
| 33 | 43.4097 | 6.9530 | 1.49700 | 81.61 | 0.0373 | FCD1 |
| 34 | 62.0139 | 0.8477 | 1.91082 | 35.25 | −0.0028 | TAFD35 |
| 35 | 29.7524 | 3.3928 | | | | |
| *36 | 133.7065 | 3.7491 | 1.80610 | 40.73 | −0.0058 | MC-NBFD130 |
| *37 | −199.3448 | 14.8136 | | | | |
| 38 | ∞ | 2.5000 | 1.51680 | 64.20 | 0.0014 | BSC7 |
| 39 | ∞ | (BF) | | | | |

[Aspherical Surface Data]

| | 15th Surface | 16th Surface | 36th Surface | 37th Surface |
|---|---|---|---|---|
| K | 0.00000E+00 | 0.00000E+00 | 0.00000E+00 | 0.00000E+00 |
| A4 | −2.23652E−06 | 4.05148E−07 | −1.04802E−06 | 1.87054E−06 |
| A6 | −2.25040E−09 | −3.08367E−09 | −1.09807E−08 | −7.69431E−09 |
| A8 | 3.84549E−12 | 1.68754E−12 | −3.35729E−12 | −8.98365E−11 |
| A10 | 3.11662E−15 | 2.86917E−14 | 1.59525E−13 | 6.98929E−13 |
| A12 | −6.72119E−17 | −1.86935E−16 | −2.69304E−16 | −2.03111E−15 |
| A14 | 1.49463E−19 | 4.08499E−19 | 0.00000E+00 | 2.18373E−18 |
| A16 | −8.65376E−23 | −2.97153E−22 | 0.00000E+00 | 0.00000E+00 |

[Various Data]

| | Wide Angle (INF) |
|---|---|
| Focal Length | 15.50 |
| F-number | 1.46 |
| Total Angle of View 2ω | 185.73 |
| Image Height Y | 22.39 |
| Overall Lens Length | 168.50 |

[Variable Distance Data]

| | INF | Close Distance |
|---|---|---|
| (d0) | ∞ | 435.2537 |
| (d12) | 3.9500 | 5.9915 |
| (d14) | 8.7163 | 6.6748 |
| (BF) | 1.0000 | 1.0000 |

[Lens Group Data]

| Group | Starting Surface | Focal Length |
|---|---|---|
| G1 | 1 | −111.4197 |
| G2 | 21 | 41.1473 |

[Convex Lens in Second Lens Group G2 Satisfying Conditional Expression (16)]

| Surface | Corresponding | | | G2LPAXh/ | |
|---|---|---|---|---|---|
| Number | Glass Material | G2LPAXh | G2LPOAh | G2LPOAh | ΔPgF |
| 26 | FDS16-W | 16.60 | 7.01 | 2.4 | 0.0468 |
| 29 | FCD100 | 14.96 | 8.47 | 1.8 | 0.0564 |
| 31 | FCD100 | 13.85 | 11.29 | 1.2 | 0.0564 |
| 33 | FCD1 | 10.54 | 12.56 | 0.8 | 0.0373 |
| 36 | MC-NBFD130 | 7.01 | 13.32 | 0.5 | −0.0058 |

### Example 4

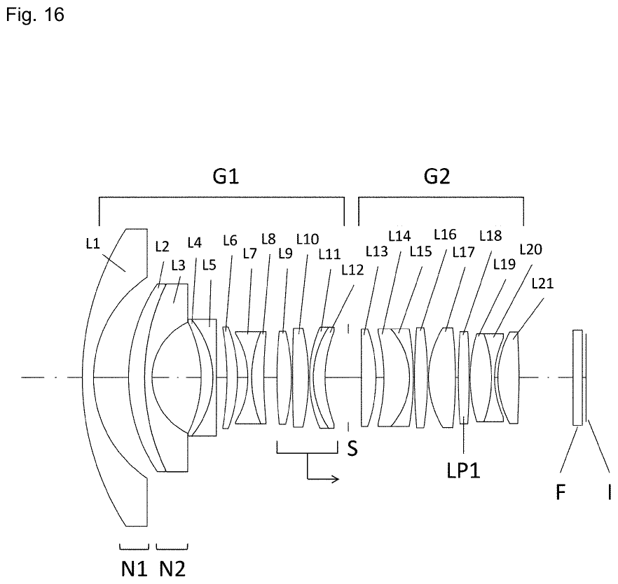

FIG. 16 is a diagram showing a lens configuration of a large aperture ratio ultra wide angle lens according to Example 4 when focusing on infinity.

The large aperture ratio ultra wide angle lens in FIG. 16 includes, in order from the object side, with a first lens group G1 having a negative refractive power, an aperture diaphragm S, and a second lens group G2 having a positive refractive power.

The first lens group G1 includes, in order from the object side, a meniscus negative lens component N1 including a meniscus negative lens L1 with its convex surface facing the object side, a meniscus negative lens component N2 including a cemented lens of a meniscus negative lens L2 with its convex surface facing the object side and a meniscus negative lens L3 with its convex surface facing the object side, a cemented lens of a meniscus positive lens L4 with its convex surface facing the image side and a meniscus negative lens L5 with its convex surface facing the image side, a meniscus positive lens L6 with its convex surface facing the image side, a cemented lens of a biconcave lens L7 and a meniscus positive lens L8 with its convex surface facing the object side, a biconvex lens L9, a biconvex aspheric lens L10, and a cemented lens of a meniscus negative lens L11 with its convex surface facing the object side and a meniscus positive lens L12 with its convex surface facing the object side.

The second lens group G2 includes, in order from the object side, a meniscus positive lens L13 with its convex surface facing the image side, a cemented lens of a meniscus positive lens L14 with its convex surface facing the image side and a meniscus negative lens L15 with its convex surface facing the image side, a biconvex lens L16, a biconvex lens L17, a biconvex lens L18, a cemented lens of a biconvex lens L19 and a biconcave lens L20, and a biconvex aspheric lens L21.

As an example of focusing, the lenses L9 to L12 among the lenses that configure the first lens group G1 are integrally moved to the image side along the optical axis, thereby making it possible to perform focusing from an infinite distance object to a close distance object. Regardless of this, it is possible to perform focusing by moving a part or the entirety of the optical system in the optical axis direction.

Specifications of the large aperture ratio ultra wide angle lens according to Example 4 are shown below.

### Numerical Example 4

Unit: mm
[Surface Data]

| Surface | | | | | | Corresponding |
|---|---|---|---|---|---|---|
| Number | r | d | nd | vd | ΔPgF | Glass Material |
| 0 | | (d0) | | | | |
| 1 | 76.0166 | 3.0000 | 1.88300 | 40.80 | −0.0094 | TAFD30 |
| 2 | 33.4076 | 9.4277 | | | | |
| 3 | 46.7261 | 4.2743 | 1.85451 | 25.15 | 0.0071 | NBFD25 |
| 4 | 59.2616 | 2.0000 | 1.94595 | 17.98 | 0.0385 | FDS18-W |
| 5 | 16.7084 | 13.1427 | | | | |
| 6 | −34.2629 | 3.1403 | 1.85451 | 25.15 | 0.0071 | NBFD25 |
| 7 | −24.9850 | 1.0000 | 1.43700 | 95.10 | 0.0564 | FCD100 |
| 8 | −3096.5243 | 2.8099 | | | | |
| 9 | −79.1069 | 2.8052 | 1.85451 | 25.15 | 0.0071 | NBFD25 |
| 10 | −39.5852 | 2.7846 | | | | |
| 11 | −23.7094 | 1.0000 | 1.77250 | 49.62 | −0.0088 | TAF1 |
| 12 | 33.2902 | 3.2581 | 1.86966 | 20.02 | 0.0310 | FDS20-W |
| 13 | 124.4257 | (d13) | | | | |
| 14 | 118.5925 | 3.9283 | 1.49700 | 81.61 | 0.0373 | FCD1 |
| 15 | −51.3653 | 0.3000 | | | | |
| *16 | 520.2443 | 4.2446 | 1.85135 | 40.10 | −0.0067 | M-TAFD305 |
| *17 | −58.1074 | 0.3000 | | | | |
| 18 | 35.7963 | 1.0000 | 1.65160 | 58.54 | −0.0041 | S-LAL7Q |
| 19 | 25.1332 | 3.1571 | 2.00100 | 29.13 | 0.0035 | TAFD55-W |
| 20 | 33.9522 | (d20) | | | | |
| 21 (diaphragm) | ∞ | 3.5021 | | | | |
| 22 | −35542.9790 | 3.9342 | 1.49700 | 81.61 | 0.0373 | FCD1 |
| 23 | −40.5698 | 2.1000 | | | | |
| 24 | −50.7128 | 6.8888 | 1.43700 | 95.10 | 0.0564 | FCD100 |
| 25 | −20.0308 | 1.0000 | 1.85451 | 25.15 | 0.0071 | NBFD25 |
| 26 | −80.7330 | 0.3000 | | | | |
| 27 | 165.5981 | 3.5062 | 1.59282 | 68.62 | 0.0192 | FCD515 |
| 28 | −93.8173 | 0.3000 | | | | |
| 29 | 26.1052 | 7.1747 | 1.43700 | 95.10 | 0.0564 | FCD100 |
| 30 | −127.6923 | 0.7636 | | | | |
| 31 | 170.8089 | 2.9191 | 1.94595 | 17.98 | 0.0385 | FDS18-W |
| 32 | −207.3386 | 0.3000 | | | | |
| 33 | 42.0574 | 5.6832 | 1.43700 | 95.10 | 0.0564 | FCD100 |
| 34 | −36.7982 | 0.8500 | 1.85451 | 25.15 | 0.0071 | NBFD25 |
| 35 | 25.7957 | 0.8626 | | | | |
| *36 | 24.5956 | 5.6765 | 1.80610 | 40.73 | −0.0058 | M-NBFD130 |
| *37 | 132.3414 | 14.4500 | | | | |
| 38 | ∞ | 2.5000 | 1.51680 | 64.20 | 0.0014 | BSC7 |
| 39 | ∞ | (BF) | | | | |

[Aspherical Surface Data]

| | 16th Surface | 17th Surface | 36th Surface | 37th Surface |
|---|---|---|---|---|
| K | 0.00000E+00 | 0.00000E+00 | 0.00000E+00 | 0.00000E+00 |
| A4 | 1.93585E−06 | 2.53223E−06 | −7.64682E−06 | 1.04361E−05 |
| A6 | 2.07469E−09 | 4.77753E−09 | −1.24828E−08 | −5.03599E−09 |
| A8 | 2.10019E−11 | −1.64410E−11 | 8.31091E−11 | 9.35222E−11 |
| A10 | −9.10124E−14 | 1.22810E−13 | −3.11642E−13 | −6.63784E−14 |
| A12 | −2.62256E−16 | −6.75655E−16 | −4.35758E−16 | −1.58419E−15 |
| A14 | 5.68925E−19 | 4.92352E−19 | 0.00000E+00 | 4.13406E−18 |
| A16 | −1.15124E−21 | −4.86103E−22 | 0.00000E+00 | 0.00000E+00 |

[Various Data]

| | Wide Angle (INF) |
|---|---|
| Focal Length | 8.15 |
| F-number | 1.26 |
| Total Angle of View 2ω | 185.73 |
| Image Height Y | 11.93 |
| Overall Lens Length | 135.00 |

[Variable Distance Data]

| | INF | Close Distance |
|---|---|---|
| (d0) | ∞ | 220.0000 |
| (d13) | 3.5000 | 3.7405 |
| (d20) | 6.2164 | 5.9759 |
| (BF) | 1.0000 | 1.0000 |

[Lens Group Data]

| Group | Starting Surface | Focal Length |
|---|---|---|
| G1 | 1 | −104.0373 |
| G2 | 22 | 28.5547 |

[Convex Lens in Second Lens Group G2 Satisfying Conditional Expression (16)]

| Surface | Corresponding | | | G2LPAXh/ | |
|---|---|---|---|---|---|
| Number | Glass Material | G2LPAXh | G2LPOAh | G2LPOAh | ΔPgF |
| 27 | FCD 515 | 12.46051 | 5.86111 | 2.1 | 0.0192 |
| 29 | FCD100 | 12.54806 | 7.35643 | 1.7 | 0.0564 |
| 31 | FDS18-W | 11.49705 | 8.54917 | 1.3 | 0.0385 |
| 33 | FCD100 | 10.29538 | 8.90658 | 1.2 | 0.0564 |
| 36 | M-NBFD130 | 8.27639 | 9.82554 | 0.8 | −0.0058 |

### Example 5

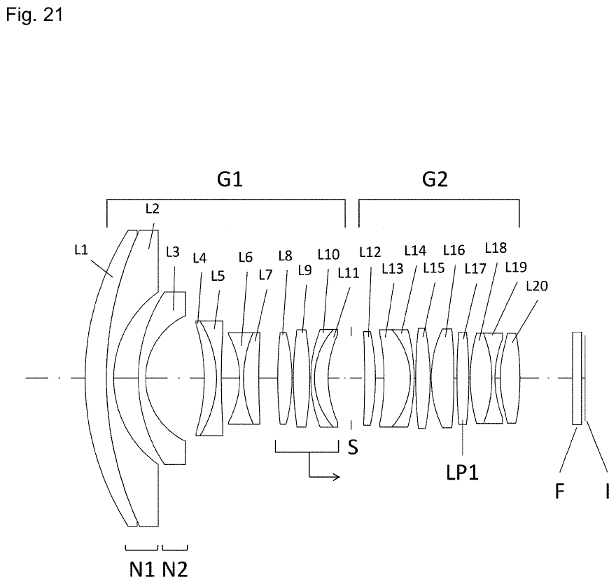

FIG. 21 is a diagram showing a lens configuration of a large aperture ratio ultra wide angle lens according to Example 5 when focusing on infinity.

The large aperture ratio ultra wide angle lens in FIG. 21 includes, in order from the object side, with a first lens group G1 having a negative refractive power, an aperture diaphragm S, and a second lens group G2 having a positive refractive power.

The first lens group G1 includes, in order from the object side, a meniscus negative lens component N1 including a meniscus positive lens L1 with its convex surface facing the object side and a meniscus negative lens L2 with its convex surface facing the object side, a meniscus negative lens component N2 including a meniscus negative lens L3 with its convex surface facing the object side, a cemented lens of a meniscus positive lens L4 with its convex surface facing the image side and a biconcave lens L5, a cemented lens of a biconcave lens L6 and a meniscus positive lens L7 with its convex surface facing the object side, a biconvex lens L8, a biconvex aspheric lens L9, and a cemented lens of a meniscus negative lens L10 with its convex surface facing the object side and a meniscus positive lens L11 with its convex surface facing the object side.

The second lens group G2 includes, in order from the object side, a meniscus positive lens L12 with its convex surface facing the image side, a cemented lens of a meniscus positive lens L13 with its convex surface facing the image side and a meniscus negative lens L14 with its convex surface facing the image side, a biconvex lens L15, a biconvex lens L16, a biconvex lens L17, a cemented lens of a biconvex lens L18 and a biconcave lens L19, and a biconvex aspheric lens L20.

As an example of focusing, the lenses L8 to L11 among the lenses that configure the first lens group G1 are integrally moved to the image side along the optical axis, thereby making it possible to perform focusing from an infinite distance object to a close distance object. Regardless of this, it is possible to perform focusing by moving a part or the entirety of the optical system in the optical axis direction.

Specifications of the large aperture ratio ultra wide angle lens according to Example 5 are shown below.

### Numerical Example 5

Unit: mm
[Surface Data]

| Surface | | | | | | Corresponding |
|---|---|---|---|---|---|---|
| Number | r | d | nd | vd | ΔPgF | Glass Material |
| 0 | | (d0) | | | | |
| 1 | 78.1841 | 5.8899 | 1.65844 | 50.88 | −0.0008 | S-BSM25 |
| 2 | 98.6169 | 1.9999 | 1.87071 | 40.73 | −0.0069 | TAFD32 |
| 3 | 29.9011 | 6.8179 | | | | |
| 4 | 44.1964 | 1.9997 | 2.00100 | 29.13 | 0.0035 | TAFD55-W |
| 5 | 19.5714 | 16.1960 | | | | |
| 6 | −52.0691 | 3.3481 | 2.00100 | 29.13 | 0.0035 | TAFD55-W |
| 7 | −30.6034 | 1.3500 | 1.43700 | 95.10 | 0.0564 | FCD100 |
| 8 | 231.8150 | 5.0695 | | | | |
| 9 | −25.9907 | 1.0478 | 1.80100 | 34.97 | 0.0009 | S-LAM66 |
| 10 | 32.1522 | 4.2042 | 1.86966 | 20.02 | 0.0310 | FDS20-W |
| 11 | 248.2593 | (d11) | | | | |
| 12 | 130.7311 | 3.9395 | 1.49700 | 81.61 | 0.0373 | FCD1 |
| 13 | −50.6408 | 0.3567 | | | | |
| *14 | 91.5376 | 4.5291 | 1.85135 | 40.10 | −0.0067 | M-TAFD305 |
| *15 | −82.3330 | 0.3000 | | | | |
| 16 | 37.5071 | 1.0001 | 1.80420 | 46.50 | −0.0075 | TAF3D |
| 17 | 20.5675 | 3.7743 | 1.95375 | 32.32 | −0.0002 | TAFD45 |
| 18 | 30.1702 | (d18) | | | | |
| 19(diaphragm) | ∞ | 3.7348 | | | | |
| 20 | −305.9715 | 2.9272 | 1.49700 | 81.61 | 0.0373 | FCD1 |
| 21 | −63.7074 | 2.4122 | | | | |
| 22 | −67.4760 | 7.2451 | 1.43700 | 95.10 | 0.0564 | FCD100 |
| 23 | −20.8552 | 1.0571 | 1.85451 | 25.15 | 0.0071 | NBFD25 |
| 24 | −54.3257 | 0.4218 | | | | |
| 25 | 136.7619 | 3.9872 | 1.55032 | 75.50 | 0.0274 | FCD705 |
| 26 | −75.3445 | 0.3000 | | | | |
| 27 | 32.5023 | 6.2497 | 1.43700 | 95.10 | 0.0564 | FCD100 |
| 28 | −167.1194 | 0.8577 | | | | |
| 29 | 160.9965 | 3.2738 | 1.89286 | 20.36 | 0.0276 | S-NPH4 |
| 30 | −126.2144 | 0.4042 | | | | |
| 31 | 48.1172 | 5.9576 | 1.43700 | 95.10 | 0.0564 | FCD100 |
| 32 | −35.9886 | 0.8500 | 1.85451 | 25.15 | 0.0071 | NBFD25 |
| 33 | 30.1966 | 1.4700 | | | | |
| *34 | 34.2985 | 5.3761 | 1.80610 | 40.73 | −0.0058 | M-NBFD130 |
| *35 | −82.2760 | 14.5474 | | | | |
| 36 | ∞ | 2.5000 | 1.51680 | 64.20 | 0.0014 | BSC7 |
| 37 | ∞ | (BF) | | | | |

[Aspherical Surface Data]

| | 14th Surface | 15th Surface | 34th Surface | 35th Surface |
|---|---|---|---|---|
| K | 0.00000E+00 | 0.00000E+00 | 0.00000E+00 | 0.00000E+00 |
| A4 | −3.07739E−07 | 2.80585E−06 | −9.39927E−06 | 2.25624E−08 |
| A6 | −1.94032E−09 | −6.51496E−10 | −2.78573E−08 | −2.93477E−08 |
| A8 | 5.68308E−13 | −2.66578E−11 | 4.65482E−11 | 3.97997E−11 |
| A10 | −9.63453E−14 | 4.66964E−14 | −8.77629E−13 | −6.81332E−13 |
| A12 | −9.28204E−17 | −3.82840E−16 | −4.35791E−16 | −1.58415E−15 |
| A14 | 5.68937E−19 | 4.92344E−19 | 0.00000E+00 | 4.13406E−18 |
| A16 | −1.15701E−21 | −5.47469E−22 | 0.00000E+00 | 0.00000E+00 |

[Various Data]

| | Wide Angle (INF) |
|---|---|
| Focal Length | 8.15 |
| F-number | 1.26 |
| Total Angle of View 2ω | 185.73 |
| Image Height Y | 11.93 |
| Overall Lens Length | 138.00 |

[Variable Distance Data]

| | INF | Close Distance |
|---|---|---|
| (d0) | ∞ | 219.0202 |
| (d11) | 5.2521 | 5.5152 |
| (d18) | 6.3532 | 6.0902 |
| (BF) | 1.0000 | 1.0000 |

[Lens Group Data]

| Group | Starting Surface | Focal Length |
|---|---|---|
| G1 | 1 | −105.6709 |
| G2 | 20 | 28.3077 |

[Convex Lens in Second Lens Group G2 Satisfying Conditional Expression (16)]

| Surface | Corresponding | | | G2LPAXh/ | |
|---|---|---|---|---|---|
| Number | Glass Material | G2LPAXh | G2LPOAh | G2LPOAh | ΔPgF |
| 25 | FCD705 | 12.85 | 6.14 | 2.1 | 0.0274 |
| 27 | FCD100 | 12.77 | 7.61 | 1.7 | 0.0564 |
| 29 | S-NPH4 | 11.81 | 8.68 | 1.4 | 0.0276 |
| 31 | FCD100 | 10.48 | 9.04 | 1.2 | 0.0564 |
| 34 | M-NBFD130 | 8.28 | 9.87 | 0.8 | −0.0058 |

### Example 6

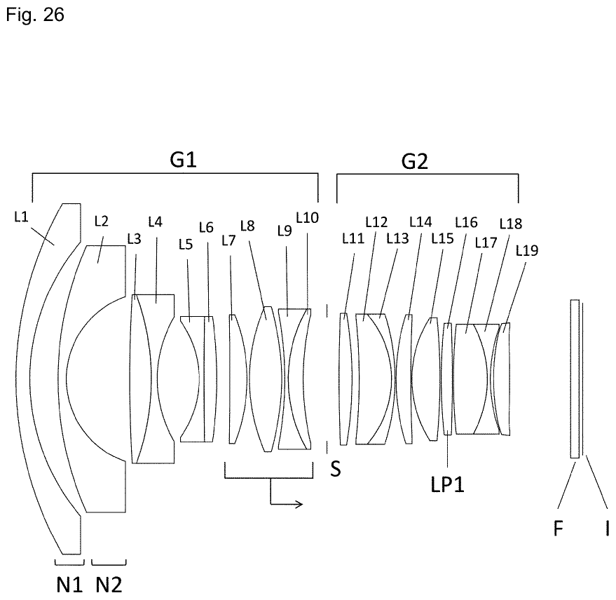

FIG. 26 is a diagram showing a lens configuration of a large aperture ratio ultra wide angle lens according to Example 6 when focusing on infinity.

The large aperture ratio ultra wide angle lens in FIG. 26 includes, in order from the object side, with a first lens group G1 having a positive refractive power, an aperture diaphragm S, and a second lens group G2 having a positive refractive power.

The first lens group G1 includes, in order from the object side, a meniscus negative lens component N1 including a meniscus negative lens L1 with its convex surface facing the object side, a meniscus negative lens component N2 including a meniscus negative lens L2 with its convex surface facing the object side, a cemented lens of a biconvex lens L3 and a biconcave lens L4, a cemented lens of a biconcave lens L5 and a biconvex lens L6, a meniscus positive lens L7 with its convex surface facing the image side, a biconvex aspheric lens L8, and a cemented lens of a biconcave lens L9 and a meniscus positive lens L10 with its convex surface facing the object side.

The second lens group G2 includes, in order from the object side, a biconvex lens L11, a cemented lens of a meniscus positive lens L12 with its convex surface facing the image side and a meniscus negative lens L13 with its convex surface facing the image side, a meniscus positive lens L14 with its convex surface facing the object side, a biconvex lens L15, a biconvex lens L16, a cemented lens of a biconvex lens L17 and a biconcave lens L18, and a biconvex aspheric lens L19.

As an example of focusing, the lenses L7 to L10 among the lenses that configure the first lens group G1 are integrally moved to the image side along the optical axis, thereby making it possible to perform focusing from an infinite distance object to a close distance object. Regardless of this, it is possible to perform focusing by moving a part or the entirety of the optical system in the optical axis direction.

Specifications of the large aperture ratio ultra wide angle lens according to Example 6 are shown below.

### Numerical Example 6

Unit: mm
[Surface Data]

| Surface | | | | | | Corresponding |
|---|---|---|---|---|---|---|
| Number | r | d | nd | vd | ΔPgF | Glass Material |
| 0 | | (d0) | | | | |
| 1 | 105.0884 | 4.0000 | 1.95375 | 32.32 | −0.0002 | TAFD45 |
| 2 | 62.3697 | 8.0986 | | | | |
| 3 | 96.5425 | 2.4000 | 1.79952 | 42.24 | −0.0049 | S-LAH52Q |
| 4 | 25.6052 | 18.2653 | | | | |
| 5 | 431.7667 | 6.1930 | 1.85451 | 25.15 | 0.0071 | NBFD25 |
| 6 | −73.7267 | 1.7495 | 1.43700 | 95.10 | 0.0564 | FCD100 |
| 7 | 36.5412 | 12.0807 | | | | |
| 8 | −29.4512 | 1.4008 | 1.71736 | 29.50 | 0.0087 | E-FD1L |
| 9 | 1220.0710 | 3.6809 | 1.94595 | 17.98 | 0.0385 | FDS18-W |
| 10 | −133.0022 | (d10) | | | | |
| 11 | −1415.9797 | 4.9937 | 1.49700 | 81.61 | 0.0373 | FCD1 |
| 12 | −52.2108 | 0.7207 | | | | |
| *13 | 53.3910 | 9.2920 | 1.85135 | 40.10 | −0.0067 | M-TAFD305 |
| *14 | −66.6961 | 0.8637 | | | | |
| 15 | −107.7114 | 0.9992 | 1.77047 | 29.74 | 0.0002 | NBFD29 |
| 16 | 42.1147 | 4.2984 | 2.05090 | 26.94 | 0.0052 | TAFD65 |
| 17 | 81.4727 | (d17) | | | | |
| 18 (diaphragm) | ∞ | 3.5000 | | | | |
| 19 | 493.3890 | 3.6904 | 1.49700 | 81.61 | 0.0373 | FCD1 |
| 20 | −120.1125 | 2.1000 | | | | |
| 21 | −176.3604 | 9.3077 | 1.43700 | 95.10 | 0.0564 | FCD100 |
| 22 | −29.2381 | 1.0000 | 1.85451 | 25.15 | 0.0071 | NBFD25 |
| 23 | −63.4867 | 0.3000 | | | | |
| 24 | 64.4652 | 4.2523 | 1.43700 | 95.10 | 0.0564 | FCD100 |
| 25 | 460.1202 | 0.3000 | | | | |
| 26 | 33.6927 | 8.0870 | 1.43700 | 95.10 | 0.0564 | FCD100 |
| 27 | −195.6035 | 0.3681 | | | | |
| 28 | 156.2083 | 3.2258 | 1.94595 | 17.98 | 0.0385 | FDS18-W |
| 29 | −459.9519 | 0.3000 | | | | |
| 30 | 161.1771 | 9.7675 | 1.43700 | 95.10 | 0.0564 | FCD100 |
| 31 | −33.8619 | 0.8500 | 1.80000 | 29.84 | 0.0070 | S-NBH55 |
| 32 | 44.8498 | 0.9528 | | | | |
| *33 | 59.9308 | 4.6568 | 1.80610 | 40.73 | −0.0058 | M-NBFD130 |
| *34 | −244.2526 | 17.5000 | | | | |
| 35 | ∞ | 2.5000 | 1.51680 | 64.20 | 0.0014 | BSC7 |
| 36 | ∞ | (BF) | | | | |

[Aspherical Surface Data]

| | 13th Surface | 14th Surface | 33rd Surface | 34th Surface |
|---|---|---|---|---|
| K | 0.00000E+00 | 0.00000E+00 | 0.00000E+00 | 0.00000E+00 |
| A4 | −3.17059E−07 | 2.16094E−06 | −4.39558E−06 | 4.57987E−06 |
| A6 | 5.33641E−10 | 8.18081E−10 | 7.32350E−10 | 1.36979E−09 |
| A8 | 6.57168E−12 | 7.55549E−13 | 2.08542E−11 | −4.99721E−12 |
| A10 | −1.62374E−14 | −3.38820E−15 | 1.90632E−13 | 5.87530E−13 |
| A12 | −1.19807E−16 | −1.12747E−16 | 2.65861E−16 | −1.78009E−15 |
| A14 | 5.75716E−19 | 5.09977E−19 | 0.00000E+00 | 4.13406E−18 |
| A16 | −6.81690E−22 | −6.19402E−22 | 0.00000E+00 | 0.00000E+00 |

[Various Data]

| | Wide Angle (INF) |
|---|---|
| Focal Length | 15.29 |
| F-number | 1.26 |
| Total Angle of View 2ω | 185.73 |
| Image Height Y | 22.11 |
| Overall Lens Length | 163.26 |

[Variable Distance Data]

| | INF | Close Distance |
|---|---|---|
| (d0) | ∞ | 424.4124 |
| (d10) | 3.6964 | 4.1236 |
| (d17) | 6.8718 | 6.4446 |
| (BF) | 1.0000 | 1.0000 |

[Lens Group Data]

| Group | Starting Surface | Focal Length |
|---|---|---|
| G1 | 1 | 1309.1203 |
| G2 | 19 | 42.6388 |

[Convex Lens in Second Lens Group G2 Satisfying Conditional Expression (16)]

| Surface | Corresponding | | | G2LPAXh/ | |
|---|---|---|---|---|---|
| Number | Glass Material | G2LPAXh | G2LPOAh | G2LPOAh | ΔPgF |
| 24 | FCD100 | 17.593 | 8.290 | 2.1 | 0.0564 |
| 26 | FCD100 | 16.740 | 10.217 | 1.6 | 0.0564 |
| 28 | FDS18-W | 15.170 | 11.582 | 1.3 | 0.0385 |
| 30 | FCD100 | 13.858 | 11.911 | 1.2 | 0.0564 |
| 33 | M-NBFD130 | 9.543 | 13.335 | 0.7 | −0.0058 |

### Example 7

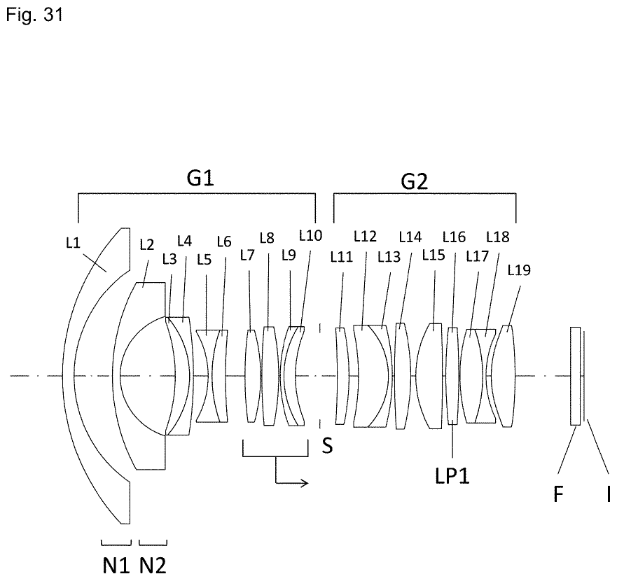

FIG. 31 is a diagram showing a lens configuration of a large aperture ratio ultra wide angle lens according to Example 7 when focusing on infinity.

The large aperture ratio ultra wide angle lens in FIG. 31 includes, in order from the object side, with a first lens group G1 having a negative refractive power, an aperture diaphragm S, and a second lens group G2 having a positive refractive power.

The first lens group G1 includes, in order from the object side, a meniscus negative lens component N1 including a meniscus negative lens L1 with its convex surface facing the object side, a meniscus negative lens component N2 including a meniscus negative lens L2 with its convex surface facing the object side, a cemented lens of a meniscus positive lens L3 with its convex surface facing the image side and a meniscus negative lens L4 with its convex surface facing the image side, a cemented lens of a biconcave lens L5 and a meniscus positive lens L6 with its convex surface facing the object side, a biconvex lens L7, a biconvex aspheric lens L8, and a cemented lens of a meniscus negative lens L9 with its convex surface facing the object side and a meniscus positive lens L10 with its convex surface facing the object side.

The second lens group G2 includes, in order from the object side, a meniscus positive lens L11 with its convex surface facing the image side, a cemented lens of a meniscus positive lens L12 with its convex surface facing the image side and a meniscus negative lens L13 with its convex surface facing the image side, a biconvex lens L14, a biconvex lens L15, a biconvex lens L16, a cemented lens of a biconvex lens L17 and a biconcave lens L18, and a biconvex aspheric lens L19.

As an example of focusing, the lenses L7 to L10 among the lenses that configure the first lens group G1 are integrally moved to the image side along the optical axis, thereby making it possible to perform focusing from an infinite distance object to a close distance object. Regardless of this, it is possible to perform focusing by moving a part or the entirety of the optical system in the optical axis direction.

Specifications of the large aperture ratio ultra wide angle lens according to Example 7 are shown below.

### Numerical Example 7

Unit: mm
[Surface Data]

| Surface | | | | | | Corresponding |
|---|---|---|---|---|---|---|
| Number | r | d | nd | vd | ΔPgF | Glass Material |
| 0 | | (d0) | | | | |
| 1 | 57.5656 | 3.0000 | 1.95375 | 32.32 | −0.0002 | TAFD45 |
| 2 | 34.4906 | 10.0000 | | | | |
| 3 | 52.6007 | 2.0000 | 2.00100 | 29.13 | 0.0035 | TAFD55-W |
| 4 | 16.4925 | 14.3440 | | | | |
| 5 | −43.0810 | 3.7168 | 1.85451 | 25.15 | 0.0071 | NBFD25 |
| 6 | −24.1033 | 1.0000 | 1.43700 | 95.10 | 0.0564 | FCD100 |
| 7 | −103.3559 | 3.8100 | | | | |
| 8 | −23.9752 | 1.0084 | 1.80420 | 46.50 | −0.0075 | TAF3D |
| 9 | 37.1560 | 3.5509 | 1.86966 | 20.02 | 0.0310 | FDS20-W |
| 10 | 130.1216 | (d10) | | | | |
| 11 | 97.1994 | 4.0662 | 1.49700 | 81.61 | 0.0373 | FCD1 |
| 12 | −46.6097 | 0.3065 | | | | |
| *13 | 144.9762 | 4.3599 | 1.85135 | 40.10 | −0.0067 | M-TAFD305 |
| *14 | −65.1909 | 0.4067 | | | | |
| 15 | 38.5469 | 0.9996 | 1.80611 | 40.73 | −0.0080 | NBFD13 |
| 16 | 25.0162 | 2.9914 | 2.05090 | 26.94 | 0.0052 | TAFD65 |
| 17 | 32.1087 | (d17) | | | | |
| 18(diaphragm) | ∞ | 4.5190 | | | | |
| 19 | −205.3714 | 3.1058 | 1.49700 | 81.61 | 0.0373 | FCD1 |
| 20 | −59.4551 | 2.4492 | | | | |
| 21 | −61.0121 | 7.7636 | 1.43700 | 95.10 | 0.0564 | FCD100 |
| 22 | −19.6631 | 1.0003 | 1.85451 | 25.15 | 0.0071 | NBFD25 |
| 23 | −54.8875 | 0.5835 | | | | |
| 24 | 222.0073 | 4.2554 | 1.55032 | 75.50 | 0.0274 | FCD705 |
| 25 | −56.9266 | 1.3121 | | | | |
| 26 | 28.5159 | 6.9065 | 1.43700 | 95.10 | 0.0564 | FCD100 |
| 27 | −375.7035 | 0.8801 | | | | |
| 28 | 119.4415 | 3.3450 | 1.94595 | 17.98 | 0.0385 | FDS18-W |
| 29 | −195.2717 | 0.3120 | | | | |
| 30 | 44.4274 | 5.9592 | 1.43700 | 95.10 | 0.0564 | FCD100 |
| 31 | −38.4161 | 0.8640 | 1.85451 | 25.15 | 0.0071 | NBFD25 |
| 32 | 26.4842 | 1.3541 | | | | |
| *33 | 27.2323 | 6.1787 | 1.80610 | 40.73 | −0.0058 | M-NBFD130 |
| *34 | −110.8318 | 14.4500 | | | | |
| 35 | ∞ | 2.5000 | 1.51680 | 64.20 | 0.0014 | BSC7 |
| 36 | ∞ | (BF) | | | | |

[Aspherical Surface Data]

| | 13th Surface | 14th Surface | 33rd Surface | 34th Surface |
|---|---|---|---|---|
| K | 0.00000E+00 | 0.00000E+00 | 0.00000E+00 | 0.00000E+00 |
| A4 | 6.55853E−07 | 1.91717E−06 | −8.88512E−06 | 2.19582E−06 |
| A6 | −2.29219E−09 | −1.09209E−09 | −2.18487E−08 | −2.31128E−08 |
| A8 | −1.63019E−12 | −2.62880E−11 | 4.87875E−11 | 7.01848E−11 |
| A10 | −1.07318E−13 | 4.15624E−14 | −7.28767E−13 | −6.46356E−13 |
| A12 | −6.86909E−17 | −4.43982E−16 | −4.83940E−16 | −1.57392E−15 |
| A14 | 6.59535E−19 | 5.03346E−19 | 0.00000E+00 | 4.13402E−18 |
| A16 | −1.09599E−21 | −2.69038E−22 | 0.00000E+00 | 0.00000E+00 |

[Various Data]

| | Wide Angle (INF) |
|---|---|
| Focal Length | 7.70 |
| F-number | 1.26 |
| Total Angle of View 2ω | 202.00 |
| Image Height Y | 11.89 |
| Overall Lens Length | 135.68 |

[Variable Distance Data]

| | INF | Close Distance |
|---|---|---|
| (d0) | ∞ | 207.2333 |
| (d10) | 5.0518 | 5.2879 |
| (d17) | 6.3314 | 6.0953 |
| (BF) | 1.0000 | 1.0000 |

[Lens Group Data]

| Group | Starting Surface | Focal Length |
|---|---|---|
| G1 | 1 | −73.7389 |
| G2 | 19 | 27.7005 |

[Convex Lens in Second Lens Group G2 Satisfying Conditional Expression (16)]

| Surface | Corresponding | | | G2LPAXh / | |
|---|---|---|---|---|---|
| Number | Glass Material | G2LPAXh | G2LPOAh | G2LPOAh | ΔPgF |
| 24 | FCD705 | 12.755 | 6.568 | 1.9 | 0.0274 |
| 26 | FCD100 | 12.808 | 8.629 | 1.5 | 0.0564 |
| 28 | FDS18-W | 11.793 | 9.517 | 1.2 | 0.0385 |
| 30 | FCD100 | 10.538 | 9.700 | 1.1 | 0.0564 |
| 33 | M-NBFD130 | 8.354 | 10.310 | 0.8 | −0.0058 |

### Example 8

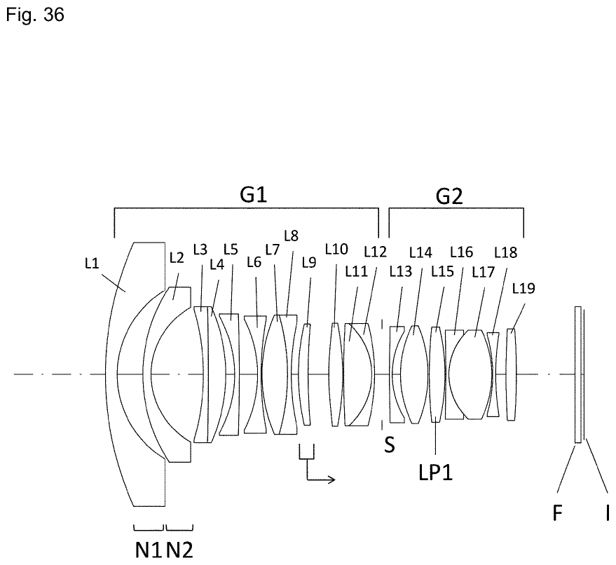

FIG. 36 is a diagram showing a lens configuration of a large aperture ratio ultra wide angle lens according to Example 8 when focusing on infinity.

The large aperture ratio ultra wide angle lens in FIG. 36 includes, in order from the object side, with a first lens group G1 having a positive refractive power, an aperture diaphragm S, and a second lens group G2 having a positive refractive power.

The first lens group G1 includes, in order from the object side, a meniscus negative lens component N1 including a meniscus negative lens L1 with its convex surface facing the object side, a meniscus negative lens component N2 including a meniscus negative lens L2 with its convex surface facing the object side, a cemented lens of a meniscus negative lens L3 with its convex surface facing the image side and a meniscus positive lens L4 with its convex surface facing the image side, a meniscus negative lens L5 with its convex surface facing the image side, a biconcave lens L6, a cemented lens of a biconvex lens L7 and a biconcave lens L8, a meniscus positive lens L9 with its convex surface facing the object side, a biconvex aspheric lens L10, and a cemented lens of a biconvex lens L11 and a meniscus negative lens L12 with its convex surface facing the image side.

The second lens group G2 includes, in order from the object side, a meniscus negative lens L13 with its convex surface facing the object side, a biconvex lens L14, a biconvex lens L15, a cemented lens of a biconcave lens L16 and a biconvex lens L17, a biconcave lens L18, and a biconvex aspheric lens L19.

As an example of focusing, L9 among the lenses that configure the first lens group G1 is moved to the image side along the optical axis, thereby making it possible to perform focusing from an infinite distance object to a close distance object. Regardless of this, it is possible to perform focusing by moving a part or the entirety of the optical system in the optical axis direction.

Specifications of the large aperture ratio ultra wide angle lens according to Example 8 are shown below.

### Numerical Example 8

Unit: mm
[Surface Data]

| Surface | | | | | | Corresponding |
|---|---|---|---|---|---|---|
| Number | r | d | nd | vd | ΔPgF | Glass Material |
| 0 | | (d0) | | | | |
| 1 | 112.3138 | 4.0000 | 1.95375 | 32.32 | 0.0003 | S-LAH98 |
| 2 | 34.2660 | 8.7111 | | | | |
| 3 | 55.2718 | 2.8000 | 1.83481 | 42.72 | −0.0068 | TAFD5G |
| 4 | 26.7269 | 17.7777 | | | | |
| 5 | −80.6582 | 1.6980 | 1.49700 | 81.61 | 0.0373 | FCD1 |
| 6 | −983.3216 | 5.9013 | 1.95375 | 32.32 | −0.0002 | TAFD45 |
| 7 | −57.9494 | 3.0030 | | | | |
| 8 | −41.5288 | 1.5482 | 1.64769 | 33.84 | 0.0049 | E-FD2 |
| 9 | −708.8133 | 6.2185 | | | | |
| 10 | −43.2268 | 1.2490 | 1.49700 | 81.61 | 0.0373 | FCD1 |
| 11 | 107.1727 | 0.3000 | | | | |
| 12 | 52.8607 | 8.6416 | 1.88300 | 40.80 | −0.0094 | TAFD30 |
| 13 | −76.5204 | 1.2483 | 1.43700 | 95.10 | 0.0564 | FCD100 |
| 14 | 84.1545 | (d14) | | | | |
| 15 | 79.1535 | 3.2271 | 1.94595 | 17.98 | 0.0385 | FDS18-W |
| 16 | 198.2362 | (d16) | | | | |
| *17 | 92.7539 | 4.7726 | 1.59271 | 66.97 | 0.0088 | MC-PCD5170 |
| *18 | −85.5420 | 0.3000 | | | | |
| 19 | 322.3327 | 9.5384 | 1.77250 | 49.62 | −0.0088 | TAF1 |
| 20 | −23.9034 | 1.0000 | 2.05090 | 26.94 | 0.0052 | TAFD65 |
| 21 | −69.0134 | 2.5000 | | | | |
| 22 (diaphragm) | ∞ | 2.5000 | | | | |
| 23 | 567.9832 | 1.0000 | 1.67270 | 32.17 | 0.0058 | E-FD5 |
| 24 | 29.7016 | 2.7592 | | | | |
| 25 | 38.1242 | 9.3236 | 1.43700 | 95.10 | 0.0564 | FCD100 |
| 26 | −44.9424 | 0.5000 | | | | |
| 27 | 167.2352 | 5.2510 | 1.94595 | 17.98 | 0.0385 | FDS18-W |
| 28 | −73.7899 | 0.3000 | | | | |
| 29 | −620.9350 | 1.0967 | 1.68893 | 31.16 | 0.0066 | E-FD8 |
| 30 | 21.2617 | 14.5557 | 1.59282 | 68.62 | 0.0192 | FCD515 |
| 31 | −34.9210 | 0.3000 | | | | |
| 32 | −51.2896 | 1.0000 | 1.85451 | 25.15 | 0.0071 | NBFD25 |
| 33 | 91.4301 | 3.5000 | | | | |
| *34 | 148.0573 | 3.4850 | 1.80610 | 40.73 | −0.0058 | M-NBFD130 |
| *35 | −450.0000 | 19.9335 | | | | |
| 36 | ∞ | 2.1000 | 1.51680 | 64.20 | 0.0014 | BSC7 |
| 37 | ∞ | (BF) | | | | |

[Aspherical Surface Data]

| | 17th Surface | 18th Surface | 34th Surface | 35th Surface |
|---|---|---|---|---|
| K | 0.00000E+00 | 0.00000E+00 | 0.00000E+00 | 0.00000E+00 |
| A4 | −5.20870E−06 | 2.40548E−06 | −9.85290E−06 | −8.77603E−06 |
| A6 | 1.68908E−10 | −3.25984E−09 | −2.18389E−09 | 9.04754E−10 |
| A8 | −6.31999E−12 | 1.32317E−12 | 1.25848E−10 | 1.01128E−10 |
| A10 | 1.92312E−14 | 0.00000E+00 | −2.23659E−13 | −9.72629E−14 |
| A12 | 0.00000E+00 | 0.00000E+00 | 8.49746E−17 | −6.12395E−17 |
| A14 | 0.00000E+00 | 0.00000E+00 | 0.00000E+00 | 0.00000E+00 |
| A16 | 0.00000E+00 | 0.00000E+00 | 0.00000E+00 | 0.00000E+00 |

[Various Data]

| | Wide Angle (INF) |
|---|---|
| Focal Length | 15.51 |
| F-number | 1.46 |
| Total Angle of View 2ω | 185.73 |
| Image Height Y | 22.40 |
| Overall Lens Length | 162.54 |

[Variable Distance Data]

| | INF | Close Distance |
|---|---|---|
| (d0) | ∞ | 435.5949 |
| (d14) | 2.5000 | 4.1313 |
| (d16) | 7.0000 | 5.3687 |
| (BF) | 1.0000 | 1.0000 |

[Lens Group Data]

| Group | Starting Surface | Focal Length |
|---|---|---|
| G1 | 1 | 28.4098 |
| G2 | 23 | 70.6349 |

[Convex Lens in Second Lens Group G2 Satisfying Conditional Expression (16)]

| Surface | Corresponding | | | G2LPAXh/ | |
|---|---|---|---|---|---|
| Number | Glass Material | G2LPAXh | G2LPOAh | G2LPOAh | ΔPgF |
| 27 | FDS18-W | 15.14826 | 6.9084 | 2.2 | 0.0385 |
| 30 | FCD515 | 12.74823 | 8.46934 | 1.5 | 0.0192 |
| 34 | M-NBFD130 | 8.71565 | 12.87559 | 0.7 | −0.0058 |

### Example 9

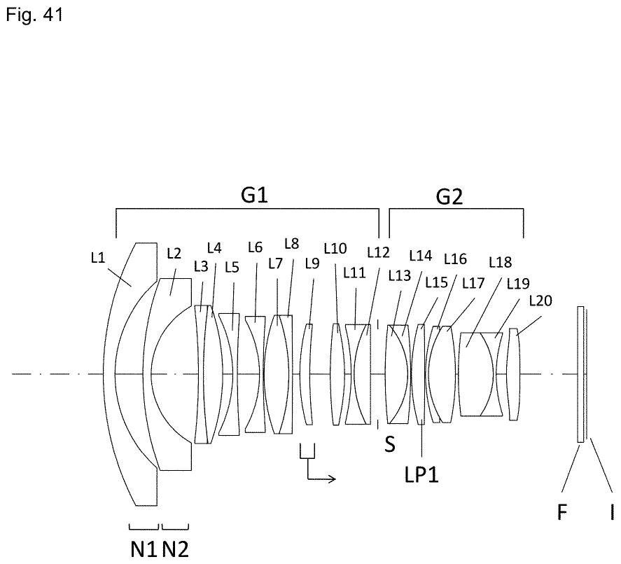

FIG. 41 is a diagram showing a lens configuration of a large aperture ratio ultra wide angle lens according to Example 9 when focusing on infinity.

The large aperture ratio ultra wide angle lens in FIG. 41 includes, in order from the object side, with a first lens group G1 having a positive refractive power, an aperture diaphragm S, and a second lens group G2 having a positive refractive power.

The first lens group G1 includes, in order from the object side, a meniscus negative lens component N1 including a meniscus negative lens L1 with its convex surface facing the object side, a meniscus negative lens component N2 including a meniscus negative lens L2 with its convex surface facing the object side, a cemented lens of a biconcave lens L3 and a biconvex lens L4, a biconcave lens L5, a biconcave lens L6, a cemented lens of a biconvex lens L7 and a meniscus negative lens L8 with its convex surface facing the image side, a meniscus positive lens L9 with its convex surface facing the object side, a biconvex aspheric lens L10, and a cemented lens of a biconcave lens L11 and a plano-convex lens L12 with its convex surface facing the object side.

The second lens group G2 includes, in order from the object side, a cemented lens of a biconvex lens L13 and a meniscus negative lens L14 with its convex surface facing the image side, a biconvex lens L15, a cemented lens of a meniscus negative lens L16 with its convex surface facing the object side and a biconvex lens L17, a cemented lens of a biconvex lens L18 and a biconcave lens L19, and a biconvex aspheric lens L20.

As an example of focusing, L9 among the lenses that configure the first lens group G1 is moved to the image side along the optical axis, thereby making it possible to perform focusing from an infinite distance object to a close distance object. Regardless of this, it is possible to perform focusing by moving a part or the entirety of the optical system in the optical axis direction.

Specifications of the large aperture ratio ultra wide angle lens according to Example 9 are shown below.

### Numerical Example 9

Unit: mm
[Surface Data]

| Surface | | | | | | Corresponding |
|---|---|---|---|---|---|---|
| Number | r | d | nd | vd | ΔPgF | Glass Material |
| 0 | | (d0) | | | | |
| 1 | 98.7053 | 4.0000 | 2.00069 | 25.46 | 0.0110 | TAFD40-W |
| 2 | 43.9390 | 9.5217 | | | | |
| 3 | 97.2080 | 2.8000 | 1.88300 | 40.80 | −0.0094 | TAFD30 |
| 4 | 27.2191 | 16.2160 | | | | |
| 5 | −213.5111 | 1.6981 | 1.43700 | 95.10 | 0.0564 | FCD100 |
| 6 | 185.5420 | 6.5692 | 1.77047 | 29.74 | 0.0002 | NBFD29 |
| 7 | −72.4901 | 3.4403 | | | | |
| 8 | −45.3581 | 1.5485 | 1.59410 | 60.47 | 0.0156 | FCD600 |
| 9 | 276.3884 | 7.5756 | | | | |
| 10 | −39.1252 | 1.2494 | 1.49700 | 81.61 | 0.0373 | FCD1 |
| 11 | 254.1854 | 0.3000 | | | | |
| 12 | 62.1410 | 8.4310 | 1.83481 | 42.72 | −0.0068 | TAFD5G |
| 13 | −64.8431 | 1.2489 | 1.61340 | 44.27 | −0.0054 | S-NBM51 |
| 14 | −1674.5692 | (d14) | | | | |
| 15 | 68.8448 | 3.4012 | 1.95375 | 32.32 | 0.0003 | S-LAH98 |
| 16 | 165.1776 | (d16) | | | | |
| *17 | 154.6546 | 4.8709 | 1.59271 | 66.97 | 0.0088 | MC-PCD5170 |
| *18 | −65.8469 | 2.2392 | | | | |
| 19 | −70.3351 | 1.0000 | 1.73037 | 32.23 | −0.0005 | NBFD32 |
| 20 | 38.3564 | 5.5908 | 1.95375 | 32.32 | 0.0003 | S-LAH98 |
| 21 | ∞ | 2.5000 | | | | |
| 22(diaphragm) | ∞ | 2.5000 | | | | |
| 23 | 163.5955 | 7.6894 | 1.43700 | 95.10 | 0.0564 | FCD100 |
| 24 | −26.4662 | 0.9923 | 1.85451 | 25.15 | 0.0071 | NBFD25 |
| 25 | −159.1732 | 0.3000 | | | | |
| 26 | 66.7799 | 4.4880 | 1.94595 | 17.98 | 0.0385 | FDS18-W |
| 27 | −1051.7542 | 0.3000 | | | | |
| 28 | 54.6478 | 0.9940 | 1.85451 | 25.15 | 0.0071 | NBFD25 |
| 29 | 31.2809 | 9.2065 | 1.59522 | 67.73 | 0.0177 | S-FPM2 |
| 30 | −86.8624 | 0.9834 | | | | |
| 31 | 119.2742 | 12.0000 | 1.59522 | 67.73 | 0.0177 | S-FPM2 |
| 32 | −25.2449 | 0.9984 | 1.73037 | 32.23 | −0.0005 | NBFD32 |
| 33 | 45.9157 | 3.5000 | | | | |
| *34 | 58.9965 | 4.5763 | 1.80610 | 40.73 | −0.0058 | M-NBFD130 |
| *35 | −450.0000 | 19.6699 | | | | |
| 36 | ∞ | 2.1000 | 1.51680 | 64.20 | 0.0014 | BSC7 |
| 37 | ∞ | (BF) | | | | |

[Aspherical Surface Data]

| | 17th Surface | 18th Surface | 34th Surface | 35th Surface |
|---|---|---|---|---|
| K | 0.00000E+00 | 0.00000E+00 | 0.00000E+00 | 0.00000E+00 |
| A4 | −8.73064E−07 | 2.93720E−06 | −1.36912E−05 | −7.92100E−06 |
| A6 | 3.33444E−09 | 1.20867E−09 | −1.14939E−08 | −6.93770E−09 |
| A8 | −1.10489E−12 | 4.39165E−12 | −7.65401E−11 | −9.93617E−11 |
| A10 | 1.28985E−14 | 0.00000E+00 | 2.20186E−13 | 3.27569E−13 |
| A12 | 0.00000E+00 | 0.00000E+00 | 1.08085E−16 | −8.89676E−17 |
| A14 | 0.00000E+00 | 0.00000E+00 | 0.00000E+00 | 0.00000E+00 |
| A16 | 0.00000E+00 | 0.00000E+00 | 0.00000E+00 | 0.00000E+00 |

[Various Data]

| | Wide Angle (INF) |
|---|---|
| Focal Length | 15.51 |
| F-number | 1.46 |
| Total Angle of View 2ω | 185.73 |
| Image Height Y | 22.42 |
| Overall Lens Length | 165.00 |

[Variable Distance Data]

| | INF | Close Distance |
|---|---|---|
| (d0) | ∞ | 432.9120 |
| (d14) | 2.5000 | 4.1549 |
| (d16) | 7.0010 | 5.3462 |
| (BF) | 1.0000 | 1.0000 |

[Lens Group Data]

| Group | Starting Surface | Focal Length |
|---|---|---|
| G1 | 1 | 128.6077 |
| G2 | 23 | 48.8800 |

[Convex Lens in Second Lens Group G2 Satisfying Conditional Expression (16)]

| Surface | Corresponding | | | G2LPAXh/ | |
|---|---|---|---|---|---|
| Number | Glass Material | G2LPAXh | G2LPOAh | G2LPOAh | ΔPgF |
| 29 | S-FPM2 | 14.944 | 5.722 | 2.6 | 0.0177 |
| 31 | S-FPM2 | 13.033 | 8.241 | 1.6 | 0.0177 |
| 34 | M-NBFD130 | 8.748 | 12.745 | 0.7 | −0.0058 |

### Example 10

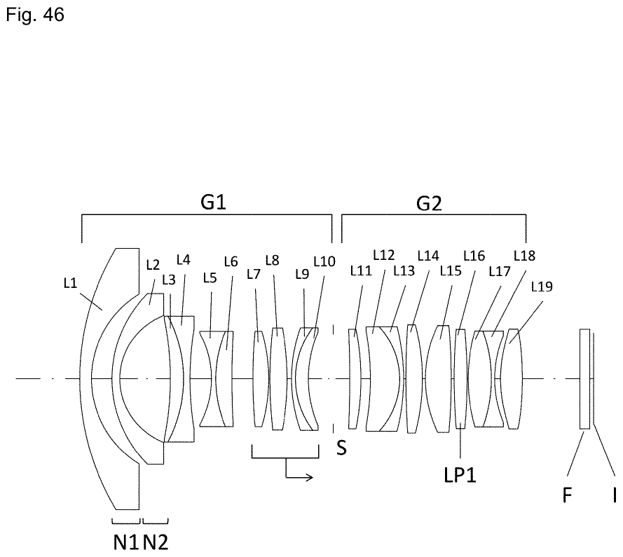

FIG. 46 is a diagram showing a lens configuration of a large aperture ratio ultra wide angle lens according to Example 10 when focusing on infinity.

The large aperture ratio ultra wide angle lens in FIG. 46 includes, in order from the object side, with a first lens group G1 having a negative refractive power, an aperture diaphragm S, and a second lens group G2 having a positive refractive power.

The first lens group G1 includes, in order from the object side, a meniscus negative lens component N1 including a meniscus negative lens L1 with its convex surface facing the object side, a meniscus negative lens component N2 including a meniscus negative lens L2 with its convex surface facing the object side, a cemented lens of a meniscus positive lens L3 with its convex surface facing the image side and a biconcave lenses L4, a cemented lens of a biconcave lenses L5 and a meniscus positive lens L6 with its convex surface facing the object side, a biconvex lens L7, a biconvex aspheric lens L8, and a cemented lens of a meniscus negative lens L9 with its convex surface facing the object side and a meniscus positive lens L10 with its convex surface facing the object side.

The second lens group G2 includes, in order from the object side, a meniscus positive lens L11 with its convex surface facing the image side, a cemented lens of a meniscus positive lens L12 with its convex surface facing the image side and a meniscus negative lens L13 with its convex surface facing the image side, a biconvex lens L14, a biconvex lens L15, a biconvex lens L16, a cemented lens of a biconvex lens L17 and a biconcave lens L18, and a biconvex aspheric lens L19.

As an example of focusing, the lenses L7 to L10 among the lenses that configure the first lens group G1 are integrally moved to the image side along the optical axis, thereby making it possible to perform focusing from an infinite distance object to a close distance object. Regardless of this, it is possible to perform focusing by moving a part or the entirety of the optical system in the optical axis direction.

Specifications of the large aperture ratio ultra wide angle lens according to Example 10 are shown below.

### Numerical Example 10

Unit: mm
[Surface Data]

| Surface | | | | | | Corresponding |
|---|---|---|---|---|---|---|
| Number | r | d | nd | vd | ΔPgF | Glass Material |
| 0 | | (d0) | | | | |
| 1 | 66.8969 | 3.0000 | 1.95375 | 32.32 | 0.0003 | S-LAH98 |
| 2 | 26.0915 | 5.2825 | | | | |
| 3 | 31.6843 | 2.0000 | 1.95375 | 32.32 | 0.0003 | S-LAH98 |
| 4 | 17.7585 | 12.9593 | | | | |
| 5 | −79.9016 | 3.3649 | 1.85451 | 25.15 | 0.0071 | NBFD25 |
| 6 | −35.5849 | 1.6504 | 1.43700 | 95.10 | 0.0564 | FCD100 |
| 7 | 82.9243 | 5.4787 | | | | |
| 8 | −25.1965 | 1.0883 | 1.80100 | 34.97 | 0.0009 | S-LAM66 |
| 9 | 31.9192 | 4.1874 | 1.86966 | 20.02 | 0.0310 | FDS20-W |
| 10 | 230.0159 | (d10) | | | | |
| 11 | 146.1103 | 4.0237 | 1.49700 | 81.61 | 0.0373 | FCD1 |
| 12 | −44.6598 | 0.3000 | | | | |
| *13 | 117.2465 | 4.4343 | 1.85135 | 40.10 | −0.0067 | M-TAFD305 |
| *14 | −70.8792 | 1.1490 | | | | |
| 15 | 40.2335 | 0.9999 | 1.80440 | 39.58 | −0.0010 | S-LAH63Q |
| 16 | 22.4130 | 3.2875 | 2.05090 | 26.94 | 0.0052 | TAFD65 |
| 17 | 31.2387 | (d17) | | | | |
| 18 (diaphragm) | ∞ | 4.2749 | | | | |
| 19 | −291.0489 | 2.8532 | 1.49700 | 81.61 | 0.0373 | FCD1 |
| 20 | −65.9825 | 2.4054 | | | | |
| 21 | −71.0126 | 7.4724 | 1.43700 | 95.10 | 0.0564 | FCD100 |
| 22 | −20.2989 | 1.0000 | 1.85451 | 25.15 | 0.0071 | NBFD25 |
| 23 | −56.5038 | 0.5986 | | | | |
| 24 | 223.1596 | 4.2656 | 1.55032 | 75.50 | 0.0274 | FCD705 |
| 25 | −55.7988 | 0.7680 | | | | |
| 26 | 32.3637 | 6.5820 | 1.43700 | 95.10 | 0.0564 | FCD100 |
| 27 | −164.2584 | 0.7552 | | | | |
| 28 | 159.3632 | 3.2913 | 1.94595 | 17.98 | 0.0385 | FDS18-W |
| 29 | −142.3318 | 0.3000 | | | | |
| 30 | 45.2517 | 5.9578 | 1.43700 | 95.10 | 0.0564 | FCD100 |
| 31 | −37.1225 | 0.8500 | 1.85451 | 25.15 | 0.0071 | NBFD25 |
| 32 | 29.8468 | 1.4869 | | | | |
| *33 | 34.0201 | 5.5673 | 1.80610 | 40.73 | −0.0058 | M-NBFD130 |
| *34 | −88.7909 | 14.7372 | | | | |
| 35 | ∞ | 2.5000 | 1.51680 | 64.20 | 0.0014 | BSC7 |
| 36 | ∞ | (BF) | | | | |

[Aspherical Surface Data]

| | 13th Surface | 14th Surface | 33rd Surface | 34th Surface |
|---|---|---|---|---|
| K | 0.00000E+00 | 0.00000E+00 | 0.00000E+00 | 0.00000E+00 |
| A4 | 2.43982E−07 | 2.61027E−06 | −8.74514E−06 | −1.12943E−06 |
| A6 | −2.49273E−09 | −1.30700E−09 | −2.53563E−08 | −2.52830E−08 |
| A8 | −2.32133E−12 | −2.88783E−11 | 6.38673E−11 | 5.83737E−11 |
| A10 | −1.14082E−13 | 4.33693E−14 | −7.47845E−13 | −5.16445E−13 |
| A12 | −9.13500E−17 | −4.44549E−16 | −5.45248E−17 | −1.55588E−15 |
| A14 | 5.57097E−19 | 5.00316E−19 | 0.00000E+00 | 4.13406E−18 |
| A16 | −1.17000E−21 | −5.13779E−22 | 0.00000E+00 | 0.00000E+00 |

[Various Data]

| | Wide Angle (INF) |
|---|---|
| Focal Length | 8.15 |
| F-number | 1.26 |
| Total Angle of View 2ω | 185.73 |
| Image Height Y | 11.93 |
| Overall Lens Length | 131.59 |

[Variable Distance Data]

| | INF | Close Distance |
|---|---|---|
| (d0) | ∞ | 224.2633 |
| (d10) | 5.3643 | 5.6235 |
| (d17) | 6.3544 | 6.0951 |
| (BF) | 1.0000 | 1.0000 |

[Lens Group Data]

| Group | Starting Surface | Focal Length |
|---|---|---|
| G1 | 1 | −88.9270 |
| G2 | 19 | 28.0433 |

[Convex Lens in Second Lens Group G2 Satisfying Conditional Expression (16)]

| Surface | Corresponding | | | G2LPAXh/ | |
|---|---|---|---|---|---|
| Number | Glass Material | G2LPAXh | G2LPOAh | G2LPOAh | ΔPgF |
| 24 | FCD705 | 12.848 | 6.596 | 1.9 | 0.0274 |
| 26 | FCD100 | 12.824 | 8.469 | 1.5 | 0.0564 |
| 28 | FDS18-W | 11.866 | 9.464 | 1.3 | 0.0385 |
| 30 | FCD100 | 10.579 | 9.739 | 1.1 | 0.0564 |
| 33 | M-NBFD130 | 8.383 | 10.385 | 0.8 | −0.0058 |

### Example 11

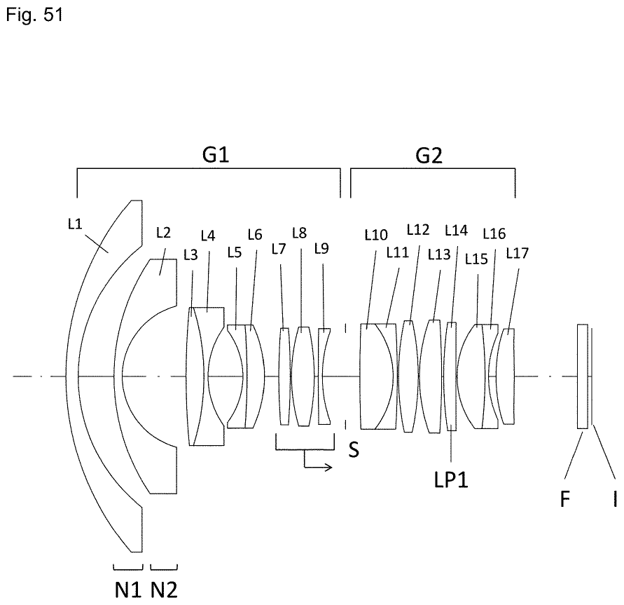

FIG. 51 is a diagram showing a lens configuration of a large aperture ratio ultra wide angle lens according to Example 11 when focusing on infinity.

The large aperture ratio ultra wide angle lens in FIG. 51 includes, in order from the object side, with a first lens group G1 having a negative refractive power, an aperture diaphragm S, and a second lens group G2 having a positive refractive power.

The first lens group G1 includes, in order from the object side, a meniscus negative lens component N1 including a meniscus negative lens L1 with its convex surface facing the object side, a meniscus negative lens component N2 including a meniscus negative lens L2 with its convex surface facing the object side, a cemented lens of a biconvex lens L3 and a biconcave lens L4, a cemented lens of a meniscus negative lens L5 with its convex surface facing the image side and a meniscus positive lens L6 with its convex surface facing the image side, a biconvex lens L7, a biconvex aspheric lens L8, and a meniscus negative lens L9 with its convex surface facing the object side.

The second lens group G2 includes, in order from the object side, a cemented lens of a biconvex lens L10 and a meniscus negative lens L11 with its convex surface facing the image side, a biconvex lens L12, a biconvex lens L13, a meniscus positive lens L14 with its convex surface facing the object side, a cemented lens of a biconvex lens L15 and a biconcave lens L16, and a biconvex aspheric lens L17.

As an example of focusing, the lenses L7 to L9 among the lenses that configure the first lens group G1 are integrally moved to the image side along the optical axis, thereby making it possible to perform focusing from an infinite distance object to a close distance object. Regardless of this, it is possible to perform focusing by moving a part or the entirety of the optical system in the optical axis direction.

Specifications of the large aperture ratio ultra wide angle lens according to Example 11 are shown below.

### Numerical Example 11

Unit: mm
[Surface Data]

| Surface | | | | | | Corresponding |
|---|---|---|---|---|---|---|
| Number | r | d | nd | vd | ΔPgF | Glass Material |
| 0 | | (d0) | | | | |
| 1 | 67.2900 | 3.0000 | 1.95375 | 32.32 | 0.0003 | S-LAH98 |
| 2 | 41.3838 | 8.7352 | | | | |
| 3 | 52.1615 | 2.0000 | 2.00100 | 29.13 | 0.0035 | TAFD55-W |
| 4 | 18.1324 | 15.5164 | | | | |
| 5 | 179.1485 | 4.3635 | 1.85478 | 24.80 | 0.0085 | S-NBH56 |
| 6 | −57.8236 | 1.0000 | 1.43875 | 94.66 | 0.0560 | S-FPL55 |
| 7 | 21.0637 | 8.5020 | | | | |
| 8 | −19.0241 | 1.0000 | 1.90043 | 37.37 | −0.0045 | TAFD37A |
| 9 | −169.3560 | 4.2124 | 1.86966 | 20.02 | 0.0310 | FDS20-W |
| 10 | −30.6058 | (d10) | | | | |
| 11 | 157.1560 | 2.7797 | 1.49700 | 81.61 | 0.0373 | FCD1 |
| 12 | −161.0009 | 0.3000 | | | | |
| *13 | 41.3631 | 5.5534 | 1.85135 | 40.10 | −0.0067 | M-TAFD305 |
| *14 | −55.9387 | 0.9864 | | | | |
| 15 | 778.6812 | 1.0000 | 1.77250 | 49.62 | −0.0088 | TAF1 |
| 16 | 33.5791 | (d16) | | | | |
| 17 (diaphragm) | ∞ | 3.5000 | | | | |
| 18 | 337.9519 | 8.0673 | 1.43875 | 94.66 | 0.0560 | S-FPL55 |
| 19 | −21.0961 | 1.0000 | 1.85478 | 24.80 | 0.0085 | S-NBH56 |
| 20 | −220.9655 | 0.3000 | | | | |
| 21 | 66.9199 | 4.8116 | 1.53775 | 74.70 | 0.0254 | S-FPM3 |
| 22 | −64.8593 | 0.3000 | | | | |
| 23 | 41.7438 | 5.4048 | 1.59522 | 67.73 | 0.0177 | S-FPM2 |
| 24 | −218.6134 | 0.5009 | | | | |
| 25 | 91.4489 | 2.9745 | 1.94595 | 17.98 | 0.0385 | FDS18-W |
| 26 | 1224.3490 | 0.3000 | | | | |
| 27 | 21.4816 | 6.7604 | 1.43875 | 94.66 | 0.0560 | S-FPL55 |
| 28 | −109.9546 | 0.8500 | 1.80518 | 25.46 | 0.0131 | FD60-W |
| 29 | 25.9991 | 1.8290 | | | | |
| *30 | 38.7592 | 4.4495 | 1.80610 | 40.73 | −0.0058 | M-NBFD130 |
| *31 | −162.2004 | 15.3592 | | | | |
| 32 | ∞ | 2.5000 | 1.51680 | 64.20 | 0.0014 | BSC7 |
| 33 | ∞ | (BF) | | | | |

[Aspherical Surface Data]

| | 13th Surface | 14th Surface | 30th Surface | 31st Surface |
|---|---|---|---|---|
| K | 0.00000E+00 | 0.00000E+00 | 0.00000E+00 | 0.00000E+00 |
| A4 | −2.81080E−06 | 1.93216E−06 | −6.35491E−06 | 1.64485E−05 |
| A6 | −1.25716E−09 | 2.08091E−09 | 5.30275E−08 | 6.01955E−08 |
| A8 | −1.95942E−12 | −3.40050E−11 | −2.75847E−11 | −2.31795E−11 |
| A10 | −1.89149E−13 | −6.57967E−14 | 1.35764E−12 | 1.72479E−12 |
| A12 | 4.66222E−16 | 7.00762E−16 | −5.04259E−16 | −1.53100E−15 |
| A14 | 4.77965E−18 | 1.71629E−18 | 0.00000E+00 | 4.09144E−18 |
| A16 | −5.95085E−20 | −5.29005E−20 | 0.00000E+00 | 0.00000E+00 |

[Various Data]

| | Wide Angle (INF) |
|---|---|
| Focal Length | 7.70 |
| F-number | 1.26 |
| Total Angle of View 2ω | 202.00 |
| Image Height Y | 11.88 |
| Overall Lens Length | 128.00 |

[Variable Distance Data]

| | INF | Close Distance |
|---|---|---|
| (d0) | ∞ | 205.2527 |
| (d10) | 3.5000 | 4.0317 |
| (d16) | 5.6438 | 5.1120 |
| (BF) | 1.0000 | 1.0000 |

[Lens Group Data]

| Group | Starting Surface | Focal Length |
|---|---|---|
| G1 | 1 | −40.3001 |
| G2 | 18 | 25.0935 |

[Convex Lens in Second Lens Group G2 Satisfying Conditional Expression (16)]

| Surface | Corresponding | | | G2LPAXh/ | |
|---|---|---|---|---|---|
| Number | Glass Material | G2LPAXh | G2LPOAh | G2LPOAh | ΔPgF |
| 23 | S-FPM2 | 12.856 | 6.071 | 2.1 | 0.0177 |
| 25 | FDS18-W | 12.278 | 7.176 | 1.7 | 0.0385 |
| 27 | S-FPL55 | 10.927 | 7.768 | 1.4 | 0.0560 |
| 30 | M-NBFD130 | 8.557 | 8.354 | 1.0 | −0.0058 |

### Example 12

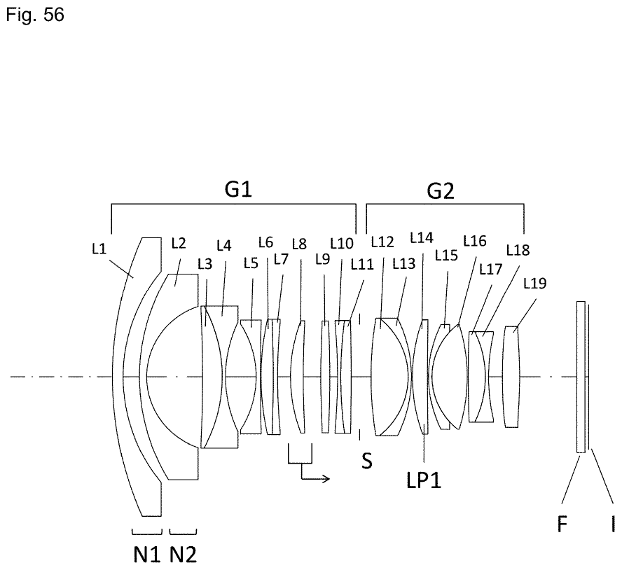

FIG. 56 is a diagram showing a lens configuration of a large aperture ratio ultra wide angle lens according to Example 12 when focusing on infinity.

The large aperture ratio ultra wide angle lens in FIG. 56 includes, in order from the object side, with a first lens group G1 having a negative refractive power, an aperture diaphragm S, and a second lens group G2 having a positive refractive power.

The first lens group G1 includes, in order from the object side, a meniscus negative lens component N1 including a meniscus negative lens L1 with its convex surface facing the object side, a meniscus negative lens component N2 including a meniscus negative lens L2 with its convex surface facing the object side, a cemented lens of a meniscus positive lens L3 with its convex surface facing the image side and a biconcave lenses L4, a biconcave lens L5, a cemented lens of a biconvex lens L6 and a biconcave lens L7, a meniscus positive lens L8 with its convex surface facing the object side, a biconvex aspheric lens L9, and a cemented lens of a biconcave lens L10 and a biconvex lens L11.

The second lens group G2 includes, in order from the object side, a cemented lens of a biconvex lens L12 and a meniscus positive lens L13 with its convex surface facing the image side, a meniscus positive lens L14 with its convex surface facing the object side, a cemented lens of a meniscus negative lens L15 with its convex surface facing the object side and a biconvex lens L16, a cemented lens of a biconvex lens L17 and a biconcave lens L18, and a biconvex aspheric lens L19.

As an example of focusing, L8 among the lenses that configure the first lens group G1 is moved to the image side along the optical axis, thereby making it possible to perform focusing from an infinite distance object to a close distance object. Regardless of this, it is possible to perform focusing by moving a part or the entirety of the optical system in the optical axis direction.

Specifications of the large aperture ratio ultra wide angle lens according to Example 12 are shown below.

### Numerical Example 12

Unit: mm
[Surface Data]

| Surface | | | | | | Corresponding |
|---|---|---|---|---|---|---|
| Number | r | d | nd | vd | ΔPgF | Glass Material |
| 0 | | (d0) | | | | |
| 1 | 107.7115 | 3.2000 | 1.88300 | 40.80 | −0.0094 | TAFD30 |
| 2 | 51.8324 | 5.0000 | | | | |
| 3 | 61.6766 | 2.2000 | 2.00100 | 29.13 | 0.0035 | TAFD55-W |
| 4 | 23.0469 | 17.0075 | | | | |
| 5 | −437.9084 | 6.0155 | 1.91082 | 35.25 | −0.0028 | TAFD35 |
| 6 | −46.3851 | 1.0000 | 1.43700 | 95.10 | 0.0564 | FCD100 |
| 7 | 39.7177 | 9.3614 | | | | |
| 8 | −30.5889 | 1.2909 | 1.63980 | 34.47 | 0.0059 | S-TIM27 |
| 9 | 613.6154 | 0.2000 | | | | |
| 10 | 81.5892 | 3.7398 | 2.00100 | 29.13 | 0.0035 | TAFD55-W |
| 11 | −431.5214 | 1.2478 | 1.49700 | 81.61 | 0.0373 | FCD1 |
| 12 | 182.9894 | (d12) | | | | |
| 13 | 49.2579 | 3.8959 | 1.95375 | 32.32 | −0.0002 | TAFD45 |
| 14 | 314.0027 | (d14) | | | | |
| *15 | 177.2163 | 2.7755 | 1.77377 | 47.17 | −0.0078 | MC-TAF401 |
| *16 | −330.8819 | 2.3588 | | | | |
| 17 | −183.2441 | 1.0000 | 1.80518 | 25.42 | 0.0134 | S-TIH6 |
| 18 | 134.6389 | 3.1728 | 2.00100 | 29.13 | 0.0035 | TAFD55-W |
| 19 | −819.5687 | 2.5000 | | | | |
| 20 (diaphragm) | ∞ | 3.4884 | | | | |
| 21 | 112.4142 | 11.3509 | 1.48071 | 85.29 | 0.0413 | FCD915 |
| 22 | −23.2781 | 1.0000 | 1.85451 | 25.15 | 0.0071 | NBFD25 |
| 23 | −41.1422 | 0.3000 | | | | |
| 24 | 51.9123 | 4.6218 | 1.86966 | 20.02 | 0.0310 | FDS20-W |
| 25 | 1230.0149 | 0.3000 | | | | |
| 26 | 37.1727 | 1.0000 | 1.85451 | 25.15 | 0.0071 | NBFD25 |
| 27 | 20.6943 | 10.7654 | 1.43700 | 95.10 | 0.0564 | FCD100 |
| 28 | −54.8713 | 0.3000 | | | | |
| 29 | 342.6779 | 5.2180 | 1.49700 | 81.61 | 0.0373 | FCD1 |
| 30 | −32.1179 | 1.0000 | 1.85883 | 30.00 | 0.0035 | NBFD30 |
| 31 | 58.9286 | 4.2268 | | | | |
| *32 | 165.5922 | 5.1795 | 1.80610 | 40.73 | −0.0058 | MC-NBFD130 |
| *33 | −138.4515 | 17.5000 | | | | |
| 34 | ∞ | 2.5000 | 1.51680 | 64.20 | 0.0014 | BSC7 |
| 35 | ∞ | (BF) | | | | |

[Aspherical Surface Data]

| | 15th Surface | 16th Surface | 32nd Surface | 33rd Surface |
|---|---|---|---|---|
| K | 0.00000E+00 | 0.00000E+00 | 0.00000E+00 | 0.00000E+00 |
| A4 | −6.32687E−06 | −9.74442E−08 | −1.69670E−06 | 2.34273E−06 |
| A6 | 6.99614E−09 | 2.18933E−09 | 4.57151E−08 | 2.95505E−08 |
| A8 | −7.12822E−12 | 2.01425E−11 | −3.68763E−10 | −2.15074E−10 |
| A10 | 2.55926E−14 | −7.39304E−14 | 1.88482E−12 | 9.16473E−13 |
| A12 | −6.73556E−17 | −1.62263E−16 | −3.23696E−15 | −9.68715E−16 |
| A14 | 4.97415E−20 | 1.17443E−18 | 0.00000E+00 | −9.69817E−19 |
| A16 | −1.19614E−23 | −1.75009E−21 | 0.00000E+00 | 0.00000E+00 |

[Various Data]

| | Wide Angle (INF) |
|---|---|
| Focal Length | 15.50 |
| F-number | 1.46 |
| Total Angle of View 2ω | 185.73 |
| Image Height Y | 22.36 |
| Overall Lens Length | 145.00 |

[Variable Distance Data]

| | INF | Close Distance |
|---|---|---|
| (d0) | ∞ | 437.6737 |
| (d12) | 3.9500 | 4.5211 |
| (d14) | 5.3334 | 4.7622 |
| (BF) | 1.0000 | 1.0000 |

[Lens Group Data]

| Group | Starting Surface | Focal Length |
|---|---|---|
| G1 | 1 | −134.6293 |
| G2 | 21 | 40.8737 |

[Convex Lens in Second Lens Group G2 Satisfying Conditional Expression (16)]

| Surface | Corresponding | | | G2LPAXh/ | |
|---|---|---|---|---|---|
| Number | Glass Material | G2LPAXh | G2LPOAh | G2LPOAh | ΔPgF |
| 27 | FCD100 | 13.600 | 7.162 | 1.9 | 0.0564 |
| 29 | FCD1 | 11.254 | 9.294 | 1.2 | 0.0373 |
| 32 | MC-NBFD130 | 8.218 | 12.618 | 0.7 | −0.0058 |

### Example 13

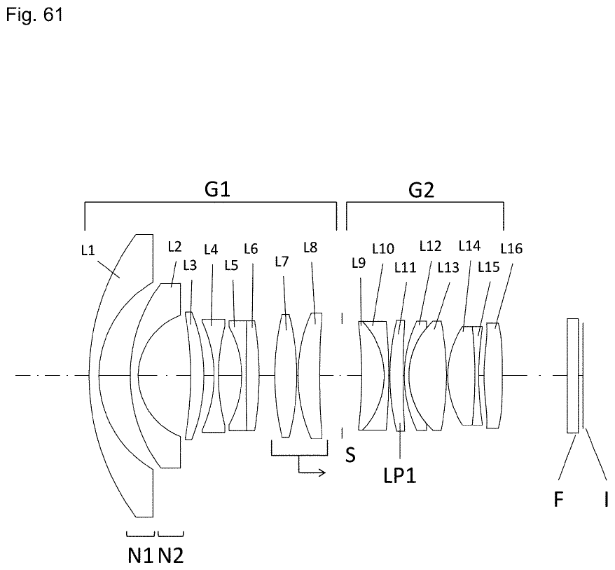

FIG. 61 is a diagram showing a lens configuration of a large aperture ratio ultra wide angle lens according to Example 13 when focusing on infinity.

The large aperture ratio ultra wide angle lens in FIG. 61 includes, in order from the object side, with a first lens group G1 having a positive refractive power, an aperture diaphragm S, and a second lens group G2 having a positive refractive power.

The first lens group G1 includes, in order from the object side, a meniscus negative lens component N1 including a meniscus negative lens L1 with its convex surface facing the object side, a meniscus negative lens component N2 including a meniscus negative lens L2 with its convex surface facing the object side, a meniscus positive lens L3 with its convex surface facing the image side, a biconcave lens L4, a cemented lens of a biconcave lens L5 and a biconvex lens L6, a biconvex lens L7, and a meniscus positive aspheric lens L8 with its convex surface facing the object side.

The second lens group G2 includes, in order from the object side, a cemented lens of a meniscus positive lens L9 with its convex surface facing the image side and a meniscus negative lens L10 with its convex surface facing the image side, a meniscus positive lens L11 with its convex surface facing the object side, a cemented lens of a meniscus negative lens L12 with its convex surface facing the object side and a biconvex lens L13, a cemented lens of a biconvex lens L14 and a biconcave lens L15, and a biconvex aspheric lens L16.

As an example of focusing, the lenses L7 to L8 among the lenses that configure the first lens group G1 are integrally moved to the image side along the optical axis, thereby making it possible to perform focusing from an infinite distance object to a close distance object. Regardless of this, it is possible to perform focusing by moving a part or the entirety of the optical system in the optical axis direction.

Specifications of the large aperture ratio ultra wide angle lens according to Example 13 are shown below.

### Numerical Example 13

Unit: mm
[Surface Data]

| Surface | | | | | | Corresponding |
|---|---|---|---|---|---|---|
| Number | r | d | nd | vd | ΔPgF | Glass Material |
| 0 | | (d0) | | | | |
| 1 | 54.0869 | 2.1998 | 1.87071 | 40.73 | −0.0069 | TAFD32 |
| 2 | 24.6840 | 6.9595 | | | | |
| 3 | 35.3626 | 1.7998 | 2.00100 | 29.13 | 0.0035 | TAFD55-W |
| 4 | 14.6760 | 11.6757 | | | | |
| 5 | −81.2294 | 2.9502 | 1.86966 | 20.02 | 0.0310 | FDS20-W |
| 6 | −39.5419 | 2.2419 | | | | |
| 7 | −29.8698 | 1.0000 | 1.43700 | 95.10 | 0.0564 | FCD100 |
| 8 | 45.4095 | 5.1697 | | | | |
| 9 | −23.2533 | 1.0000 | 1.80400 | 46.53 | −0.0070 | S-LAH65VS |
| 10 | 977.2188 | 2.8777 | 1.95375 | 32.32 | 0.0003 | S-LAH98 |
| 11 | −79.6200 | (d11) | | | | |
| 12 | 60.9734 | 4.9016 | 1.85150 | 40.78 | −0.0055 | S-LAH89 |
| 13 | −56.5096 | 0.3000 | | | | |
| *14 | 39.1505 | 4.7890 | 1.85135 | 40.10 | −0.0067 | M-TAFD305 |
| *15 | 330.8734 | (d15) | | | | |
| 16 (diaphragm) | ∞ | 4.3340 | | | | |
| 17 | −102.1298 | 5.0253 | 1.43875 | 94.66 | 0.0560 | S-FPL55 |
| 18 | −18.1293 | 1.0000 | 1.85478 | 24.80 | 0.0085 | S-NBH56 |
| 19 | −136.6592 | 0.3000 | | | | |
| 20 | 53.2499 | 2.9047 | 1.94595 | 17.98 | 0.0385 | FDS18-W |
| 21 | 185.3580 | 0.3000 | | | | |
| 22 | 28.9648 | 1.0000 | 1.76182 | 26.52 | 0.0129 | S-TIH14 |
| 23 | 16.8004 | 8.3747 | 1.43875 | 94.66 | 0.0560 | S-FPL55 |
| 24 | −63.7401 | 0.3000 | | | | |
| 25 | 20.6577 | 6.0332 | 1.43875 | 94.66 | 0.0560 | S-FPL55 |
| 26 | −106.2575 | 0.8500 | 1.85478 | 24.80 | 0.0085 | S-NBH56 |
| 27 | 73.7830 | 1.1962 | | | | |
| *28 | 44.6728 | 4.0690 | 1.80610 | 40.73 | −0.0058 | M-NBFD130 |
| *29 | −300.0000 | 14.4500 | | | | |
| 30 | ∞ | 2.5000 | 1.51680 | 64.20 | 0.0014 | BSC7 |
| 31 | ∞ | (BF) | | | | |

[Aspherical Surface Data]

| | 14th Surface | 15th Surface | 28th Surface | 29th Surface |
|---|---|---|---|---|
| K | 0.00000E+00 | 0.00000E+00 | 0.00000E+00 | 0.00000E+00 |
| A4 | 4.95784E−06 | 8.30571E−06 | −4.30974E−05 | −2.34518E−05 |
| A6 | 1.95158E−08 | 1.78240E−08 | −8.49095E−08 | −1.29468E−07 |
| A8 | −5.48172E−11 | −1.42424E−10 | 1.03060E−11 | 7.62476E−10 |
| A10 | 1.02975E−13 | 6.56869E−13 | 1.46055E−13 | −5.01269E−12 |
| A12 | 1.90218E−17 | −2.22330E−15 | 8.03092E−15 | 1.93846E−14 |
| A14 | 1.46327E−19 | −8.40293E−19 | 0.00000E+00 | 4.09600E−18 |
| A16 | −8.16597E−21 | 5.32357E−21 | 0.00000E+00 | 0.00000E+00 |

[Various Data]

| | Wide Angle (INF) |
|---|---|
| Focal Length | 8.15 |
| F-number | 1.26 |
| Total Angle of View 2ω | 185.73 |
| Image Height Y | 11.93 |
| Overall Lens Length | 110.00 |

[Variable Distance Data]

| | INF | Close Distance |
|---|---|---|
| (d0) | ∞ | 225.0631 |
| (d11) | 3.5000 | 3.7160 |
| (d15) | 4.9981 | 4.7820 |
| (BF) | 1.0000 | 1.0000 |

[Lens Group Data]

| Group | Starting Surface | Focal Length |
|---|---|---|
| G1 | 1 | 31.8976 |
| G2 | 17 | 30.5733 |

[Convex Lens in Second Lens Group G2 Satisfying Conditional Expression (16)]

| Surface | Corresponding | | | G2LPAXh/ | |
|---|---|---|---|---|---|
| Number | Glass Material | G2LPAXh | G2LPOAh | G2LPOAh | ΔPgF |
| 23 | S-FPL55 | 10.70675 | 5.36386 | 2.0 | 0.0560 |
| 25 | S-FPL55 | 9.71243 | 8.38196 | 1.2 | 0.0560 |
| 28 | M-NBFD130 | 8.07256 | 9.25816 | 0.9 | −0.0058 |

### Example 14

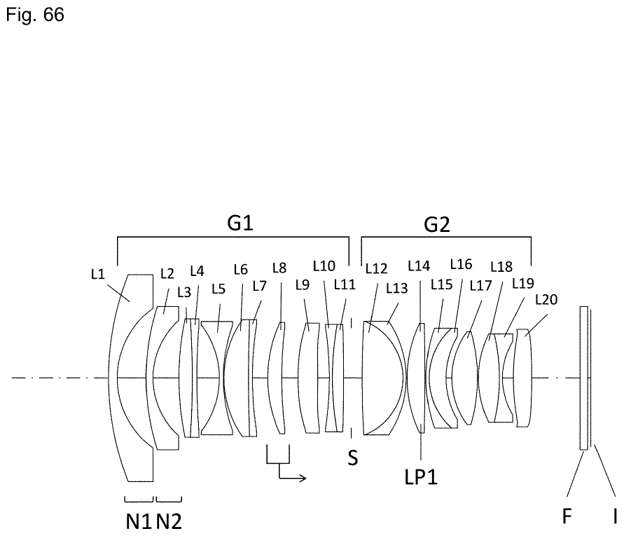

FIG. 66 is a diagram showing a lens configuration of a large aperture ratio ultra wide angle lens according to Example 14 when focusing on infinity.

The large aperture ratio ultra wide angle lens in FIG. 66 includes, in order from the object side, with a first lens group G1 having a negative refractive power, an aperture diaphragm S, and a second lens group G2 having a positive refractive power.

The first lens group G1 includes, in order from the object side, a meniscus negative lens component N1 including a meniscus negative lens L1 with its convex surface facing the object side, a meniscus negative lens component N2 including a meniscus negative lens L2 with its convex surface facing the object side, a cemented lens of a biconvex lens L3 and a biconcave lens L4, a biconcave lens L5, a cemented lens of a meniscus positive lens L6 with its convex surface facing the object side and a meniscus negative lens L7 with its convex surface facing the object side, a meniscus positive lens L8 with its convex surface facing the object side, a biconvex aspheric lens L9, and a cemented lens of a biconcave lens L10 and a biconvex lens L11.

The second lens group G2 includes, in order from the object side, a cemented lens of a biconvex lens L12 and a meniscus negative lens L13 with its convex surface facing the image side, a biconvex lens L14, a meniscus negative lens L15 with its convex surface facing the object side, a meniscus positive lens L16 with its convex surface facing the object side, a biconvex lens L17, a cemented lens of a biconvex lens L18 and a biconcave lens L19, and a biconvex aspheric lens L20.

As an example of focusing, L8 among the lenses that configure the first lens group G1 is moved to the image side along the optical axis, thereby making it possible to perform focusing from an infinite distance object to a close distance object. Regardless of this, it is possible to perform focusing by moving a part or the entirety of the optical system in the optical axis direction.

Specifications of the large aperture ratio ultra wide angle lens according to Example 14 are shown below.

### Numerical Example 14

Unit: mm
[Surface Data]

| Surface | | | | | | Corresponding |
|---|---|---|---|---|---|---|
| Number | r | d | nd | vd | ΔPgF | Glass Material |
| 0 | | (d0) | | | | |
| 1 | 93.2051 | 2.8000 | 2.05090 | 26.94 | 0.0052 | TAFD65 |
| 2 | 28.3327 | 9.2593 | | | | |
| 3 | 77.3086 | 2.2000 | 2.05090 | 26.94 | 0.0052 | TAFD65 |
| 4 | 25.4934 | 8.3772 | | | | |
| 5 | 95.7644 | 4.3183 | 1.85451 | 25.15 | 0.0071 | NBFD25 |
| 6 | −282.9514 | 1.4736 | 1.43875 | 94.66 | 0.0560 | S-FPL55 |
| 7 | 231.4955 | 7.1593 | | | | |
| 8 | −28.8409 | 1.2854 | 1.43875 | 94.66 | 0.0560 | S-FPL55 |
| 9 | 50.7551 | 0.2000 | | | | |
| 10 | 33.5428 | 7.9415 | 1.55298 | 55.07 | −0.0046 | J-KZFH4 |
| 11 | 532.1293 | 1.2498 | 1.49700 | 81.61 | 0.0373 | FCD1 |
| 12 | 113.4705 | (d12) | | | | |
| 13 | 43.9162 | 4.5145 | 1.85451 | 25.15 | 0.0071 | NBFD25 |
| 14 | 142.3024 | (d14) | | | | |
| *15 | 77.1154 | 6.2706 | 1.77377 | 47.17 | −0.0078 | MC-TAF401 |
| *16 | −277.6205 | 3.7431 | | | | |
| 17 | −110.5563 | 1.0000 | 1.85451 | 25.15 | 0.0071 | NBFD25 |
| 18 | 100.9979 | 3.6066 | 2.00100 | 29.13 | 0.0035 | TAFD55-W |
| 19 | −575.0909 | 2.5000 | | | | |
| 20 (diaphragm) | ∞ | 3.4844 | | | | |
| 21 | 321.0180 | 13.1263 | 1.48071 | 85.29 | 0.0413 | FCD915 |
| 22 | −20.1401 | 1.0000 | 1.85451 | 25.15 | 0.0071 | NBFD25 |
| 23 | −33.2861 | 0.3000 | | | | |
| 24 | 41.4022 | 5.7466 | 1.66382 | 27.35 | 0.0327 | J-SFH4 |
| 25 | −721.4485 | 0.3000 | | | | |
| 26 | 49.4849 | 1.0000 | 1.90043 | 37.37 | −0.0045 | TAFD37A |
| 27 | 21.9142 | 5.4423 | 1.43700 | 95.10 | 0.0564 | FCD100 |
| 28 | 27.1029 | 1.8583 | | | | |
| 29 | 25.8168 | 8.2863 | 1.43700 | 95.10 | 0.0564 | FCD100 |
| 30 | −55.1118 | 0.3000 | | | | |
| 31 | 33.3478 | 6.7126 | 1.49700 | 81.61 | 0.0373 | FCD1 |
| 32 | −62.0234 | 0.9624 | 1.95375 | 32.32 | 0.0003 | S-LAH98 |
| 33 | 23.3478 | 3.5312 | | | | |
| *34 | 80.0000 | 5.9223 | 1.80610 | 40.73 | −0.0058 | MC-NBFD130 |
| *35 | 219.5578 | 15.4983 | | | | |
| 36 | ∞ | 2.5000 | 1.51680 | 64.20 | 0.0014 | BSC7 |
| 37 | ∞ | (BF) | | | | |

[Aspherical Surface Data]

| | 15th Surface | 16th Surface | 34th Surface | 35th Surface |
|---|---|---|---|---|
| K | 0.00000E+00 | 0.00000E+00 | 0.00000E+00 | 0.00000E+00 |
| A4 | 7.15947E−06 | 1.56123E−05 | 6.16616E−07 | −3.95320E−06 |
| A6 | 9.08446E−09 | 1.26004E−08 | 6.36098E−08 | 7.58097E−09 |
| A8 | −4.13213E−11 | −5.07839E−11 | −8.77432E−10 | 7.09101E−11 |
| A10 | −4.04508E−15 | 1.38009E−14 | 5.67449E−12 | −2.38867E−12 |
| A12 | 1.29524E−17 | −1.41088E−16 | −1.49240E−14 | 1.50632E−14 |
| A14 | −4.83809E−19 | −1.45961E−18 | 0.00000E+00 | −3.65299E−17 |
| A16 | 5.59008E−23 | 2.65009E−21 | 0.00000E+00 | 0.00000E+00 |

[Various Data]

| | Wide Angle (INF) |
|---|---|
| Focal Length | 15.50 |
| F-number | 1.58 |
| Total Angle of View 2ω | 185.73 |
| Image Height Y | 22.30 |
| Overall Lens Length | 155.00 |

[Variable Distance Data]

| | INF | Close Distance |
|---|---|---|
| (d0) | ∞ | 443.3234 |
| (d12) | 4.8777 | 5.3944 |
| (d14) | 5.2521 | 4.7354 |
| (BF) | 1.0000 | 1.0000 |

[Lens Group Data]

| Group | Starting Surface | Focal Length |
|---|---|---|
| G1 | 1 | −190.0438 |
| G2 | 21 | 46.1252 |

[Convex Lens in Second Lens Group G2 Satisfying Conditional Expression (16)]

| Surface | Corresponding | | | G2LPAXh/ | |
|---|---|---|---|---|---|
| Number | Glass Material | G2LPAXh | G2LPOAh | G2LPOAh | ΔPgF |
| 27 | FCD100 | 13.79965 | 6.79814 | 2.0 | 0.0564 |
| 29 | FCD100 | 12.72132 | 8.98006 | 1.4 | 0.0564 |
| 31 | FCD1 | 10.28047 | 10.42632 | 1.0 | 0.0373 |
| 34 | MC-NBFD130 | 6.96538 | 12.5552 | 0.6 | −0.0058 |

In addition, the following shows a list of the corresponding values of the conditional expressions in these examples.

### [Conditional Expression Corresponding Values]

TABLE 1

| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

This technology can also adopt the following configuration.

### [Item 1]

A large aperture ratio ultra wide angle lens comprising, in order from an object side, a first lens group G1, an aperture diaphragm S, and a second lens group G2, wherein
the first lens group G1 has a meniscus negative lens component N1 having its convex surface facing the object side and being disposed on a side closest to the object side, and a meniscus negative lens component N2 with its convex surface facing the object side on a side closer to an image side than the meniscus negative lens component N1, and
the following Conditional Expressions (1) to (4) are satisfied.

$$2 ω \geq 160. ° \qquad ( 1 )$$

$$Fno < 1.9 \qquad ( 2 )$$

$$- 6. < N 1 OAh / iOAh < - 1.1 \qquad ( 3 )$$

$$0.5 < SagN 1 / SagN 2 < 1.8 \qquad ( 4 )$$

ω: A half angle of view when focusing on infinity
Fno: An F-number when focusing on infinity
N1OAh: An off-axis chief ray height when a ray with an object-side angle of incidence of 90° is incident on the meniscus negative lens component N1 when focusing on infinity (however, when 2ω<180°, it is an off-axis chief ray height that is incident at an object-side angle of incidence ω)
iOAh: An imaging height of an off-axis chief ray when a ray with an object-side angle of incidence of 90° forms an image on an image surface when focusing on infinity (however, when 2ω<180°, it is an imaging height of an off-axis chief ray that is incident at an object-side angle of incidence ω)
SagN1: A sag from a surface vertex of an image-side surface of the meniscus negative lens component N1 (as a ray height when calculating a sag, an off-axis chief ray height when a ray with an object-side angle of incidence of 90° emerges from the surface when focusing on infinity is used. When 2ω<180°, an off-axis chief ray height that is incident at an object-side angle of incidence ω is used for calculation.)
SagN2: A sag from a surface vertex of an image-side surface of the meniscus negative lens component N2 (as a ray height when calculating a sag, an off-axis chief ray height when a ray with an object-side angle of incidence of 90° emerges from the surface when focusing on infinity is used. When 2ω<180°, an off-axis chief ray height that is incident at an object-side angle of incidence ω is used for calculation.)

### [Item 2]

The large aperture ratio ultra wide angle lens according to [Item 1], wherein the following Conditional Expression (5) is satisfied.

$$0.4 < fN 1 / fN 2 < 5. \qquad ( 5 )$$

fN1: A focal length of the meniscus negative lens component N1
fN2: A focal length of THE meniscus negative lens component N2

### [Item 3]

The large aperture ratio ultra wide angle lens according to [Item 1] or [Item 2], wherein the meniscus negative lens component N1 satisfies the following Conditional Expression (6).

$$1.5 < N 1 SF < 6. \qquad ( 6 )$$

$$N 1 SF = ( N 1 R 1 + N 1 R 2 ) / ( N 1 R 1 - N 1 R 2 )$$

N1R1: A curvature radius of an object-side surface of the meniscus negative lens component N1
N1R2: A curvature radius of the image-side surface of the meniscus negative lens component N1

### [Item 4]

The large aperture ratio ultra wide angle lens according to any one of [Item 1] to [Item 3], wherein the meniscus negative lens component N2 satisfies the following Conditional Expression (7).

$$1.2 < N 2 SF < 5. \qquad ( 7 )$$

$$N 2 SF = ( N 2 R 1 + N 2 R 2 ) / ( N 2 R 1 - N 2 R 2 )$$

N2R1: A curvature radius of the object-side surface of the meniscus negative lens component N2
N2R2: A curvature radius of the image-side surface of the meniscus negative lens component N2

### [Item 5]

The large aperture ratio ultra wide angle lens according to any one of [Item 1] to [Item 4], wherein the meniscus negative lens component N1 and the meniscus negative lens component N2 satisfy the following Conditional Expression (8).

$$0.4 < N 1 SF / N 2 SF < 3. \qquad ( 8 )$$

$$N 1 SF = ( N 1 R 1 + N 1 R 2 ) / ( N 1 R 1 - N 1 R 2 )$$

N1R1: A curvature radius of the object-side surface of the meniscus negative lens component N1
N1R2: A curvature radius of the image-side surface of the meniscus negative lens component N1

$$N 2 S F = ( N 2 R 1 + N 2 R 2 ) / ( N 2 R 1 - N 2 R 2 )$$

N2R1: A curvature radius of the object-side surface of the meniscus negative lens component N2
N2R2: A curvature radius of the image-side surface of the meniscus negative lens component N2

### [Item 6]

The large aperture ratio ultra wide angle lens according to any one of [Item 1] to [Item 5], wherein the meniscus negative lens component N1 satisfies the following Conditional Expression (9).

$$1.8 < P LOAN 1 / PLAN 1 < 5. \qquad ( 9 )$$

PLOAN1: A distance at which an off-axis chief ray passes through the meniscus negative lens component N1 when a ray incident at an object-side angle of incidence of 90° when focusing on infinity is an off-axis ray (however, when 2ω<180°, a ray incident at an object-side angle of incidence ω is an off-axis ray)
PLAN1: A thickness of the meniscus negative lens component N1 on an optical axis

### [Item 7]

The large aperture ratio ultra wide angle lens according to any one of [Item 1] to [Item 6], wherein the meniscus negative lens component N1 and the meniscus negative lens component N2 satisfy the following Conditional Expression (10).

$$0.3 < P LOAN 1 / PLOAN 2 < 3.5 \qquad ( 10 )$$

PLOAN1: A distance at which an off-axis chief ray passes through the meniscus negative lens component N1 when a ray incident at an object-side angle of incidence of 90° when focusing on infinity is an off-axis ray (however, when 2ω<180°, a ray incident at an object-side angle of incidence ω is an off-axis ray)
PLOAN2: A distance at which an off-axis chief ray passes through the meniscus negative lens component N2 when a ray incident at an object-side angle of incidence of 90° when focusing on infinity is an off-axis ray (however, when 2ω<180°, a ray incident at an object-side angle of incidence ω is an off-axis ray)

### [Item 8]

The large aperture ratio ultra wide angle lens according to any one of [Item 1] to [Item 7], wherein the second lens group G2 has a convex lens LP1 that satisfies the following Conditional Expressions (11) to (13).

$$1.6 < ndLP 1 \qquad ( 11 )$$

$$vdLP 1 < 35. \qquad ( 12 )$$

$$0.018 < Δ PgFLP 1 \qquad ( 13 )$$

ndLP1: A refractive index of the convex lens LP1
vdLP1: An Abbe number of the convex lens LP1
ΔPgFLP1: Anomalous dispersion of the convex lens LP1

### [Item 9]

The large aperture ratio ultra wide angle lens according to any one of [Item 1] to [Item 8], wherein the first lens group G1 has a negative refractive power and satisfies the following Conditional Expression (14).

$$- 0.4 < f / f 1 < 0.7 \qquad ( 14 )$$

f: A focal length of an entire system when focusing on infinity
f1: A focal length of the first lens group G1 when focusing on infinity

### [Item 10]

The large aperture ratio ultra wide angle lens according to any one of [Item 1] to [Item 9], wherein the second lens group G2 has a positive refractive power and satisfies the following Conditional Expression (15).

$$- 0.8 < f 2 / f 1 < 2.7 \qquad ( 15 )$$

f1: A focal length of the first lens group G1 when focusing on infinity
f2: A focal length of the second lens group G2 when focusing on infinity

### [Item 11]

The large aperture ratio ultra wide angle lens according to any one of [Item 1] to [Item 10], wherein the second lens group G2 includes at least one convex lens satisfying the following Conditional Expression (16), and satisfies the following Conditional Expression (17).

$$0.3 < G 2 LPAXh / G 2 LPOAh < 2.7 \qquad ( 16 )$$

$$0.004 < G 2 LPAve \qquad ( 17 )$$

G2LPAXh: An axial marginal ray height incident on a convex lens when focusing on infinity in a diaphragm open state
G2LPOAh: An off-axis chief ray height when a ray with an object-side angle of incidence of 90° is incident on a convex lens when focusing on infinity (however, when 2ω<180°, it is an off-axis chief ray height that is incident at an object-side angle of incidence ω)
G2LPAve: An average value of anomalous dispersion of a convex lens that satisfies Conditional Expression (16)

### [Item 12]

The large aperture ratio ultra wide angle lens according to any one of [Item 1] to [Item 11], wherein the meniscus negative lens component N1 includes a concave lens that satisfies the following Conditional Expression (18).

$$1. 7 < ndN 1 n \qquad ( 18 )$$

ndN1n: A refractive index of the concave lens included in the meniscus negative lens component N1

### [Item 13]

The large aperture ratio ultra wide angle lens according to any one of [Item 1] to [Item 12], wherein the following Conditional Expression (19) is satisfied.

$$5. 00 < LT / BF < 12. \qquad ( 19 )$$

LT: A distance on the optical axis from a lens surface closest to the object side to a lens surface closest to the image side when focusing on infinity
BF: A distance on the optical axis from a lens surface closest to the image side to an image surface when focusing on infinity

### [Item 14]

A large aperture ratio ultra wide angle lens according to any one of [Item 1] to [Item 13], wherein the following Conditional Expression (20) is satisfied.

$$2.5 < \vert LT / iOAh \vert < 18. \qquad ( 20 )$$

LT: A distance on the optical axis from a lens surface closest to the object side to a lens surface closest to the image side when focusing on infinity
iOAh: An imaging height of an off-axis chief ray when a ray with an object-side angle of incidence of 90° forms an image on an image surface when focusing on infinity (however, when 2ω<180°, it is an imaging height of an off-axis chief ray that is incident at an object-side angle of incidence ω)

### [Item 15]

The large aperture ratio ultra wide angle lens according to any one of [Item 1] to [Item 14], wherein the meniscus negative lens component N2 is a meniscus negative lens component having its convex surface facing the object side and being disposed second from the object side among meniscus negative lens components with those convex surfaces facing the object side.

### [Item 16]

The large aperture ratio ultra wide angle lens according to any one of [Item 1] to [Item 15], wherein the concave meniscus lens component N1 and the concave meniscus lens component N2 are disposed consecutively from a side closest to the object side.

### [Item 17]

The large aperture ratio ultra wide angle lens according to any one of [Item 1] to [Item 16], wherein the concave meniscus lens component N1 and the concave meniscus lens component N2 include spherical lenses.

### [Item 18]

The large aperture ratio ultra wide angle lens according to any one of [Item 1] to [Item 17], wherein focusing is performed from infinity to a close distance object by moving a part or the entirety of an optical system in the optical axis direction.

The above description of the embodiment is an example of the large aperture ratio ultra wide angle lens of the present invention, and the present invention is not limited to this embodiment within the scope of the gist of the invention. Various design changes, modifications, combinations, and sub-combinations are possible, and all of them are included in the scope of the present invention.

### REFERENCE SYMBOLS LIST

G1 First lens group
G2 Second lens group
S Aperture diaphragm
N1 Meniscus negative lens component
N2 Meniscus negative lens component
LP1 Convex lens
F Filter
I Image surface

What is claimed is:

1. A large aperture ratio ultra wide angle lens comprising, in order from an object side, a first lens group G1, an aperture diaphragm S, and a second lens group G2, wherein
the first lens group G1 has a meniscus negative lens component N1 having its convex surface facing the object side and being disposed on a side closest to the object side, and a meniscus negative lens component N2 with its convex surface facing the object side on a side closer to an image side than the meniscus negative lens component N1, and
the following Conditional Expressions (1) to (4) are satisfied:
$$2 ω \geq 160. ° \qquad ( 1 )$$
$$Fno < 1.9 \qquad ( 2 )$$
$$- 6. < N 1 OAh / iOAh < - 1.1 \qquad ( 3 )$$
$$0.5 < SagN 1 / SagN 2 < 1.8 \qquad ( 4 )$$
ω: A half angle of view when focusing on infinity
Fno: An F-number when focusing on infinity
N1OAh: An off-axis chief ray height when a ray with an object-side angle of incidence of 90° is incident on the meniscus negative lens component N1 when focusing on infinity (however, when 2ω<180°, it is a height of an off-axis chief ray that is incident at an object-side angle of incidence ω)
iOAh: An imaging height of an off-axis chief ray when a ray with an object-side angle of incidence of 90° forms an image on an image surface when focusing on infinity (however, when 2ω<180°, it is an imaging height of an off-axis chief ray that is incident at an object-side angle of incidence ω)
SagN1: A sag from a surface vertex of an image-side surface of the meniscus negative lens component N1 (as a ray height when calculating a sag, an off-axis chief ray height when a ray with an object-side angle of incidence of 90° emerges from the surface when focusing on infinity is used. When 2ω<180°, an off-axis chief ray height that is incident at an object-side angle of incidence ω is used for calculation)
SagN2: A sag from a surface vertex of an image-side surface of the meniscus negative lens component N2 (as a ray height when calculating a sag, an off-axis chief ray height when a ray with an object-side angle of incidence of 90° emerges from the surface when focusing on infinity is used. When 2ω<180°, an off-axis chief ray height that is incident at an object-side angle of incidence ω is used for calculation).

2. The large aperture ratio ultra wide angle lens according to claim 1, wherein the following Conditional Expression (5) is satisfied:
$$0.4 < fN 1 / fN 2 < 5. \qquad ( 5 )$$
fN1: A focal length of the meniscus negative lens component N1
fN2: A focal length of the meniscus negative lens component N2.

3. The large aperture ratio ultra wide angle lens according to claim 1, wherein the meniscus negative lens component N1 satisfies the following Conditional Expression (6):
$$1.5 < N 1 SF < 6. \qquad ( 6 )$$
$$N 1 SF = ( N 1 R 1 + N 1 R 2 ) / ( N 1 R 1 - N 1 R 2 )$$
N1R1: A curvature radius of an object-side surface of the meniscus negative lens component N1
N1R2: A curvature radius of the image-side surface of the meniscus negative lens component N1.

4. The large aperture ratio ultra wide angle lens according to claim 1, wherein the meniscus negative lens component N2 satisfies the following Conditional Expression (7):
$$1.2 < N 2 SF < 5. \qquad ( 7 )$$
$$N 2 SF = ( N 2 R 1 + N 2 R 2 ) / ( N 2 R 1 - N 2 R 2 )$$
N2R1: A curvature radius of the object-side surface of the meniscus negative lens component N2
N2R2: A curvature radius of the image-side surface of the meniscus negative lens component N2.

5. The large aperture ratio ultra wide angle lens according to claim 1, wherein the meniscus negative lens component N1 and the meniscus negative lens component N2 satisfy the following Conditional Expression (8):
$$0.4 < N 1 SF / N 2 SF < 3. \qquad ( 8 )$$
$$N 1 SF = ( N 1 R 1 + N 1 R 2 ) / ( N 1 R 1 - N 1 R 2 )$$
N1R1: A curvature radius of the object-side surface of the meniscus negative lens component N1
N1R2: A curvature radius of the image-side surface of the meniscus negative lens component N1
$$N 2 SF = ( N 2 R 1 + N 2 R 2 ) / ( N 2 R 1 - N 2 R 2 )$$
N2R1: A curvature radius of the object-side surface of the meniscus negative lens component N2
N2R2: A curvature radius of the image-side surface of the meniscus negative lens component N2.

6. The large aperture ratio ultra wide angle lens according to claim 1, wherein the meniscus negative lens component N1 satisfies the following Conditional Expression (9):
$$1.8 < PLOAN 1 / PLAN 1 < 5. \qquad ( 9 )$$
PLOAN1: A distance at which an off-axis chief ray passes through the meniscus negative lens component N1 when a ray incident at an object-side angle of incidence of 90° when focusing on infinity is an off-axis ray (however, when 2ω<180°, a ray incident at an object-side angle of incidence ω is an off-axis ray)
PLAN1: A thickness of the meniscus negative lens component N1 on an optical axis.

7. The large aperture ratio ultra wide angle lens according to claim 1, wherein the meniscus negative lens component N1 and the meniscus negative lens component N2 satisfy the following Conditional Expression (10):
$$0.3 < PLOAN 1 / PLOAN 2 < 3.5 \qquad ( 10 )$$
PLOAN1: A distance at which an off-axis chief ray passes through the meniscus negative lens component N1 when a ray incident at an object-side angle of incidence of 90° when focusing on infinity is an off-axis ray (however, when 2ω<180°, a ray incident at an object-side angle of incidence ω is an off-axis ray)
PLOAN2: A distance at which an off-axis chief ray passes through the meniscus negative lens component N2 when a ray incident at an object-side angle of incidence of 90° when focusing on infinity is an off-axis ray (however, when 2ω<180°, a ray incident at an object-side angle of incidence ω is an off-axis ray).

8. The large aperture ratio ultra wide angle lens according to claim 1, wherein the second lens group G2 has a convex lens LP1 that satisfies the following Conditional Expressions (11) to (13):
$$1.6 < ndLP 1 \qquad ( 11 )$$
$$vdLP 1 < 35. \qquad ( 12 )$$
$$0.018 < Δ PgFLP 1 \qquad ( 13 )$$
ndLP1: A refractive index of the convex lens LP1
vdLP1: An Abbe number of the convex lens LP1
ΔPgFLP1: Anomalous dispersion of the convex lens LP1.

9. The large aperture ratio ultra wide angle lens according to claim 1, wherein the first lens group G1 has a negative refractive power and satisfies the following Conditional Expression (14):
$$- 0.4 < f / f 1 < 0.7 \qquad ( 14 )$$
f: A focal length of an entire system when focusing on infinity
f1: A focal length of the first lens group G1 when focusing on infinity.

10. The large aperture ratio ultra wide angle lens according to claim 1, wherein the second lens group G2 has a positive refractive power and satisfies the following Conditional Expression (15):
$$- 0.8 < f 2 / f 1 < 2.7 \qquad ( 15 )$$
f1: A focal length of the first lens group G1 when focusing on infinity
f2: A focal length of the second lens group G2 when focusing on infinity.

11. The large aperture ratio ultra wide angle lens according to claim 1, wherein the second lens group G2 includes at least one convex lens satisfying the following Conditional Expression (16), and satisfies the following Conditional Expression (17):
$$0.3 < G 2 LPAXh / G 2 LPOAh < 2.7 \qquad ( 16 )$$
$$0.004 < G 2 LPAve \qquad ( 17 )$$
G2LPAXh: An axial marginal ray height incident on a convex lens when focusing on infinity in a diaphragm open state
G2LPOAh: An off-axis chief ray height when a ray with an object-side angle of incidence of 90° is incident on a convex lens when focusing on infinity (however, when 2ω<180°, it is an off-axis chief ray height that is incident at an object-side angle of incidence ω)
G2LPAve: An average value of anomalous dispersion of a convex lens that satisfies Conditional Expression (16).

12. The large aperture ratio ultra wide angle lens according to claim 1, wherein the meniscus negative lens component N1 includes a concave lens that satisfies the following Conditional Expression (18):
$$1.7 < ndN 1 n \qquad ( 18 )$$
ndN1n: A refractive index of the concave lens included in the meniscus negative lens component N1.

13. The large aperture ratio ultra wide angle lens according to claim 1, wherein the following Conditional Expression (19) is satisfied:
$$5. < LT / BF < 12. \qquad ( 19 )$$
LT: A distance on the optical axis from a lens surface closest to the object side to a lens surface closest to the image side when focusing on infinity
BF: A distance on the optical axis from a lens surface closest to the image side to an image surface when focusing on infinity.

14. The large aperture ratio ultra wide angle lens according to claim 1, wherein the following Conditional Expression (20) is satisfied:
$$2.5 < \vert LT / iOAh \vert < 18. \qquad ( 20 )$$
LT: A distance on the optical axis from a lens surface closest to the object side to a lens surface closest to the image side when focusing on infinity
iOAh: An imaging height of an off-axis chief ray when a ray with an object-side angle of incidence of 90° forms an image on an image surface when focusing on infinity (however, when 2ω<180°, it is an imaging height of an off-axis chief ray that is incident at an object-side angle of incidence ω).

15. The large aperture ratio ultra wide angle lens according to claim 1, wherein the meniscus negative lens component N2 is a meniscus negative lens component having its convex surface facing the object side and being disposed second from the object side among meniscus negative lens components with those convex surfaces facing the object side.

16. The large aperture ratio ultra wide angle lens according to claim 1, wherein the concave meniscus lens component N1 and the concave meniscus lens component N2 are disposed consecutively from a side closest to the object side.

17. The large aperture ratio ultra wide angle lens according to claim 1, wherein the concave meniscus lens component N1 and the concave meniscus lens component N2 include spherical lenses.

18. The large aperture ratio ultra wide angle lens according to claim 1, wherein focusing is performed from infinity to a close distance object by moving a part or the entirety of an optical system in the optical axis direction.
